(19) United States
(12) Patent Application Publication
(10) Pub. No.: US 2016/0047360 A1
(43) Pub. Date: Feb. 18, 2016

(54) Method and apparatus to utilize the push-pull power of an upwards flow of wind energy within a structure

(71) Applicant: James Patrick Fex, JR., Bouse, AZ (US)

(72) Inventor: James Patrick Fex, JR., Bouse, AZ (US)

(21) Appl. No.: 14/121,225

(22) Filed: Aug. 12, 2014

(51) Int. Cl. F03D 11/02; F24F 7/04; F03D 9/00; F24F 7/00; F03D 1/04; F03D 1/06

(52) U.S. Cl. CPC F03D 11/02; F03D 1/04; F03D 1/06; F03D 9/002; F24F 7/00; F24F 7/04; F24F 2007/004

(57) ABSTRACT

Method and apparatus to utilize the push-pull power of an upwards flow of wind energy within a structure with one or more open tops; for ventilation, moisture condensing and producing mechanical energy for useful work, which will include producing electricity. Including a unique application of “Bernoulli's Principal” that allows the maximum amount of wind energy to be captured, channeled and/or concentrated within that structure over its height; to directly operate any number, type, form, size and/or shape of wind powered devices to transform this wind energy into mechanical energy. Then this mechanical energy can be used by machine devices to produce useful work, propel vehicles and/or to condense moisture from humid wind energy through momentum with geometric moisture condensing devices.

### FIELD OF THE INVENTION

I am the first inventor to conceive and produce a working prototype of a method and apparatus to efficiently utilize the push-pull power of an upwards flow of wind energy within a structure; for ventilation, moisture condensing and producing mechanical energy for useful work, which will include producing electricity. By capturing, channeling, concentrating wind energy within that structure; to directly operate any number, type, form, size and/or shape of wind powered devices to transform this wind energy into mechanical energy. Then this mechanical energy can be used by machine devices to produce useful work and/or by geometric moisture condensing devices to condense moisture from humid wind energy through momentum.

Additionally, this method and apparatus also includes a unique application of “Bernoulli's Principal” that allows the maximum amount of wind energy to be captured, channeled and then concentrated over the height of specially designed wind energy structures, with one or more open tops to initiate a push-pull wind energy system, with one or more structural supports, with one or more external surfaces, separating one or more internal areas with one or more floors with one or more rooms with one or more internal surfaces, from an outside. This upwards flow of wind energy can be effectively and efficiently utilized to operate any number, type, form, size and/or shape of wind powered devices.

The power, force, motion and/or energy generated by any wind powered device within these wind energy structures can be directly connected and/or connected through shafts, belts, drive lines and the like, with any type, size or form of machine devices mounted inside and/or outside of this structure. Thereby transforming wind energy into mechanical energy; that can then be utilized to produce useful work in any number of ways imaginable. Including producing electrical power. The prior art never mentions using “Bernoulli's Principal”, or any “low pressure mathematics” as I disclose herein; to dramatically increase performance and efficiencies.

Through the implementation of multiple internal channels within these wind energy structures, any number of “stages” of wind powered devices and/or machine devices imaginable, can be employed. Including “special casement channels” through another unique application of the “Laws of Pressure”. Thus, these wind energy structures can be employed to produce low cost, green wind energy that can be used in any way imaginable; either within these structures and/or by machine devices connected with them yet mounted outside of the wind energy structure. Additionally, the power, force, motion and/or energy generated by wind energy within said structure, can be transmitted to any conceivable number, type, form and/or style of separate but connected structures and/or special casement channels, in any number of ways imaginable. One is to use these connected but separate structures and/or special casement channels to house even more wind powered devices to produce more mechanical energy. Another is to ventilate the wind energy structure, along with any connected but separate structures. Moisture can be condensed from humid wind energy streams within wind energy structures and/or any connected special casement channels and/or any separate but connected structures. Wind energy structures could become integral parts of vehicles such as ships and transform wind energy into mechanical energy momentum. To be clear; all of the power utilized, will be derived from wind energy generated within these wind energy structures. All previous attempts have failed to adequately employ the “Laws of Pressure”, any “low pressure mathematics” and/or “Bernoulli's Principal”.

### BACKGROUND OF THE INVENTION

In 1684 Blaise Pascal wrote the primary rule of pressure, known as “Pascal's Law”: “a change in the pressure of an enclosed incompressible fluid is conveyed undiminished to every part of the fluid and to the surfaces of its container”. In the case at hand, atmospheric air is the fluid and it can be considered incompressible. This is the primary physics behind my first three granted U.S. patents. I chose to determine the pressure of a vessel by measuring the speed of air as it enters and/or leaves through holes in the surfaces of that structure/container/vessel. I knew that any and all pressure changes applied to the fluid field within any structure/container/vessel; will also be immediately conveyed undiminished to the surfaces of that structure/container/vessel. I then began to study the effects of “Pascal's Law” on a standard structure during high wind events.

Wikipedia describe “wind” as “the flow of gases on a large scale” and goes onto say “air is accelerated from higher to lower pressures”; so “pressure energy” is the root force of all “wind energy” and is why air will only move from all higher pressure areas towards low pressure areas, based on Pascal's teachings and Daniel Bernoulli's dynamic/velocity pressure equation: “the square root of this pressure differential; times the constant 4005; equals the velocity of this movement of air in feet per minute”, thereby generating “wind energy”. Air is just the fluid, the really important information is the dynamic wind energy pressure imparted on it, as represented by Bernoulli's velocity/dynamic pressure formula stated above. Air, plus this energy, is what we call “wind energy”. I could not find a definition of “wind energy” and must assume that its very name describes itself. For the patent application at hand “wind energy” will be used to describe “any energy, motion and/or force derived from wind, wind speed, including pressure, pressure from wind, dynamic pressure, dynamic pressure energy, dynamic wind pressure, dynamic wind energy pressure, wind pressure energy and/or any version thereof regardless of how it is used”.

Wikipedia describes “wind power” as “the conversion of wind energy into a useful form of energy”, which will be used in this application. “When work is done upon an object, that object gains energy; the energy acquired by the objects upon which work is done is known as” “mechanical energy”, which will be used in this application. Wikipedia defines “dynamic pressure” as “being closely related to the kinetic energy of a fluid particle” and “the pressure of a fluid particle in motion”, again the fluid particle in our case is air, therefore in the patent at hand, “dynamic pressure”, “dynamic pressure energy”, “dynamic wind pressure”, “dynamic wind energy pressure”, “wind pressure energy”, “wind energy pressure”, “pressure from wind”, “wind”, “wind energy” and/or any versions thereof, describe the same force, motion and/or energy and can be used interchangeably. Dictionary.com describes “device” as “a plan or scheme for effecting a purpose”, so in this invention “wind powered device”, refers to “any attempt, plan, scheme, strategy, assemblage of parts, occurrence, method and/or apparatus to purposefully transform wind energy into mechanical energy that can then be used to operate any other device and/or machine imaginable, regardless of the output”. These wind powered devices can be any now known device, or any device invented in the future, that can use wind energy in any useful way imaginable. All of these wind powered devices will be used within “wind energy structures” which is a new term and a new way of utilizing wind energy.

For the invention at hand, these “wind energy structures” are “any attempt, strategy, scheme, plan, assemblage of parts, occurrence, method and/or apparatus to capture, channel, concentrate and/or utilize wind, wind energy, wind power, wind pressure, wind energy pressure, pressure from wind, dynamic pressure, dynamic wind pressure, dynamic wind energy pressure and/or any version thereof in any way imaginable, within a structure regardless of its size, shape, form and/or type”. “Wind energy”, “wind power”, “capture”, “channel”, “concentrate” and “utilize” are clearly defined herein. So these wind powered devices will be mounted within “wind energy structures”; where the “Laws of Pressure” are used to predict their performance.

Webster's defines “machine” as “an assemblage of parts that transmit force, motion and/or energy from one to another in a predetermined manner”. For the patent application at hand “machine device”, refers to “any attempt, strategy, assemblage, scheme, plan, assemblage of parts, occurrence, method and/or apparatus to purposefully transmit any and/or all of the force, motion and/or mechanical energy generated by a wind powered device, to operate any imaginable assemblage of parts in any way imaginable, regardless of the output; additionally these machine devices can be directly connected to wind powered devices within the wind energy structure and/or connected through shafts, belts, drive lines and the like, with machine devices remotely mounted either inside and/or outside of the structure, thereby supplying them with mechanical energy”. These machine devices can be any currently known device, or any device invented in the future, that can use the force, motion and/or mechanical energy generated by a wind powered device, in any useful way imaginable and/or in any useful location imaginable. For our purposes here “operate/operated/operating” refers to “any attempt, strategy, assemblage, scheme, plan, assemblage of parts, occurrence, method and/or apparatus to purposefully have control over the way any machine, vehicle and device imaginable; functions, is utilized and/or is controlled, in any imaginable way”.

The definition of the primary terms used to describe this invention need to be established. Webster's defines “utilize” as “to make use of turn to practical use”; “capture” is defined as “to take captive” while “channel” is defined as “a means of communicating” and “concentrate” is “to accumulate”. So for our purposes here “to utilize wind energy within a structure” refers “to any and/or all attempts, schemes, plans, assemblage of parts, occurrences, methods, strategies and/or apparatuses that uses any form and/or type of wind energy whatsoever within a structure, regardless of the output”.

“Capture/captured/capturing” refers to “any and all attempts, schemes, plans, assemblage of parts, occurrences, methods, strategies and/or apparatuses whereby wind energy becomes captive and/or trapped within a structure”.

“Channel/channeled/channeling” refers to “any and all attempts, schemes, plans, assemblage of parts, occurrences, methods, strategies and/or apparatuses imaginable for allowing this captured wind energy within the structure to communicate with any and/or all areas within the structure and/or with an outside, for any purpose imaginable”.

“Concentrate/concentrated/concentrating” refers to “any and all attempts, schemes, plans, assemblage of parts, occurrences, methods, strategies and/or apparatuses for accumulating wind energy within a structure”.

“Utilize/utilized/utilized” refers to “any and all attempts, schemes, plans, assemblage of parts, occurrences, methods, strategies and/or apparatuses to make practical use of any and/or all captured, channeled and concentrated wind energy within a structure in any way conceivable and/or imaginable”.

For this invention, “stages” is defined as “any attempt, strategy, scheme, plan, assemblage of parts, occurrence, method and/or apparatus for providing a series of positions and/or stations to contain multiple wind powered devices and/or machine devices within any wind energy structure and/or any connected but separate structure and/or any special casement channel”. While “contained stages” only refers “to a situation where multiple wind powered devices are mounted within a “special casement channel”.

In the patent application at hand, “external” refers to “any and/or all surfaces, areas and spaces that connect with an outside”; while “internal”, “includes any and/or all surfaces, areas and/or spaces located within a structure”; and “internal surface” refers to “any surface that is located within and/or connects with these internal areas”. For clarity “external surface” is used to define “the surface that is located within and/or connects with an outside”; to differentiate it from “internal surface”.

Velocity/dynamic pressure is the high-velocity-low-pressure wind energy, which immediately slows to become a low-velocity-high-pressure wind energy force, when it impacts the walls of a standard structure. Once it enters that structure it continues as a captured low-velocity-high-pressure wind energy force within the structure. Pascal and Bernoulli agree that “velocity pressure” and “dynamic pressure” are the same force, and as stated above is defined as “the pressure of a fluid particle in motion”; so to measure them, one must measure the movement of air. “Static pressure” is defined as “the pressure of a fluid particle that is not moving”. I employed “Pascal's Law” by measuring the dynamic pressure of a structure/container/vessel directly at its surface/skin by measuring the velocity of air as it enters and leaves all of the external sides/surfaces of the structure. This method and apparatus was never employed by the prior art.

The patent application at hand is also based on dynamic pressure in the form of the low-velocity-high-pressure wind energy force within structures; along with the “lift” generated by high-velocity-low-pressure wind energy force flowing over the “open top” of my “wind energy structures”. Based on mathematics established by Daniel Bernoulli that is associated with his “Bernoulli's Principal”. Including exactly how to channel, concentrate and/or utilize captured wind energy within the structure to power any imaginable number of “wind powered devices” located within that structure. I first learned how powerful wind energy can become within a structure; when I stood below my roof mounted skylight that I had converted into a “self-activating relief valve” in an attempt to protect my home during hurricane IVAN on Sep. 15, 2004. I watched this skylight pop open every few seconds, and even faster as the winds strengthened during IVAN and felt the dramatic rush of air by me on its way out of my home. I instantly knew my research and math was right and that I had discovered something new, important and very powerful.

I soon realized that this captured low-velocity-high-pressure wind energy force can easily be channeled, into one or more channels within a structure; then concentrated and/or utilized to operate any form, type and/or size of wind powered devices. The force, motion and/or mechanical energy generated by these wind powered devices can be transmitted through connections with any form, type and/or size of machine device; including but not limited to electrical power generators. Large amounts of mechanical energy can be generated within properly designed “wind energy structures”, in winds as low as 1.0 MPH. Structures that can continue operating throughout hurricanes and/or tornadoes. My experience with WAN is described in detail within a patent application that I filed on the same day as this one, named “METHOD AND APPARATUS TO UTILIZE WIND ENERGY WITHIN A STRUCTURE TO PROTECT IT FROM HIGH WINDS”.

For the patent application at hand, “self-activating” is defined as “no controls of any kind, including manual, can be employed if the system is to be accurately considered ‘self-activating’; and all openings must be self-contained and capable of starting, operating and regulating themselves once their set point has been set and be considered totally independent of any and/or all external influence, whatsoever; their self-contained nature prevents the use of any electrical power, controls, electronics, information technologies, triggers and/or control systems of any kind in a truly self-activating system; additionally no form of ‘control theory’ involving any or all of the following: data processors, controllers, controlled openings, pressure sensors, pressure transducers, static pressure theory and/or static pressure sensors, can be used in a truly self-activating system”. On my home, I used a variation of the spring type of a self-activating, wind energy operated, weather resistant relief valve, by employing a ½″ piece of bungee cord on my operable skylight.

The only prior art involved in any claims pertaining to how to control wind as it enters and/or leaves from and/or to a wind energy structure; is PARKER (U.S. Pat. No. 5,956,903) and FEX (U.S. Pat. No. 7,127,850) and both of these schemes are based totally on “control theory”; which involves the use of electricity to control and operated openings. Wikipedia describes “control theory” as “an interdisciplinary branch of engineering and mathematics that deals with the behavior of dynamical systems. The desired output (structure pressure control) of a system is called the reference. When one or more output variables (sensor readings) of a system need to follow a certain reference over time, a controller manipulates the input (controlled openings) to a system to obtain the desired effect on the output of the system.” Wikipedia goes on to show that “controllers, sensors, electronics and pneumatic or electric motors” are always required in “control theory” applications. Webster's defines “dynamical systems” as “systems marked by usually continuous and productive activity or change”; which is how all “control systems” operate, including PARKER and FEX (U.S. Pat. No. 7,127,850).

I hereby declare that while observing the operation of my self-activating, wind energy operated, pressure relief skylight, during IVAN as described above, I learned exactly how powerful this captured low-velocity-high-pressure wind energy force really is; and that I had never accurately calculated or observed this force within a structure before. I never thought it could be so powerful. Within a day I realized how this energy could be captured, channeled, concentrated and/or utilized to power any type, size, form or shape of wind powered device, even in winds down to 1.0 MPH and as high as 240+MPH, regardless of wind direction, including but not limited to wind powered electrical power generators. Any applicable form, type, size or shape of wind powered device currently existing or invented in the future can be used within my wind energy structures. I just kept on studying it until I disclosed it on Dec. 24, 2008; without mentioning it to anyone until then.

This is exactly why I knew ever since Apr. 11, 2006 that my schemes expressed within U.S. Pat. Nos. 6,584,855; 6,968,745 and 7,127,850 along with PARKER's scheme are not “self-activating” and they will ALL FAIL in high winds; just when they are needed the most. So, I knew that to modulate between 100% open and 90-100% closed and/or to proportionally move to open and/or proportionally move to close any opening, channel, inlet scoop, outlet bell, open top, etc. that is on, within and/or in any way connected to a wind energy structure; some form of “self-activating” controls. If they are to ever continue to operate through any hurricane and/or tornado. My “open tops” that I referred to earlier, are to be considered as “transfer openings”, because they never fully close; for many reasons. For the patent application at hand “transfer openings” and/or “self-activating openings” refers to “any attempt, strategy, scheme, plan, assemblage of parts, occurrence, method and/or apparatus involving any self-regulating, self-activating, self-contained, wind energy operated, opening that allows air and/or pressure to be transferred/conveyed from one space to another without any restrictions, every minute of every day and may be as basic as a simple hole in a surface, such as an ‘open top’, which may or may not have a cover, that allows pressure to easily and quickly equalize between different spaces”. This makes them “self-activating”, since no external influence or control of any kind is required for them to operate properly. Plus they are “wind energy operated” because “wind energy pressures generated within the wind energy structure and/or over this ‘open top’ per Bernoulli's Principal, will provide the necessary energy to move air and/or pressure through these openings”.

An unreasonable person, like some USPTO Examiners, might say that “PARKER discloses an apparatus and method that includes transfer openings or channels, (20, 21, 22, 23), which openings or channels allow for passage of air from an internal area of the structure to an outside of the structure. PARKER also discloses valves (e.g., 24, 25, 26, 27), to allow for transfer of pressure. The valves are set to open or close at a predetermined external as well as internal pressure. The openings or channels would be the openings or channels themselves, (e.g., 20, 21, 22, 23), while the valves are the regulating devices, (e.g., 24, 25, 26, 27)”. As stated above, the openings PARKER claims will fail when they are needed the most, in high winds, while my “self-activating” openings will be even faster in high wind.

I know I can never leave any stone unturned so I will take the above unreasonable statement in detail, and show how it is actually a purposeful paraphrasing of PARKER's statements out of context; and purposefully manipulating them into a false assertion; in order to purposefully confuse an extremely clear issue. Every time PARKER mentions these “openings” and “valves”; he uses the complete phrase “openings 20, 21, 22 and 23 with opening operators 24, 25, 26 and 27” making them what PARKER himself only calls his “controlled openings”. Which do not fit any definition of a “transfer opening”, especially all of the definitions within the application at hand. Every time PARKER ever mentions openings 20, 21, 22, or 23 in later statements concerning his drawings he uses these exact words “the closing of opening 20 by motorized opening operator 24 and the opening of opening 22 by motorized opening operator 26”.

PARKER never separates his “openings 20, 21, 22 and 23” from his “opening operators 24, 25, 26 and 27”. So he never teaches applying his “openings 20, 21, 22 and 23” without also applying his “opening operators 24, 25, 26 and 27”. So PARKER is only teaching “controlled openings”, or “openings with valves” as these unreasonable people might now call them! PARKER's shutters are not controlled and are just a method and apparatus for protecting “windows” from high winds and the associated flying debris; and have nothing to add to this discussion concerning “transfer openings” and/or “controlled openings”. For clarity, PARKER does teach “controlled openings”, “that allow air to pass from an internal area of the structure to an outside of the structure”. But that is absolutely all that PARKER teaches on this all important issue.

Therefore, PARKER only teaches how to use “controlled openings”. He never even uses the words “transfer” and/or “transfer openings” anywhere within his disclosure. PARKER only uses the term “controlled openings” when referring to his openings. If PARKER wanted to use the term “transfer” and/or “transfer opening”, he should have. Plus, he should have then explained exactly how different “transfer openings” are from his “controlled openings”. He has the burden to go into detail and explain exactly how, when and where he wanted to use any “transfer openings”, just like he did concerning exactly how, when and where he wanted to use his “controlled openings”. But he never does, and something this important cannot now be inferred or assumed by you; or any other unreasonable person. Further, PARKER never mentions any desire to use any “un-controlled openings” which are exactly what “transfer openings” are. My “transfer openings” are really the exact opposite of PARKER's disclosed “controlled openings”.

For a far more complete argument against PARKER teaching anything about “transfer openings”; please page 36, line 21 through page 43, line 26, within my named “METHOD AND APPARATUS TO UTILIZE WIND ENERGY WITHIN A STRUCTURE TO PROTECT IT FROM HIGH WINDS” application. I filed it on the same day as this application. It is just as important within that disclosure as it is within this disclosure; and possibly even more important, because critical humidity movement issues are involved. So, I had to take much more time and go into much more detail, to describe how the USPTO took PARKER's words out of context and manipulated them into a false assertion; confusing a simple issue.

I have been through the Patent Examination Process before and found to my dismay that there are some very unreasonable Examiners there at the USPTO; that enjoy in taking the prior art out of context, and then purposefully paraphrasing it into many false assertions! Just like the one above, concerning “transfer openings”! I have learned the hard way that they find great joy in purposefully confusing simple issues! I hereby formally demand that any Examiner on any of my patent applications, including this one, stop paraphrasing the prior art, whatsoever! And supply the exact words of the prior art in context and in “quotation marks” along with exact page and line numbers involved! So we can all at least begin with the real truth; instead of lies made up by Examiners! Please stop paraphrasing the prior art into purposeful false assertions; which misleads everyone and confuses perfectly clear situations. All of which is extremely frustrating, time consuming, wrong and a clear abuse of your power and privilege.

Per my above argument on the issue of “transfer openings”; I only use PARKER's exact words to disprove your false assertion. This issue could not be more important! You are now attempting to take away my claims involving my “open top” from me, by saying that PARKER is teaching “transfer openings that allow for the passage of air from an internal area of the structure to an outside of the structure”. When he does NOT! For over eight years USPTO Examiners have attempted to take my ideas with just these types of false assertions. Even if I do “modulate” my “open top” if will still be 100% opened at least 98% and then 10% opened 2% of the time; but it will never fully close. When I use my “fixed” open top, it will be 100% opened, 100% of the time. Further, PARKERS's reasoning for opening and closing his controlled openings is in no way related to the reasoning I use for modulating my open tops. Which means that this separates our ideas “as a whole”, which with any other inventor would have been enough! I need my open top 100% open at least 98% of the time to maximize my use of “Bernoulli's Principal” within my wind energy structures. PARKER never discloses any opening on any structure that will never fully close, because he never expresses any interest in employing “Bernoulli's Principal” within any structure. I will only move my “open tops” towards close for safety and maintenance purposes. It can never fully close or my wind energy structures would become unserviceable “ovens”. And if I left the fully opened all of the time it could result in a catastrophic failure during a hurricane and/or tornado. While making routine maintenance an extremely dangerous game of “dodge the wind turbine blades, or die”.

Before I filed any patent application I first looked around to see what anyone else was teaching. I directly addressed PARKER in the beginning, back in 2006 and you are still making me address him over eight years later and the USPTO has paraphrased him over fifty times to make it seem like he has invented all of this. Well, he did not and his writings prove that he really had very little understanding of structure pressure. He got almost every big issue wrong. Please stop paraphrasing the prior art which misleads everyone and confuses perfectly clear situations; all of which is extremely frustrating, time consuming, wrong and a clear abuse of your power and privilege.

Please begin to use only the exact words of the prior art by putting it in “quotation marks”; in all future Office Actions; so we can at least begin with the truth. This eight year delay could have easily been avoided if you had ever once, just simply and completely read what I was saying and then asked me to clear up any questions you have. But instead you embarked on a time consuming and costly delay of purposefully choosing to paraphrase the prior art into multiple false assertions, trapping me in this patent examination process. You basically want to nullify the 23 years of hard work that I invested with false assertions; that are extremely frustrating and difficult to deal with. You should be ashamed, wouldn't you rather win with the truth, instead of lies?

A patent application is a contract where I publicly disclose my new, novel and non-obvious ideas; and in return I obtain twenty years of patent protection. So far I have spent eight years telling the same story, so you have all of my ideas; and at this point, I have nothing to show for all of the lost work time, hard work and money, that I have spent over those same eight years. I honestly thought that this patent examination process is supposed to be about utilizing solid science and physics; that could be proven with solid mathematics and the truth. If I had any idea of how rigged the patent examination process is; T would have never disclosed a single one of my ideas to any of you! But now you have my ideas and I have nothing to show for all of the hard work and money involved over the past eight years!

I had no idea that a corrupt USPTO had turned the patent examination process into an expensive perverted game of “stop me from taking your ideas if you can”; involving over fifty false assertions, vicious abuses of power and privilege, continuous manipulations of the truth, and this examination process. That have wasted over eight years of my life, while innocent Americans have continued to needlessly die. Yet you have approved patents based on magic, leaving me once again with the observation that the current USPTO relies much more on magic; along with a sick, ignorant and corrupt “USPTO good ole boys network”; than you do on any mathematics, science and/or physics. With all due respect, what has happened to you?

True respect of authority has limits; as authority continuously abuses its power, it is guilty of tyranny! British tyranny made our forefathers breakaway from England! Tyranny must never be silently endured; for this will only embolden power abusive, tyrants, such as yourselves! For the first 7 years of this process; I had nothing but total respect for you, this process and the USPTO; and my filings prove it! You may say that my current statements are “inflammatory”! Well with all due respect, “I say it is dishonest, despicable, abusive, inflammatory, malicious, evil, vindictive and much, much more; to continue to employ false assertions for over eight years in order to try to destroy me and take my ideas”! After 7 years of trying to work this all out in a respectful manner; I suddenly noticed that you had never treated me, or my ideas with any respect! Your Office Actions prove this! After initial respect is given to someone like you; continued respect must then be earned; and not blindly given when no true respect is returned! You have taught me to have no respect for you! You are a tyrant! Demanding respect when and where; none is due! I cannot continuously give respect; when none is given in return! You must treat others as you wish to be treated; or accept the consequences!

Are you now going to waste another three years of my life on this new false assertion, involving “transfer openings”? Just like you just did, insisting that air/wind/pressure can move from a low pressure area into a high pressure area! Please don't forget, you now owe me three new, top secret, “Laws of Physics” along with all of the mathematics that support them. ONE concerning your assertion that air/wind/pressure can move from a low pressure area into a high pressure area! TWO concerning any “Law of Physics” other than “Bernoulli's Principal” that allows wind to generate “lift” over the open tops of my wind energy structures; just as I have always disclosed within my applications and always shown in my current FIG. 1, ever since Dec. 24, 2008! THREE concerning a “Law of Physics” that will allow 69 F saturated air to fall through 109 F dry air and generate any measureable downdraft of air within a tower that only has an open top and an open bottom; with no other openings that could allow any heat to escape! I hereby declare that I will gladly sign a confidentiality agreement to keep your new “Laws” a secret; unless they are wrong, or fake. Then I am going to tell everyone!

You also wasted three years of my life by continuously insisting that I had a desire to use diesel generators within my wind energy structures; when all I have ever referred to is “wind”, “wind energy”, “dynamic wind energy” “dynamic pressure from wind” and the like. I have never even mentioned the word “diesel” in any of my applications since April of 2006. You just made that one up, right out of the blue; when I was disclosing wind powered devices mounted on “swivels”. Meaning that you are stating that diesel electrical power generators can swivel onto their sides; and/or even upside down. I know you are reading this new application with only one thing on your mind; to find that one word, or even better, that single phrase, where I was not perfect. So you can file another USPTO Office Action and waste another three years on a simple issue that could easily and quickly be cleared up; if you only wanted too. Just like you have done for the past eight years! You are so cunning that you usually had two to three overlapping false assertions going at any one time; in an abuse of power and privilege.

Plus, you wasted three years saying that I was not showing a wind powered device within my wind energy structures; even though on Dec. 24, 2008, I purposefully changed all of my then FIGS. 1-5 to “cross section drawings”; to clarify that my wind powered devices are clearly “within/inside” of my wind energy structures as shown on that FIGURE-5. Why? Because I knew exactly how Webster's defines “cross section”; as “a view or drawing that allows what the INSIDE of something looks like”. But for those three years you kept asserting that I was saying my wind powered devices were outside of my wind energy structures. How do you get away with doing this to me? This is a simple issue that could have been easily cleared up; but you kept using your power to insist that I was saying something that my drawings and my application prove that I was not saying. Why would I go to all of the trouble to capture, channel and concentrate wind energy within a structure as I clearly disclose; only to then ignore it and mount a wind powered device outside of that very structure? Plus, over five years ago I requested that you supply a single phrase; where I expressed any desire to mount any wind powered device outside of any structure. And to date you have ignored my request. Please reply. But you won, you wasted three years of my life on this issue.

It seems that at this time, I have no other alternative than to finally agree with the Examiner that installing multiple wind powered devices and/or machine devices to structures is obvious in light of POLYAK (U.S. Pat. No. 4,122,675), ROSSEL (U.S. Pat. No. 3,707,812) and/or RICHARDS (U.S. Pat. No. 7,358,623)! Because if I disagree, I would lose everything, because while I was waiting for eight years for you to honestly review my ideas; the USPTO granted other patents that included my ideas but were filed after I disclosed “mounting wind powered devices within structures” and “mounting wind powered devices in stages within structures”, to the USPTO on Dec. 24, 2008! That is really cunning!

I must disagree that PAGE (U.S. Pat. No. 6,438,900) teaches anything about any wind powered devices, nor does he address using wind in any way! In the future, I also need you to exactly quote the prior art whenever you refer to it. This especially concerns your comments concerning PAGE involving what he says on column 3, line 64 to column 4 line 9. The only way that the USPTO allows me to view PAGE on your website, does not comply in any way whatsoever with the columns and lines you have reference. Please furnish PAGE's exact words in “quotation marks” so I can find them in context and furnish an adequate reply. I read PAGE six times and found no reference whatsoever to any kind or shape of wind powered device. Nor does PAGE address utilizing wind energy to power any “self-activating openings and/or relief valves” within his fan powered inflatable structures for automobile storage. I just need to know exactly what you are saying, so I can provide an intelligent response. I have the distinct feeling that you took whatever PAGE said, out of context; and proceeded to paraphrase it into another false assertion.

It still mystifies me, how you could have ever said that ROSSEL's single wind powered device within a very small, totally open cupola, mounted on the top of an enclosed structure; that sits “directly into the atmospheric wind fluid flow”, teaches what I am teaching? When I want to mount 90,000 individual wind powered devices within a structure! Please tell me exactly how a totally open cupola, mounted on the top of an enclosed structure will ever “capture, concentrate and channel wind energy within that structure”; as I have disclosed for over five years! You could add a hundred or more cupola's with wind powered devices in each of them, to the outside of any structure; and you still cannot “capture, concentrate and channel wind energy within that structure”! Why have you spent so much time, to so obviously attempt to take my ideas, and waste over eight years of my life and destroy me; with such obviously ridiculous prior art?

Along with saying that POLYAK's duct means along with his associated wind powered device, which are both clearly mounted on the outside of a structure, teaches any of this? Again, you could add a thousand or more of POLYAK's duct means and his associated wind powered device on the outside of any structure; and you still cannot “capture, concentrate and channel wind energy within that structure”! When I have never said a single word about any desire to mount a single wind powered device outside of any structure in over eight years! I found no wind turbine in PAGE! And RICHARDS's entire wind turbine is mounted outside of the structure! There is no motivation for a reasonable person to just take a wind powered device that is mounted on the outside of a structure and then move it within a structure; without first knowing how to “capture, concentrate and channel wind energy within that structure”! No one before me has ever taught this all important issue!

On page 80 lines 26-29 of my application Ser. No. 13/135,239 I clearly state “Charles's Law and Pascal's Law are two totally different disciplines and cannot be directly compared with each other. Applicant's ideas employing Bernoulli's equations which were derived from Pascal's Law will produce exponentially more electrical power than any system based on “warm air rising”. Why will POLYAK'S air flow “upwards”, because his stated “convection air” is “heated air” and heated air will only rise. I clearly state that I am not trying to let air rise; instead I am depending on the naturally occurring low wind energy pressure that will develop over the “open top” of my wind energy structures; to pull/suck/lift vast amounts of air in only an upwards flow. Any reasonable person can easily understand the importance of this significant difference between my scheme, POLYAK'S scheme, and all other schemes based on warm air rising.

I now go to my previous claims 8, 9, 10, 13, 14, 15, 30, 31, 32, 35, 36 and 37, where I clearly added “wherein said channel is adjustable” from my application Ser. No. 13/135,239. Why do I do this, because as I clearly state on page 80, lines 22-26 “Please note that the wind 100 is coming from the right hand, therefore all of the channels 28 on that side have moved to open at a set point, while the channels 28 on all of the other sides have moved to close at a set point, to capture wind energy 110 and prevent it from leaving the structure 90.” While POLYAK never discloses, nor shows on his drawings; any form of “adjustability” on his “openings”. Why, because he wants as much warm/hot air as possible to enter his “duct means”, from all sides of the structure; as he clearly shows in his FIG. 2. POLYAK disclose that he wants “incident wind” to also enter his “duct means”; which actually proves that he does not know much about wind energy. Wind entering his “openings” on the “windward”, or wind impact side of the structure will actually cool down his “heated air”; completely defeating his primary stated goal.

Then this “windward wind” will go on to drive his entire scheme into failure; because it will become a low-velocity-high-pressure flow within his “duct means” that will simply blow his “heated air” right through his completely open “duct means” and right over to the “leeward” side of the structure; and actually blow his “heated air” right out of his fully opened “leeward openings”. This catastrophic failure will be assisted by the reactionary “suction force” generated by the well-known high-velocity-low-pressure wind energy pressure area that forms over the “leeward” side of every structure. This will generate a “pathway of least resistance” that allows all of his “heated air” and “wind” to completely bypass his “rotary turbine” and thereby totally preventing the generation of any mechanical energy. In other words, the increased resistance posed by his “rotary turbine”, linked with the pulling/sucking force generated at his fully opened “leeward openings” by the naturally occurring low wind energy pressure force that will occur there. Means that all of the air involved will just pass from the “windward” side of his “duct means” directly over to the “leeward” side of his “duct means” and flow out into open space; never passing through, or spinning his “rotary turbine”, whatsoever.

POLYAK'S FIG. 2 clearly shows no obstruction between the opposite sides of his “duct means” as they connect below his “rotary turbine”. Since air will always take the “pathway of least resistance”; it will just flow from the “windward” side of the structure, through his “duct means” and then out of his “duct means” and back into the atmosphere, on the “leeward” side of the structure; never producing a single kw of electricity. If POLYAK had ever build a single one of his schemes in the real world, he would have easily seen his mistake and fixed it with an additional patent; but he did not, proving his ignorance of “wind energy”; and his failure to complete his invention. And something this important cannot now be assumed and/or inferred! Also, with all of his “openings” fully opened over the height of the structure; his “heated air” will simply escape from his higher opening. Additionally, POLYAK'S scheme will produce little to no “heated air” in the winter and/or nighttime; and probably be totally destroyed, the first time it ever encounters a tornado, hurricane and/or other high winds.

I must also disagree that PARKER (U.S. Pat. No. 5,956,903) teaches anyone how to use any wind powered devices within any structure. Only the ideas expressed within this application actually makes wind powered devices usable within a structure for the very first time; by employing an “open top”. Which is not addressed whatsoever by either PAGE, POLYAK, ROSSEL, RICHARDS, PARKER and/or any other existing patent involving wind. I agree with the Examiner that PARKER only teaches air leaving a structure and never teaches anything about air entering a structure through the use of the words “high-pressure surface controlled opening is closed and the low-pressure surface controlled opening is opened”, which he repeats in this exact form, six times. Whenever high-velocity-low-pressure storm winds impact any obstruction such as a structure; they immediately slow to become a low-velocity-high-pressure. So, PARKER only teaches closing all “high-pressure surface controlled openings”, which will always be on the wind impact structure surface, thereby totally preventing any air/wind/pressure from entering the structure on any of his “high-pressure surfaces”.

Additionally, PARKER never discloses even the possibility that wind might be leaking/entering into the structure through this high wind energy pressure impact wall. Neither does PARKER ever disclose “opening the high-pressure surface controlled opening”; which means that with his scheme the wind impact controlled openings are always closed, totally preventing air from ever entering the structure. No reasonable person would then totally reverse what PARKER is teaching and leave the structure open to destruction with an “open top”, with wind energy now entering the structure though the wind impact wall. This would immediately destroy the very structure PARKER professes to protect! Leaving my ideas as disclosed with this application concerning “utilizing the power of wind energy within a structure” as new, novel and non-obvious.

He goes onto say “extremely low pressure on the downwind side of the structure causing higher internal pressures inside the structure” twice and only says that “higher” pressures exist inside the structure”. PARKER never disclose that any low pressures exist within the structure. This is extremely important. It is well established by Pascal, Bernoulli and even Webster's as stated earlier within this specification that air can only move from areas of high pressure into/towards areas of lower pressure. When all of the above are combined together, PARKER's scheme will only allow air to move from the “higher internal pressures inside the structure” through his opened “low-pressure surface controlled opening” and into the low pressures outside of the structure. Therefore, PARKER only teaches air moving out of structures and never teaches anything about air/wind entering a single structure, so PARKER could never “capture, channel and concentrate wind energy within a structure over its height”! So neither he, nor anyone else on this Planet; before me, could “utilize wind energy within a new or existing structure”. Additionally, the openings as taught by PARKER and/or FEX (U.S. Pat. No. 7,127,850) will never operate in the high winds encountered during storms, as clearly pointed out within this application.

As clearly pointed out above, RICHARDS, POLYAK, PAGE, and/or ROSSEL, only teach mounting wind powered devices on the outside of structures; “directly in the atmospheric wind fluid flow”! None are teaching anything about “capturing, channeling and/or concentrating any wind energy within a structure”! As I teach! So no reasonable person would have had any motivation and/or any sufficient reason to ever mount a single wind powered device within any structure! Until I began teaching all of this on Dec. 24, 2008! So in light of PARKER and/or even FEX (U.S. Pat. No. 7,127,850) who are both doing everything we can, to keep wind out of every structure; and teach nothing at all about allowing wind to freely enter any structure! As I teach! Definitely provides NO reasonable person with ANY motivation and/or sufficient reason to combine any of this mish-mash of unrelated prior art and then come up with the new, novel and non-obvious scheme taught by the application at hand! Of truly “mounting wind powered devices within structures” and truly “mounting wind powered devices in stages within structures”! Just like I have been stating and claiming, ever since Dec. 24, 2008! Only my NEW ideas could possibly close this gap! Especially since neither PARKER nor anyone else teaches anything about my unique application of “Bernoulli's Principal” involving my all-important “open top”! So I am the only person with ANY motivation and/or sufficient reason to combine these elements and legally “mount wind powered devices within structures” and truly “mount wind powered devices in stages within structures”!

How can you say that my advancement was anticipated in any way by PAGE, POLYAK, ROSSEL and/or RICHARDS, especially in light of PARKER? This all represents an enormous abuse of your use of the prior art; along with an enormous abuse of your power and privilege! Why have you done this to me? WHY??? Especially since my upwards flow of wind energy within my structures actually allows wind powered devices to float while they are working; reducing almost all blade-to-hub stress. Just like I have shown on my drawings for over five years. There has never been any structure with an “open top” that discloses “capturing, concentrating and channeling wind energy within that structure”; so why would anyone before me have any motivation, much less sufficient motivation, to combine these elements within that structure by adding a wind powered device within that structure; as I have clearly always shown since Dec. 24, 2008: and that you have continuously ignored for those same five plus years.

The only true answer is that “no reasonable person would have sufficient motivation to combine these elements”! I hereby formally demand that after eight years of waiting; that “you immediately provide me in clear detail why anyone before me would have sufficient motivation to combine these elements within a structure”! Using only the exact words of the prior art in context and in “quotation marks” along with exact page and line numbers involved! So we can all at least begin with the real truth; instead of lies made up by Examiners! Especially since PARKER never teaches about any “transfer openings”, whatsoever as I clearly point out herein. And especially since PARKER only teaches about air leaving a structure and never teaches anything about air entering a structure, whatsoever as I clearly point out herein! Additionally, are you honestly still saying what you have said for over eight years; that PARKER was teaching “ALL OF THIS”, much less “ANY OF THIS”, “AS A WHOLE”?? REALLY??? REALLY????

Maybe my obvious naiveté has left me ignorant as to the calculus of the USPTO, so with all due respect, after eight years of purposeful confusion by you; maybe I can come at all of this from another point of view, so I can calculate a time line. Will you please tell me exactly how many more Americans have to die in tornadoes and hurricanes; before you begin to tell the truth, the whole truth and nothing but the truth? Are we any closer, two little girls just died in Nebraska and New York? Along with exactly how many more American lives have to be torn asunder when tornadoes and hurricanes destroy their schools, homes, keepsakes, livelihoods, businesses and communities; before you begin to tell the truth, the whole truth and nothing but the truth? And please tell me exactly how many more Americans must die from coal and other fossil fuel pollution; before you begin to tell the truth, the whole truth and nothing but the truth. Please tell me exactly how many more Nations must be destroyed like Japan and the Ukraine by nuclear disasters; before you begin to tell the truth, the whole truth and nothing but the truth. Additionally, please tell me exactly how much our Planet must irreversibly warm; before you begin to tell the truth, the whole truth and nothing but the truth. Please tell me exactly how much polar ice must melt; before you begin to tell the truth, the whole truth and nothing but the truth. Are we any closer, ice is melting much faster than originally projected in Antarctica; which holds 90% of the World's ice?

Please tell me, so I can do some simple calculations and have some idea of when your purposeful manipulation of the truth will end. Then I will know exactly how much longer you are going to keep me trapped in this patent examination process. Please tell me? I am honestly not trying to be inflammatory, I just need to know where I stand in this process. Or you could just begin to start telling the truth, the whole truth and nothing but the truth. Even after all of these false assertions, and all these years of my life that you have wasted by using them; I truly hope that you can somehow find it within yourself to begin to tell the truth; so we can all finally move this application forward after eight years. Your endless Office Actions have actually become a valuable asset to me. They prove that the whole reason that this has taken eight years, is because you have refused to read what I have filed, with an open mind, if at all. Requiring that I must keep saying the same things over, and over, and over, and over again; and all of those past Office Actions will prove it. This is all so unjust! If you had actually ever just taken the time to read what I was filing, you would have been unable to try to give my ideas to others. My dreams have told me that I must here and now lay all of this out as clearly as I can, because my LORD has promised me that someone from outside of the USPTO, that still cares about their immortal soul, will eventually read all that I have filed since April of 2006 and hold all of you accountable and clean up this huge mess that you have made!

I mentioned and defined the word “stages” above; now let's look at the word “stages”, as I used it in my claim 24 on page 39, lines 5-6 back on Dec. 24, 2008 in my application number Ser. No. 11/401,566 where I clearly say “with modifications said energy can be funneled, channeled and focused through one or several stages of wind turbine generators”; which was linked to my claim 19 on page 38, lines 13-15 where I go on to clearly say “A method of using the energy contained within the dynamic pressure that can become trapped within a new or existing structure with a least one wall and at least one floor, by wind”. I did make an error by originally linking my claim 24 to my claim 18; an error I corrected in an additional filing on Apr. 5, 2009 on this same application number Ser. No. 11/401,566. I am exactly correct and clear about wanting to mount wind turbine generators “within/inside” of my wind energy structures; in “stages”. I went on in later applications to further clarify my use of the words wind turbine generators to include all wind powered devices and/or wind powered electrical generators.

I was in fact the very first person to ever mention and actually “claim” this possibility in my claim 23 and went on to “claim multiple” wind powered devices in “stages” in my claim 24 on page 39 in my Dec. 24, 2008 filing on my application number Ser. No. 11/401,566 filed on Apr. 11, 2006. Which were continued on in my claims 9-12 on page 38 of my application number Ser. No. 12/799,577 filed on Apr. 26, 2010; where on page 25 lines 3-5 I add that “My calculations show that there are no limitations to the number of electrical turbines, the size of the turbines, or even the combined weight of the turbines.” Claims that are continued herein within my method and apparatus claims, leaving my priority on the issue of “stages of wind turbines” extremely clear. Please see FIGS. 5-11 herein, for proof that there are “no limitations to the number of electrical turbines, the size of the turbines, or even the combined weight of the turbines.”

It is understood that these multiple “stages” of wind powered devices and/or machine devices may be applied to these wind energy structures in any form, shape and/or way imaginable including “stages” within “special casement channels” in a way that complies with Wikipedia's definition of “turbine” as a “a rotary mechanical device that extracts energy from a fluid flow and converts it into useful work” and adds “a pressure casement is needed to contain the working fluid as it acts on the turbine stages” and then adds “the casing contains and directs the working fluid”. The diameter of these special casement channels must enlarge after each consecutive “contained stage” of wind powered devices to provide a sufficient low pressure on the downstream side of each stage; or stagnation will occur. Plus in most cases but not all, each consecutive “contained stage” of wind powered devices, will have fewer blades.

I want repeat my above definition of, “stages” as “any attempt, strategy, scheme, plan, assemblage of parts, occurrence, method and/or apparatus for providing a series of positions and/or stations to contain multiple wind powered devices and/or machine devices within any wind energy structure and/or any connected but separate structure”. While “contained stages” only refers “to a situation where multiple wind powered devices are mounted within a “special casement channel”. I hereby declare that my original claims from Dec. 24, 2008 included both of these possibilities. I was operating under the assumption that since I was the first person to ever even mention this option; that I did not have to differentiate between these two possibilities, at that time. But it seems that the USPTO had other plans!

“Contains” as used by Wikipedia, is exactly equal to the words “trapped within a structure” that I used in my claims; especially when Webster's defines “contains” as “to hold within”. When Wikipedia says “directs”, it is exactly equal to the words “funneled, channeled and focused” that I also used in my claims; especially when Webster's defines “directs” as “to regulate the activities or course of”. Wikipedia does say that “wind turbines normally operate as a single stage . . . because they are normally fully immersed directly in the atmospheric wind fluid flow”! Which was the norm for the past 1,300 years, such as with all of those large idiotic propeller wind turbines, mounted in all of those idiotic wind farms. But everything changed when I came up with my new, novel and non-obvious ideas on exactly how to “contain” and/or “trap” wind energy within a structure and concentrated more wind energy over the height of the structure; so that I can then, “funnel”, “direct”, “channel” and/or “focus” this wind energy through as many “stages” of wind powered devices as I desired or imagined, for maximum efficiency. By “capturing, channeling, concentrating and/or utilizing wind energy within a structure”, where all of the “stages” of wind powered devices have been purposefully moved “out of the atmospheric wind fluid flow”!

Without a structure around my wind powered devices, there would be no way to “contain” and “direct” any wind energy through multiple “stages” of wind powered devices. Especially when I wanted to mount “contained stages” of wind powered devices, within my “special casement channels”; exactly as disclosed herein. I naively thought that I had established priority on this issue back on Dec. 24, 2008; but it seems you had other plans. A reasonable person might ask “why are the words that I used to disclose the word “stages” back in 2008, so similar to the way that Wikipedia defines “stages”?” Well, the answer is “I hereby declare that I knew about the Wikipedia definition back in 2008 and purposefully formed much of my claims based on this definition”. Proving my priority!!

My definition of “contained stages” of wind powered devices complies fully with my definition of “special casement channels” as disclosed herein. As far as mounting “contained stage” that comply with the above Wikipedia definition and my definition of “special casement channels”; the only applicable prior art that I could find, involves “wind tunnels” as disclosed within JOHN U.S. Pat. Nos. 8,120,191; 8,517,662, 8,643,204 and PICKETT U.S. Pat. No. 8,727,698. I have commented on U.S. Pat. No. 8,643,204 in previous filings on my application Ser. No. 13/135,239, but I hereby declare that the first time I ever saw U.S. Pat. Nos. 8,517,662, 8,643,204 and 8,727,698 was on May 18, 2014.

Within each, is the exact same paragraph: “In operation, wind (captured from the environment) flows from left-to-right through turbines T1-T3 with each turbine T1-T3 extracting some measure of energy from the air with energy availability being proportional to the cube of wind speed at each turbine T1-T3. Assuming that approximately 50% of energy may be extracted by each turbine T1-T3, it may be advantageous to make the swept area of the blades of turbine T2 half that of turbine T1, and to make the swept area of the blades of T3 half that of turbine T2. Should energy extraction vary from 50%, the ratios of the wind-swept area of the blades of the various turbines may change accordingly.” What JOHN and PICKETT are describing here is impossible according to the “Laws of Pressure”.

To prove my point, I will now analyze in detail exactly what JOHN and PICKETT are saying within the above italicized paragraph. They say “the energy availability being proportional to the cube of wind speed”. The short story is that JOHN and PICKET and just about everybody else on this Planet incorrectly thinks that “wind energy” and “wind power” are the same! They are wrong; and their ignorance has prevented them from ever correctly using even a single wind powered device within any structure. This actually means that JOHN and PICKETT are still looking at wind powered devices mounted within structures; as if they were still mounted “directly in the atmospheric wind fluid flow”! Proving beyond a shadow of a doubt that they do not know what they are doing! Meaning that they definitely do not know how to mount “stages” of wind powered devices within any structure; especially the even more difficult to design and apply, “contained stages” of wind powered devices, as I correctly use them within my “special casement channels”; and as they misuse them within their “wind tunnels”!

Please see my definitions on all of these issues herein. It just proves beyond a shadow of a doubt, that none of them have really never studied “structure pressures” for a single minute; but rather just sat in nice comfortable offices with all of their awards surrounding them, patting each other on the back and “guessing” at how to use “stages” wind powered devices within structures. But I know that simple answer will not suffice for you, so now I will discuss this all important difference in detail. Including exactly how it led JOHN and PICKETT and just about everybody else on this Planet; in exactly the wrong direction; whenever they even thought about mounting “stages” of wind powered devices within a structure! Much less the far more difficult task of mounting “contained stages” of wind powered device within a tunnel. I am just wondering exactly how many times you are going to make me say all of this; before you actually read it!

Part of the problem is that no one has ever written a clear definition of “wind energy”, until I did. I truly think that no definition was needed until I originally thought that “capturing, channeling, concentrating and/or utilizing wind energy within a structure”, was even possible, as I watched my skylight during hurricane IVAN. There is no need to define “wind energy” for any wind powered device that is “immersed directly in the atmospheric wind fluid flow” like all of those idiotic large propeller wind powered devices, sitting out in those idiotic crowded wind farms. Because those idiotic devices and their designers have absolutely no control over “wind energy”; so why define it, or even think about it. This fact actually proves that I was the first to ever invent “utilizing wind energy within a structure”; or someone else would have had to write a complete definition of “wind energy” before I did, over five years ago. Because they would have needed it if they were ever going to “capture, channel and concentrate wind energy within a structure over its height”!

The only important issue for everyone before me, was exactly how much “mechanical energy” can they get out of their new idiotic large wind powered device. So, all they ever worried about was “wind power”; and Wikipedia defines “wind power” as “the conversion of wind energy into a useful form of energy”. And my old Physics book says “when work is done upon an object; that object gains energy; the energy acquired by the objects upon which work is done is known as”, “mechanical energy”. Which is exactly why I defined “machine device” as “any attempt, strategy, assemblage, scheme, plan, assemblage of parts, occurrence, method and/or apparatus to purposefully transmit any and/or all of the force, motion and/or mechanical energy generated by a wind powered device, to operate any imaginable and useful assemblage of parts in any way imaginable, regardless of the output; additionally these machine devices can be directly connected to wind powered devices within the wind energy structure and/or connected through shafts, belts, drive lines and the like, with machine devices remotely mounted either inside and/or outside of the structure, thereby supplying them with mechanical energy”. Which clearly differentiates the two terms; and leaves “wind power” more akin to “mechanical energy” than to “wind energy”.

So I was left with the job of defining “wind energy” and I decided to start at the very beginning. This journey allowed me to learn even more about the “Laws of Pressure” than I already knew; and in fact helped me to better understand exactly how wind affects structures. Which in turn allowed me to fully understand exactly how to design my wind energy structures and my high wind structure protection scheme. A journey that I say no one else on this Earth has taken yet; because they had no reason to travel this path. The real truth is that “wind energy” is converted “sun energy”. The sun radiates energy onto the earth at an hourly rate of 174.423 billion kW hours. The earth heats unevenly due to many factors and this differential heating drives global atmospheric convection; which results in global atmospheric wind fluid flow. Ground surfaces interfere with this wind circulation, resulting in differential air pressures. Also, thermal low pressure areas form, due to localized heating.

Since localized areas of warmed air are less dense that any cool air that surrounds them; this warmed air rises which lowers the atmospheric pressure near that portion of the Earth's surface. Larger scale thermal lows over continents and bodies of water help drive consistent and strong wind speeds that can last for days, weeks and almost forever when aided by the Coriolis Effect, such as with trade winds. Winds are created when centers of low pressure develop; with systems of higher pressure surrounding them. Strong winds are created by deep pressure differentials between these low pressure areas; and the high pressure areas around them. The deeper/larger this pressure differential; the stronger the resulting winds. Wind is simply the movement of air between these atmospheric pressure systems on a grand scale; as these pressure differences try to balance themselves out.

Air is just the fluid, the important information is this dynamic pressure energy that is imparted on the air by these atmospheric pressure differentials. Air, plus this energy, is what we call wind; making “wind energy” a direct result of these pressure differentials. Remove the fluid (air) and you find that “wind energy” and “wind speed” are exactly the same force. Which is exactly why I have always referred to “wind energy” within structures as a “dynamic pressure energy”; ever since April 2006! Please check me out! Further support is found within physics, concerning the “kinetic energy of a moving body of air” which is “is the energy that a body of air possesses due to its motion based on accelerating that body of air to its stated velocity; having once gained this velocity, the body of air maintains this kinetic energy unless its speed changes; and as the velocity changes this kinetic energy changes proportionally”. Leaving “wind energy”, “wind speed” and “wind kinetic energy” as exactly the same force; allowing these terms to be used interchangeably, within the application at hand. And yes I do agree that when decelerating, “kinetic energy” can become “potential energy”; but “wind speeds” on this Planet are so volatile and ever changing; that this issue becomes somewhat irrelevant.

Which is exactly why I define “wind energy” as “any energy, motion and/or force derived from wind, wind speed, including pressure, pressure from wind, dynamic pressure, dynamic pressure energy, dynamic wind pressure, dynamic wind energy pressure, wind pressure energy and/or any version thereof regardless of how it is used”. The real truth is what I have stated ever since Dec. 24, 2008, including within this application. When dealing with wind, the energy available is not based on the cube of the wind speed; but instead the “wind energy” available is the “wind speed”, which is in turn based entirely on the square root of the pressure differential available between these various atmospheric low pressure areas and the surrounding atmospheric high pressure areas. As stated repeatedly herein, wind/air/pressure will only flow from areas of high pressure; into and towards areas of low pressure with the speed being determined entirely by the pressure differential that is present.

As pointed out above, these atmospheric pressure differentials are driven by uncontrollable forces of nature. Leaving man to adapt or die. When I began my calculations concerning using these dynamic wind energy pressures produced by these atmospheric pressure differentials, within a structure. I quickly came to the conclusion that I must adapt; or all air movement will die. Meaning that I was totally responsible for maintaining the proper pressure differentials within my wind energy structures; or all air movement will cease, allowing only stagnation. This means that only through proper structure design, can a controlled, pressure differentiated, operational space, be constructed; that will allow “wind energy” to ever be efficiently “utilized” within that structure. Every existing patent I studied including JOHN, PICKETT, PARKER, PAGE, POLYAK, ROSSEL and/or RICHARDS, never even mentioned anything about these pressure differentials.

Nor do any of them ever disclose how important “low pressure mathematics” is to designing the optimum operation space for wind powered devices within structures. They, and everyone else before me, only concerned themselves with the “high pressure mathematics” of incoming wind impacting the blades of their wind powered devices; because they were “totally immersed directly within the atmospheric wind fluid flow”, so they only worried about “wind power”. They could not control any of the downstream “low pressures” after their wind powered devices out in the open atmosphere; so they never learned a thing about these “low pressures”. So when they did try to mount wind powered devices within structures; they just simply continued to look at it all in the same way, by only worrying about “high pressure mathematics”! Completely ignoring the most important new issue; downstream “low pressure mathematics”!

I am the only one of us that fully understands how important it is; and I am the only one that knows exactly how to use “low pressure mathematics”, within a structure! Dooming their schemes to failure though stagnation! Which once again proves beyond a shadow of a doubt; that they have not studied how to mount even a single wind powered device within a structure. They have all just “guessed” at how to do it and ended up falling back on “high pressure mathematics” as their only guide. Well, they all “guessed” wrong! So I knew their ideas would always fail through stagnation; which also let me see that I was way ahead of everyone else. But you consistently refused to listen to me and slowly tried to take my ideas by employing over fifty false assertions! In a barrage of abuses of power and privilege; that only served to confuse every important issue for over eight years! While you gave my ideas to others!

These are not easy calculations, nor are they easy concepts to understand; because they are actually counter intuitive to what is taught in about every major University and Mechanical Engineering book on this Planet. Everyone thinks that the “Fan/Affinity Laws” and “high pressure mathematics” are the primary “rules of the road”. Which are the “Laws” that all before me have relied on; because they had not done enough “structure pressure” work. Especially structure pressure work that involved the effects of wind on structures. Which quickly taught me that the “Laws of Pressure” and “low pressure mathematics” were my primary “rules of the road” into figuring out how to create the necessary differential pressures within structures, which could then be utilized to power any number of “stages” and/or “contained stages” of wind powered devices. All of these calculations taught me how to efficiently and effectively utilize “wind energy” within a structure; and these calculations became the basis for what I call, the “Staged Wind Powered Device Laws”.

One of these “Staged Wind Powered Device Laws” is that “wind speed” and “wind energy” are the same force; that can easily be calculated by employing Pascal's teachings and Daniel Bernoulli's “dynamic pressure” equation: “the square root of a pressure differential in inches; times the constant 4005; equals the velocity of this movement of air in feet per minute”. In my calculations, and my “Staged Wind Powered Device Laws”, I just simply added “divide this number by the constant 88 to obtain the velocity in miles per hour”. Making “wind speed” a direct function of “the square root of this pressure differential”. That has been simply corrected for time and distance through the constant 4005; so that it can be easily used in all future “velocity”, “wind speed” and/or “wind energy” calculations. As clearly pointed out above, every time you slow down “wind speed” in any way; you have also immediately and proportionally diminished its “wind energy”. You have not converted it into a static pressure, that can later be converted back into “velocity”, “wind speed” and/or “wind energy”; as JOHN and PICKETT and just about everyone else thinks.

All of my calculations and all of my research teaches me that the available “wind energy” that exist within my “special casement channels” and JOHN and PICKETT's wind tunnels; both of which involve “contained stages” of wind powered devices. Is a direct function of the pressure differential that exist at (A) between the diameter, wind-swept area and/or cross sectional area upstream of a “contained stage” of wind powered device, in relationship to the downstream diameter, wind-swept area and/or cross sectional area, directly after that same “contained stage” of wind powered device; and/or (B) the intake of the entire tunnel, channel and/or structure, in relationship to the outlet of the entire tunnel, channel and/or structure.

So, as the pressure differential increases; the associated amount of available “wind energy” will proportionally increase, with the largest pressure differential generating the largest amount of available “wind energy” within a structure. Additionally, and even more importantly, as the pressure differential decreases; the associated amount of available “wind energy” will proportionally decrease. Within JOHN and PICKETT's “wind tunnels” the available “wind energy” is based entirely on “wind speed”; which in turn is based on the square root of the pressure differential available between the various stages of their wind powered devices. So the “wind energy” available has nothing to do with the “the energy availability being proportional to the cube of wind speed”. The cube of a number, is that number multiplied by itself twice; leading JOHN and PICKETT and just about everyone else, to multiply themselves right into a huge failure. Which also clearly proves that JOHN and PICKETT are moving/looking in exactly the opposite direction from me.

This huge error allowed JOHN and PICKETT to make all of the wrong conclusions when designing their “wind tunnels”. Their error made them do exactly what JOHN and PICKETT say they want to do in their disclosure and exactly what they show on their drawings. They decrease their downstream diameter, wind-swept area and/or cross sectional area, directly after each “contained stage” of wind powered device. Because they erroneously think that they can take their “wind speed” and multiply it by itself, twice to calculate their available “wind energy”. Therefore thinking they have exponentially more “wind energy” available to them, than they actually have; they decrease their downstream diameter, wind-swept area and/or cross sectional area, directly after each “contained stage” of wind powered device. Leaving stagnation as the only outcome. Incredible!

Since I based all of my calculations on the fact that “wind speed” and “wind energy” are the exact same force; I did exactly what I say I want to do in my disclosure at hand and exactly what I show in my drawings. I increase my downstream diameter, wind-swept area and/or cross sectional area, directly after each “contained stage” of wind powered device. Knowing that I must create a downstream low pressure area to keep the “constant air body volume” moving, after each consecutive wind powered device had just used up another hunk of my available “wind energy”, reducing my “wind speed” and my “constant air body volume” speed, accordingly.

JOHN and PICKETT never even mention the possibility of enlarging the diameter, wind-swept area and/or cross sectional area, downstream of each “contained stage” of their wind turbines. I am the only one that is teaching this. Instead they persistently disclose and consistently picture the wind-swept area and/or cross sectional areas, downstream of each of their consecutive “contained stage”; decreasing. JOHN and PICKETT do disclose “wind tunnels having a constant inner diameter”. This idea might work if there wasn't another issue involved; the “constant air body volume” moving though his wind tunnels. It must be remembered that the exact same “air body volume” that flows through T1, must also flow through T2 and T3, within the same wind tunnel. Meaning that while the available amount of “wind energy” is constantly diminishing; this “constant air body volume” never changes. Yet JOHN and PICKETT are reducing the diameter, wind-swept area and/or cross sectional area after each consecutive “contained stage” of wind powered devices and/or leaving it the same.

Even leaving the diameter, wind-swept area and/or cross sectional area after each consecutive “contained stage” of wind powered devices the same; will also generate an area of high pressure as this “constant air body volume” tries to enter it with less “wind energy” available. All of my calculations teach me that since this “constant air body volume” is being pushed into this similarly sized downstream area with less “wind speed”. That similarly sized downstream area will now represent a higher pressure area; or at least an area with little to no pressure differential; when compared to the upstream area. So, whether JOHN and PICKETT are reducing the diameter, wind-swept area and/or cross sectional area after each consecutive “contained stage” of wind powered devices and/or leaving it the same; the outcome is the same. An increase in pressure within each of the consecutive downstream diameters, wind-swept and/or cross sectional areas. And as JOHN and PICKETT attempts to force their generated wind into these consecutive high pressure areas within their wind tunnels; their differential pressure relationship between each consecutive area will slowly decrease towards zero, right along with their associated available “wind energy”; directly leading to a decrease in available “wind speed”. With stagnation as the most probable; if not only, result.

This will never work! Proving that what is taught as “Law” in one discipline may allow the overly educated to become overly confident; to the point that their inexperience reveals just exactly how ignorant and untested they actually are! Leaving them in the dark and unable to “free think” and actually see what is “Law” and the real truth, in a new discipline! What they are trying to do is impossible according to the “Laws of Pressure”. They might be able to decrease these diameters, wind-swept and/or cross sectional areas within their structures, if the “air body volume” was somehow being reduced and/or if no energy was being removed/lost from the wind energy fluid field. Such as with fan forced air within a duct; which is governed by the “Fan/Affinity Laws”; because they would just be simply transforming velocity pressure energy into static pressure energy; with the total pressure energy available, remaining the same. But their “air body volume” is not decreasing, nor is their total pressure energy remaining the same; because significant energy is being lost to propelling their wind powered devices.

This difference could not be more significant, and serves to totally separate what each of us is teaching, from the other. Any reasonable person can easily understand this dramatic difference, between what each of us is teaching. So JOHN and PICKETT should only be allowed to decrease the diameter, wind-swept area and/or cross sectional area, and/or leave them a constant size; downstream of each “contained stage” of their wind turbines. While I must always increase my wind-swept area after each consecutive “contained stage” of my wind powered devices. They will be free to apply what they are teaching and I will be free to apply what I am teaching. May the best idea win? Which is exactly how it should always be.

Additionally, since JOHN and PICKETT only shows the outlets of their wind tunnels parallel to the ground; they will have a major problem whenever wind blows directly into their tunnel outlets. Any impacting wind will immediately become a low-velocity-high-pressure force that will dramatically impede any outward flow from these wind tunnels. When they actually need a low pressure to form over his wind tunnel outlets; to pull/draw/suck air from these tunnels. I honestly wish JOHN and PICKETT and their assignees all the luck in the world in making this unique application actually work, so I can learn something new; and I consider learning something new, to be the absolute best outcome of any endeavor.

The real joke about “contained stages” of wind powered devices within a structure, as defined by Wikipedia and disclosed by JOHN and PICKETT within their “wind tunnels” and by me within my “special casement channels”; is that they are actually not as great and/or as efficient as many think. All of my calculations prove to me that 70 MPH winds are required to efficiently operate consecutive “contained stages” of wind powered devices. When I do increase my wind-swept area after each consecutive “contained stage” of my wind powered devices; while 100+MPH winds could be required if someone choses to decrease their downstream diameters, wind-swept areas and/or cross sectional areas, and/or leave them a constant size.

While my calculations concerning “stages” of wind powered devices within a structure; just as I show them on my FIGS. 1-11. Prove to me that stacks of side-by-side wind powered devices with open spaces downstream; can begin to operate efficiently in winds as low as 1.0 MPH. This positioning allows for the optimal number of options; for establishing the best balance between the upstream high pressure fluid field, and the required downstream low pressure fluid field. At each individual “stage” of wind powered devices; assuring optimum efficiency especially during low wind speeds. This is also why I say there should be several miles between each set of my double offset rows of side-by-side wind energy structures. This assures the best possible performance and that each double row arrangement, does not interfere with the incoming wind energy flow of the next double row arrangement.

Allowing additional wind energy to enter between the individual “stages” of wind powered devices, as I am teaching within my wind energy structures; technically makes them simple multiple “stages”. Allowing additional wind energy to enter between the stages like this, will not provide the necessary sealed casement to contain the working fluid; as disclosed by Wikipedia and/or by JOHN and PICKETT in their wind tunnels and/or me within my “special casement channels”. Basically when someone talks about how great “contained stages” of wind powered devices are; it can be considered as proof of their ignorance of the mathematics involved in “utilizing wind energy within a structure”. I hereby declare that ever since Dec. 24, 2008, I always intended to use “contained stages” of wind powered devices as defined by Wikipedia in my “special casement channels” in winds above 70 MPH; to effectively reduce storm force winds and generate vast amounts of mechanical energy.

With all due respect, does anyone there at the USPTO do any mathematics anymore? I don't think anyone there does! I would prefer that I did not have to address any of your mistakes; but my understanding of the patent examination process, requires that I clearly and openly point out my mistakes! Along with the mistakes of others, including the USPTO, that I become aware of during my research of the prior art; to promote the free exchange of the truth! Well, all of my calculations teach me that the USPTO no longer believes in valid science, mathematics and/or the “Immutable Laws of Physics”! Instead you must now only believe in magic! Webster's defines “magic” as “a power that allows people (such as wizards) to do impossible things by saying special words or performing special actions”!
1) Per my previous statements concerning wind energy pressure movements within JOHN and PICKETT's wind tunnels involving the “Laws of Pressure”; I am left with no other conclusion that the USPTO must believe that air/wind/pressure will magically move from any low pressure area into any high pressure area! Just like you said was possible with PARKER's scheme; for over five years! I am still waiting for you to provide the “Laws of Physics” and mathematics that supports either of your absurd statements!
2) “Avogadro's Law” teaches us “that a given number of gas molecules always occupies the same amount of space at a given temperature, regardless of the chemical composition of the gas”! Thus, the density of any gas depends on the molecular mass of the gas molecules! Dry air is a mixture of 80% nitrogen molecules with each having a mass of 28; and 19% oxygen molecules with each having a mass of 32! Based on these concentrations, their average molecular mass is 28.1! While the molecular mass of water is only 18! Therefore, humid air, which contains a mixture of air and gaseous water, is lighter and therefore less dense than dry air! So while JOHN and PICKETT's liquid water drops are much denser than both dry and humid air and will fall until they hit the bottoms of their towers; or evaporate on their solar heated tower walls over height! The humid air they create through evaporation, is less dense than the dry air below it! Allowing for only one outcome; his humid air will rise! Leaving me with no other conclusion than to think that the USPTO must think JOHN and PICKETT's lighter, less dense, humid air will magically fall right through the heavier, denser, dry air below it; magically generating 50 MPH wind! “Aabraa-Kaadabraa-Shazam”!!!!
3) Temperatures drop 5.4 F for every 1,000 feet of increased altitude outside of clouds and drop only 3.3 F within clouds. Helping JOHN and PICKETT by decreasing Yuma′s 109 F down to 96 F at the top of their towers! The dry monsoon Haboobs of June and July begin within clouds that on average start at 20,000 feet and top out at 30,000 feet, providing a middle height of 25,000 feet; reducing Yuma's 109 F down to −15 F! The wet monsoon Haboobs of August and September begin within clouds that on average start at 10,000 feet and top out at 40,000 feet, providing the exact same middle height of 25,000 feet; but now only reducing Yuma's 109 F down to 05 F, due to increased cloud residence! With either of these, if JOHN and PICKETT reduce their ground temperature below 109 F, then the corresponding cold cloud temperature also reduces; by exactly the same amount! Interestingly, the report that I used to obtain this data; is from the School of Geographic Planning here at Arizona State University! ASU only shows Haboobs starting in June, July, August and September! Per Wikipedia, “Haboobs” result from “collapsing thunderstorms, which occur when the normal updraft of humid air into a cumulonimbus cloud is chocked off by a cold (05 F to −15 F) downdraft of air falling; resulting in a severe downburst known as an Atmospheric Gravity Current”! This unique set of conditions only occurs in Arizona about 8-15 times a year and only during summer; which actually makes them extremely rare! I have never seen nor even heard of a single Haboob, during any winter, nor any fall, nor any spring; nor of one starting at night, even during a summer night, here in Arizona, just as ASU states! Additionally, I have been working in the Arizona desert for the past 9 years near Yuma, and for every one summertime haboob that I have endured; I have encountered at least 10 normal thunderstorms with little to no wind! Yet JOHN and PICKETT want to create a Haboob every minute, of every day; one after another, after another, after another, etc.! Which is based on the speed of their falling water, which takes a single minute to transverse the height of their solar towers! If JOHN and PICKETT somehow think that they only have to start a single Haboob and that it will then run forever, is ludicrous; or every Haboob that ever started, would still be blowing today! JOHN and PICKETT must think that if they just simply “mimic” a very insignificant part of a Haboob; “evaporating falling rain” or “virga”, that they can then somehow “magically” extrapolate this into the much more significant event of a “collapsing thunderstorm”! Again, for each Haboob I have seen here in Arizona; I have seen 10-15 occurrences of virga, with absolutely no ground winds! In fact, virga only occurs when it is real hot and it starts to rain; and the rain then immediately evaporates leaving nothing to cause any “severe downburst of wind”; as the humid air simply rises right back into the clouds! Will their magic “falling water droplets” extrapolate into hurricanes in Florida! Tornados in Texas! Heal the sick and dying! Bring back our youth! Or simply make fools out of everyone that believes this nonsense! The real truth lies within the description of “Haboob”, as “collapsing thunderstorms, which occur when the normal updraft of humid air into a cumulonimbus cloud is chocked off by a cold (05 F to −15 F) downdraft of air falling”! JOHN and PICKETT have no “cloud” which is defined as “a visible concentrated mass of cold liquid droplets or frozen crystals of water”; nor can they create one at the top of their wind towers with the 96 F air and 74 F water, they have available! And they need this “concentrated mass of cold water droplets” to form and then initiate their desired “collapse and/or subsequent cold downdraft of air falling” if they are ever going to generate “a severe downburst of air/wind”! NO “cold cloud”; NO Haboob! NO Haboob; NO wind! Leaving me with no other conclusion than to think that the USPTO thinks that JOHN and PICKETT can magically create a “collapsing concentrated cold cloud” with only 69 F air! Resulting in a Haboob and/or an Atmospheric Gravity Current; 1,440 times a day! 525,600 times every year! Forever! How? With which “Immutable Laws of Physics”? With what math?
4) When these Atmospheric Gravity Currents begin within these 05 F to −15 F cold saturated cumulonimbus clouds; this cold, dense saturated air will rapidly fall, easily dragging much more air with it; “generating” 20-60 MPH ground winds! Please tell me exactly how JOHN and PICKETT are going to reproduce this same Atmospheric Gravity Current within their wind towers that top out at 2,250 feet; when the “design temperatures” for summertime is 109 F dry bulb and 72 F wet bulb! I have attached the chart that provided this data; as FIG. 10! I must admit now that “evaporative cooling” is not a subject that I have spent much time studying; because I am from the humid Southeast, where it has no application! I have now devoted several weeks studying this issue, and have found that I was wrong to even bring up the groundwater temperature! I have learned that the wet bulb temperature is now the most important issue! I apologize for my ignorance and any confusion that I caused by it! I still have no understanding of where the “heat” within his 109 F air and 74 F (per EPA data) groundwater, disappears too! Especially when my total heat calculations teach me that their air temperature should be around 86 F when his water arrives at the tops of his towers at 82 F on 109 F summer days! Giving JOHN and PICKETT the benefit of a 100% efficient heat transfer, they will achieve a 37 F temperature drop; leaving their final cooled air temperature as 72 F! To be honest, most of the wet bulb temperatures that I found for the summertime in Yuma; averaged out at 66 F! So to assure fairness, the average of 72 F and 66 F is 69 F. Which is still much warmer than a 05 F to −15 F saturated temperature! I think JOHN and PICKETT forgot that the monsoon is active during the summertime here in Arizona; dramatically increasing average humidity levels, while dramatically reducing their performance! Everyone I know here in Arizona; turns their “evaporative coolers” off, throughout July and August; because they stop working! Leaving me to think, that the USPTO must think, that none of the “Laws of Thermodynamics” apply to JOHN and PICKETT; and that they can magically create energy from nothing and magically turn a 69 F saturated air mass into a 05 F to −15 F air mass! “Aabraa-Kaadabraa-Shazam”!!!!
5) If JOHN and PICKETT intend to cool their water and/or air, down to around 05 F to −15 F; this would represent a huge investment of capital in a 109 F desert climate! An investment that they have never mentioned a single word about, in any of their advertisements! This might come as quite a shock and unwelcomed news to their investors; because it will represent a substantial new fixed cost, just like their enormous fixed pumping costs; because pumps are only about 60-70% efficient! Probably leaving JOHN and PICKETT producing the most expensive electrical power on this Planet; at a production cost disadvantage to all other forms of electrical power generation; including all fossil fuels and nuclear! Leaving me with no other conclusion than to think that the USPTO must think JOHN and PICKETT can magically create the energy necessary to magically cool a 69 F saturated air mass, down to a 05 F to −15 F saturated air mass! “Aabraa-Kaadabraa-Shazam”!!!!
6) Please tell me exactly how JOHN and PICKETT can ever generate his stated “50 MPH downdraft of wind” within his wind towers; in light of the above arguments! Especially when the “terminal velocity” of a falling 6 millimeter “water droplet”, which is a normal sprayed water droplet and about the size of a normal housefly; is between 22-29 miles per hour; or 1,930-2,560 feet per minute; or 32-42 feet per second! Which means that on average these water droplets will fall their entire 2,250 feet in a single minute; which is really fast! My calculations also show that JOHN and PICKETT do not have enough time and/or distance and/or time residence to “generate” anywhere near their stated goal of a “50 MPH downdraft”, within his wind towers! My calculations teach me that JOHN and PICKETT's towers must be at least 14,260 feet tall and take about eight times as much water as a 2,250 foot tall tower; so he can take advantage of the 32 F cold air available, even on a sunny day! To initiate his desired “collapse and/or subsequent cold downdraft of air falling” if he is ever going to generate “a 20-60 MPH severe downburst of air/wind”! I cannot even calculate the pumping horsepower necessary to overcome gravity and pump their enormous quantities of water to that height! Nor how they will construct such a tower; but the view from the top would be breathtaking! Leaving me with no other conclusion, than to think that the USPTO must think, that the “Laws of Motion” do not apply to JOHN and PICKETT; allowing them to magically trick air (which is a “gas”) into magically falling at 50 MPH air; when his 74 F groundwater (a “liquid”) is only falling at 29 MPH! Where exactly does this added 21 MPH of velocity (“wind energy”) come from? “Aabraa-Kaadabraa-Shazam”!!!!
7) As a United States Citizen that pays taxes and well over $10,000.00 in fees to support the USPTO; that has also spent over 23 years of my life studying, exactly how “heat”, humidity and pressure move through structures! I hereby formally demand that you provide me with the exact mathematics, “Laws of Physics” and psychrometrics that you used to approve JOHN and PICKETT's ability to generate any air temperature much below 65 F for Yuma, Arizona on an average summertime day! To cool this air past 65 F, JOHN and PICKETT will need additional energy from some unknown and previously undisclosed source! The “First Law of Thermodynamics”, which is also known as the “Law of Conservation of Energy” clearly states that “the total energy of a system can only change if energy is transferred into or out of the system; which means that it is impossible to create or destroy energy; meaning that the total energy of a system can be calculated by adding up all forms of energy in the system”! With only an open top inlet and an open bottom outlet, JOHN and PICKETT have created an “isolated system”; that has no ability to “transfer any heat out of his wind towers”! Then to this, they must add the additional “heat” that is transferred into their towers as their water “evaporates” on their solar “heated” tower walls over their height! My “total heat” calculations teach me that their 69 F saturated air temperature will dramatically increase as each and every gallon of water that evaporates off of their “heated” side walls; pumps around 8,700 BTU of additional “heat” directly into their already warm 69 F saturated air! The “Second Law of Thermodynamics”; states that “the entropy of any isolated system never decreases; they spontaneously evolve towards thermodynamic equilibrium”! I say they will be lucky if their air does not rise above an 86 F saturated temperature; which is much lighter than the 109 F dry denser air below it! With some calculations leaving his saturated air at or near 90 F+; which is much, much, much lighter than the 109 F dry air below it! This additional solar “heat” energy is not being transferred outside of their towers; nor is it magically disappearing! And JOHN and PICKETT have never even mentioned it; once! Leaving me with no other conclusion than to think that the USPTO must think that JOHN and PICKETT, can magically create even more energy from nothing; magically prevent all evaporation on their solar “heated” side walls; while magically moving “heat” out though their solid tower walls; and/or magically disappearing this additional “heat” to some magic location! This calls for an extra loud and extra big, Shazam” !!!!
8) If the USPTO took any form of additional “evaporative cooling credit within HANDBACK's structures” by saying that each gallon of water that he evaporates into the air within his “isolated system”! Is somehow cooling the air within his towers; by misapplying the standard “latent and/or sensible cooling equations”! Then you have made a huge and unforgivable error! You have subtracted “heat” through a non-existent cooling credit; when you should have been adding “heat” as his water evaporates from his tower walls! Which could be considered criminal when this obvious error is used to entice investors into a scheme; through this form of abusive and purposeful manipulation of mathematics! Mathematics that the average man on the street is very ignorant of! Once again leaving me with no other conclusion than to think that the USPTO must think that JOHN and PICKETT can magically move heat outward through the solid walls of their wind towers and/or somehow magically create cold air energy, out of thin air! Or, more accurately, should I say out of warm saturated air! Hey! Wait a minute! Have JOHN and PICKETT actually discovered “perpetual motion”? Which is defined as “motion that continues indefinitely without any external source of energy”! I don't think so; but it sure seems like they are using a version of “perpetual motion” to entice investors! This type of solar wind tower that the USPTO has approved, is impossible; as it violates the “First and Second Laws of Thermodynamics”! Leaving me conclude that the USPTO must think that JOHN and PICKETT are actually GOD and able to create something from nothing! May GOD have mercy on your souls, or maybe not!
9) I have gone to great extents within this application to describe exactly how “Bernoulli's Principal” will generate a low wind energy pressure area over my open top and lift vast amounts of wind energy upwards through my wind energy structures! Once again leaving me with no other conclusion than to think that the USPTO must think that air will just magically pass right over JOHN and PICKETT's open top and magically never generate any lift and just allow air to magically fall into their solar wind towers! At 50+MPH!
10) There may be a few Planets in the vastness of space that could possibly support the physics that JOHN and PICKETT are depending on; to make their scheme operate properly! Where humid air is heavier than dry air; and heat can magically move outward through solid wind tower walls! Where 69 F saturated air is considered cold and dense; and is exactly equal to 05 F to −15 F saturated air is on this Planet! Where “Bernoulli's Principal” does not apply! Where air/wind/pressure will magically move from any low pressure area, into any high pressure area; in violation of the “Laws of Pressure”! Where JOHN and PICKETT are gods and their word is law on that Planet; and things occur there the way they want them too, simply because they wrote it down that way! Since JOHN and PICKETT refused to learn and observe the “Natural Laws” of this Planet; they must now spend a whole lot more time searching the Galaxies, for a Planet that does support their voodoo mathematics, voodoo science and voodoo physics! Along with exactly how they are going to get there! Because Earth just happens not to be that Planet!
11) This all means that the USPTO must study this issue in detail and if my assertions are found valid! Then the USPTO must void JOHN and PICKETT's granted patents as unworkable violations of “Avogadro's Law”, the “Laws of Thermodynamics”, the “Law of Conservation of Energy”, the “Laws of Pressure”, “The Laws of Motion” and “Bernoulli's Principal”! Plus, these violations prove that JOHN and PICKETT have “failed to produce any useful new process, machine, manufacture, or composition of matter, or any new and useful improvements thereo”; which is a major requirement of the USPTO! Instead they have created “a process based on magic instead of sound physics, mathematics and science; that can harm individual investors along with causing irreparable harm to the future of wind energy”; and therefore do not deserve the protection a granted U.S. patent would offer them! Their ideas are not new, nor are they novel! They are magic!

JOHN and PICKETT will still be free to pursue their ideas and build their “solar wind towers” and “wind tunnels”, wherever and whenever they want; just without the USPTO's “seal of approval”! As long as they do not infringe on any of my ideas expressed herein; and/or start increasing their wind-swept area after each consecutive “contained stage” of wind powered devices within their “wind tunnels”! Then the USPTO must allow me to freely alter my claims accordingly; including a complete review of PAGE, POLYAK, ROSSEL and/or RICHARDS; especially in light of PARKER! I want my ideas back! Which is why I included my arguments against all of these prior art patents again, herein! I was the first to ever disclose the possibility of truly “mounting wind powered devices within structures” and “mounting wind powered devices in stages within structures”! Why was I the first? I was the first because I spent 23 years of my life learning that these things were possible! Then my LORD, JESUS CHRIST gave me these ideas in dreams; HE did not give these ideas to JOHN, PICKETT, PAGE, POLYAK, ROSSEL, RICHARDS nor PARKER! But you did give these ideas to JOHN and PICKETT! While I waited respectfully and patiently; trusting you to do the right thing! You stabbed me in the back! I can no longer continue to respect someone that continuously tries to destroy me; and take my ideas! To even think that I should continue to respect you; proves that you have become an intolerable tyrant!

I never found and you never supplied; a single patent involving “capturing, channeling, concentrating and/or utilizing wind energy within a structure”! As I have been teaching ever since Dec. 24, 2008! Especially, since no one else but me employed any “low pressure mathematics” as taught by the “Laws of Pressure”! As I have been teaching ever since Dec. 24, 2008! Leaving me as the only person on this Planet with any sufficient motivation and any sufficient reason to claim “mounting wind powered devices within structures” and “mounting wind powered devices in stages within structures”! You only supplied prior art that disclosed mounting wind powered devices to the outsides of structures! You then proceeded to extrapolate this into “mounting wind powered devices within structures” without furnishing any sufficient motivation and any sufficient reason; as to exactly how PARKER can accomplish this when he only teaches “air/wind/pressure leaving structures”!

JOHN and PICKETT's ideas will never generate enough wind energy to power a single wind powered device, and definitely not three! Yet my ideas can power 90,000 wind powered devices within a single structure; and even more within larger structures! None of them ever spent any time learning what I am teaching! That is why a reasonable person can easily tell how obviously different our ideas are from each other's! Those 23 years should not be ripped away from me, by people that have most probably never spent a single minute studying “structure pressures”! And without this 23 years of knowledge; their ideas are doomed to failure! You have the “power” to destroy me and take my ideas; but you do not have the “right” too! You have ruined eight years of my life!

The time has come for the USPTO to acknowledge your errors and to do the right thing; and show everyone that the “truth” still wins in America; and that hard work and sacrifice are still honored here in America! While showing the evil and the greedy that they cannot manipulate everything; and just take what they want, when they want, from whomever they want; without being held accountable! The time has finally come for you to correct all of your abuses of the past eight years; set things right and give me the patent I have always deserved! Or will you just prove to be one more group of corrupt men; that will destroy the innocent to hide the evil you have perpetrated here; and refuse to be held accountable for all of the damage, death and destruction you have caused? GOD is watching and HE is listening!! Personally, I think some considerable form of remuneration should be involved! In a version of the “Golden Rule”; I will settle with the USPTO for 100% of the retirement monies of each and every USPTO examiner, supervisor, reviewer, etc. along with each and every other party within the USPTO, especially any management that aided and abetted them; over the past eight years! Why? Primarily because they have succeeded in wasting most of my retirement monies!

I know it is dangerous to speak the truth to power; so I respectfully ask, “have most of you just become glorified, overpaid, arrogant, self-centered, abusive, paper pushing, spell checking, word police (“automatic”; “to”; “within”); who are owned by Politicians”? When you actually should be well paid and respected “idea police; that care about their immortal souls and whom are only owned by the truth; and whom only owe allegiance to the first person that tells the truth; using only valid science, valid mathematics and valid physics”! Respectfully, I say that this is all just a clear example of what happens when the USPTO refuses to just simply do the job that you are assigned and actually paid for; and starts playing politics with inventions, inventors and new ideas! Is it just so you can get invited to the next big political shindig? You must also think that it is just fine to use the unlimited power of the USPTO concerning the patent examination process! To deny an inventor's his ideas and act against the best interest of America; by allowing those ideas to be taken by the rich and powerful of a certain political persuasion! Allowing these sick, evil and greedy men to then use them to strengthen and maintain their death grip on money, power, jobs and our energy supply; and ultimately America itself! Including you fools there at the USPTO! How sickening and dangerous!

Respectfully I must say that it is my opinion that the USPTO now considers “junk science” to be the “best science”; progressing to the point where the “junkier” the science the “better”! Something has gone horribly wrong there at the USPTO! I respectfully am startled at how “fast and loose” the USPTO now “plays” with science, mathematics and physics; and ultimately your own reputations! Have you actually become so “political”; that real science, math and physics no longer matter? I respectfully remind you; that they are called the “Immutable Laws of Physics” for an important reason! They are “incapable of or unsusceptible to change”; so they do not change for you; or for me; or for anyone else; or for any reason; even “political” reasons! Misrepresenting and misusing them and/or allowing others to misrepresent them and/or misuse them; have real world consequences! Especially on those that trust and need you!

With all due respect, have things there at the USPTO become so perverted that using magic and breaking and ignoring the “Immutable Laws of Physics” is the fastest way to get a patent! I defy you to tell me a single important issue and/or “Law of Physics”; that JOHN and PICKETT got correct! I also defy you to tell me of a single important issue and/or “Law of Physics”; that I got incorrect! Using only the truth this time! No more false assertions! Yet JOHN and PICKETT received patents in under two years, while I have waited for eight years! And I only based my ideas on sound and valid mathematics, science and physics! I am so old that I can remember when George Bush 41 called Ronald Regan's “supply side economic” ideas “voodoo economics”; and those ideas piled up our National Debt! Well with all due respect, it looks to me like the USPTO now engages in “voodoo science”, “voodoo physics” and “voodoo mathematics”! Leaving a pile of useless patents that serve no one; except those that want to prevent new ideas from ever being realized! By locking up valid ideas within granted patents that are based entirely on “junk and voodoo mathematics, physics and science”! While valid ideas are just taken; like my ideas of “wind powered devices within structures” and “stages of wind powered devices within structures”!

It is my opinion that JOHN and PICKETT's design of their “wind tunnels” and “wind towers”; along with the USPTO's approval of both; is based on either total arrogance of and/or total ignorance of, the “Immutable Laws of Physics”! I currently do not have enough information to know exactly which one is true! I guess they will sue me over this, and I already have a three inch stack of 8 by 11 sheets of paper filled with calculations linked to my above accusations! I look forward to getting ahold of JOHN and PICKETT's own calculations on these same accusations! I took the time to come at all of this from various directions and every time; my mathematics brought me right back to the exact same conclusions, shown above! I am such a nerd, that running long chain mathematics, is what I consider fun! While I am afraid of being sued; I can no longer sit by in silence! Something has gone horribly wrong with the USPTO; and it must change, immediately! I did not know I would become trapped within the patent examination process for eight years by a corrupt USPTO; and be forced into this horrible situation!

It is also my opinion that the approval of the JOHN and PICKETT's application may just represent a new cunning, despicable, arrogant, self-centered, self-serving, abusive form of patent troll! The underhanded, back stabbing tricks just never end there at the new corrupt USPTO; do they? All of JOHN and PICKETT's U.S. Pat. Nos. 8,120,191; 8,517,662; 8,643,204 and 8,727,698 must be voided; because without JOHN and PICKETT's “wind towers” they have no way of powering any wind powered devices, within any of their “wind tunnels”! This is why they need their “wind towers”; regardless of how many “Immutable Laws of Physics” their design violates, or whether their scheme will ever work, or whether it even makes scientific sense! Without their feeble “wind tower” ideas; they are left with absolutely no motivation to mount even a single wind powered device within their “wind tunnels” because there is not a scheme on this Planet that could ever “push” air through his “wind tunnels”! Absolutely no air/wind/pressure will ever move through any of his “wind tunnels” if they are just immersed “directly into the atmospheric wind fluid flow”! Wind will just take “the pathway of least resistance”; and totally bypass his “wind tunnels”! No one should be allowed to “lock up” valid ideas with ideas that will never work! Especially when those ideas have been previously filed with the USPTO by other inventors! Namely my desire to “mount wind powered devices within structures” and “mount wind powered devices in stages within structures”! From way back in December of 2008! Why isn't there a rule against this type of obvious abuse of the patent examination process! It is just more proof of how perverted this process has become; and how all of you have somehow made the entire patent examination process, all about yourselves, instead of new ideas! Why have you done this to me? I just wanted a patent on my ideas!

I do not know how to apply for “whistle-blower” or similar status and protection; nor do I know whom to contact about it! I am not a Federal Employee, but I have been trapped in the Patent Examination Process for eight years; forcing me into an intolerable situation with a corrupt Federal Entity, the USPTO! So if anyone is listening, I hereby declare that want and request full “whistle-blower” and/or similar status and protections! I will include this request in my complaint to the FBI! In good conscience, along with the fact that my dad would kick my ass if he was still around; I cannot just sit back and watch a corrupt USPTO grant a patent and thereby give their “seal of approval” to ideas that I have spent 23 years of my life trying to master; and know that these ideas approved by a corrupt USPTO; will never work! My LORD tells me that this must be done; to protect innocent Americans that mistakenly trust the USPTO, to do the right thing! Just like I used too! It is my opinion that your actions concerning these JOHN and PICKETT patents will leave innocent investors with legitimate negligence claims against the USPTO including the examiners involved; for failing to use due diligence, and valid science, physics and/or mathematics!

What has happened to you? You should be ashamed of yourselves; but most likely you will just try all the harder to destroy the messenger (me); instead of trying to address the message of exactly how, when and where you became so corrupt! It is scary to stand up to such a pack of wolves like you; and those you have granted inappropriate patents too! But after eight years, you have left me no other choice! I hereby declare that I will not initiate any legal action; but once sued I will be force to sue all who have damaged me! So if anyone does sue me for telling the truth; which seems to be the American way now! Then I will have to countersue so I can then subpoena all of the information I would need; to mathematically calculate which of the above possibilities is true! Along with exactly who is involved! I say that I have been far more damaged by the actions and words of others; than they have been damaged by me!

Respectfully, the past actions of the USPTO have tainted your integrity and ability to intelligently and honestly verify what I have asserted in above numbered paragraphs 1-9! So, I hereby formally request that the Physics Department of a major, reputable University that has no inside connections with me, the USPTO and/or JOHN AND PICKETT! Such as Notre Dame, Stanford, Tuskegee and/or M.I.T.; be brought in to mathematically analyze what I am saying in paragraphs 1-9! And finally do what the USPTO should have done three years ago. I have given you the results of my calculations; along with the exact “Laws of Physics” I depended on! These “Laws” will provide this third party with the mathematical formulas to use; so we can all see exactly how close I come to this third party's calculations! I think that they will find that I discounted my calculations in favor of JOHN and PICKETT! I say let them also analyze my use of the “Immutable Laws of Physics” as disclosed herein; to see if I am playing GOD! Honestly, after all of the negative things the USPTO has said about my ideas; I would love a third party's view of what I have said and how the USPTO has consistently manipulated the truth against me! For the past eight years! In other words, I want an independent, un-biased, intelligent and honest third party to check all three of us out! I am not afraid; in fact I welcome this additional scrutiny! It will represent the first independent, un-biased, intelligent and honest review of my ideas! If they prove me correct, then all of JOHN and PICKETT's existing patents must be immediately voided and appropriate actions must be taken against all USPTO employees involved!!

I respectfully say that it is “treasonous” behavior by those who have spent so much time trying to destroy me and take my ideas; especially when Webster's defines “treason” as “the offense of attempting by overt acts to overthrow the state to which the offender owes allegiance”! I say this is exactly what has been going on concerning my applications; particularly if any U. S. Government Officials are involved; especially Congressmen! My dreams clearly tell me that 126 Congressmen of a certain political persuasion, from 19 States; are involved! I sure hope the FBI checks this important issue out! By continuously delaying the approval of my new, novel and non-obvious ideas; they have put their self-centered desires for personal gain and glory, above America's National Security! My ideas will save American lives, provide economical electrical power to every American, while decreasing our expensive dependency on polluting fossil fuels! Currently, if Europe was not so dependent on fossil fuels from Russia; Vladimir Vladimirovich Putin would not be such a threat to every Sovereign Country around him! And thereby to America! All of these issues speak directly to our National Security! Leaving these perpetrators guilty of “treason” and “manslaughter”! Someone that still has a soul, needs to do something soon; before more Americans needlessly die!

Your actions represents such an egregious abuse of the public trust in our Government; the USPTO and the Securities and Exchange Commission! Along with the fact that for probably the twentieth time, I feel that my Civil Rights have been violated by your actions! I remind you that a United States patent is the right of every American Citizen; it is not a privilege to be manipulated by the greed, the evil, the rich and/or those in positions of power and/or by the USPTO itself! Again, I assert that as a United States Citizen, I deserve the protection a United States patent would afford me and my new, novel and non-obvious ideas as expressed in this application at hand! I feel that I am left with no other alternative than to file a complaint with the FBI; involving your actions concerning JOHN and PICKETT'S ideas, my ideas and your continued use of false assertions concerning the prior art involved! This will be my fourth complaint to the FBI on this and I have never heard back from them; so maybe you can continue on forever, since no body must care! I have also written President Obama about this intolerable situation four times, and never heard a word! So now I will copy my FBI letter to Congressman John Lewis from Georgia! My mom was born in Georgia, along with her mom and he is the only Congressman that I trust right now, so maybe he can help me!

Additionally, he is on the House Ways and Means Committee and a Ranking Member on the Congressional Oversight Subcommittee and maybe, just maybe, he can launch a Congressional Investigation into your abuse of power and privilege, while Americans continue to die and whole communities are ravaged by tornadoes and hurricanes, like hurricanes SANDY; IKE; IRENE; along with the tornadoes that hit Moore, Okla.; Joplin, Mo.; Tuscaloosa, Ala.; and many, many more. Costing America BILLIONS and unimaginable heartache.

I did not ask for this fight; I just asked for a patent! You lit this fire and started this fight will all of your continued abuses of power and privilege, approving ideas that defy the “Immutable Laws of Physics”, establishing a “USPTO good ole boy network” and using over 50 false assertions concerning the prior art, in a veiled attempt to try to destroy me and take my ideas! Well I am still here! And I pray every day that my LORD JESUS CHRIST “allows the fire that you have started; to consume you all, along with every one that has aided and abetted you”! With all due respect, ever since you began to use false assertion to purposefully create confusion and attempt to take my ideas; I have also prayed every day that my LORD, JESUS CHRIST “please allow me to become the stone that you shatter yourselves on”! I say my prayers are being answered!

You can manipulate the truth and just about everything else; just as you have done to me for the past eight years! But you cannot manipulate GOD, nor can you manipulate the “Immutable Laws of Physics”, that HE established! Go ahead, and jump off of a 70 story structure with nothing but the clothes on your back and let's see you magically manipulate the “Laws of Motion”; like you have magically manipulated the above six “Laws of Physics” with JOHN and PICKETT! This would allow you a perfect chance to teach us all; exactly how powerful your magic really is!

I began this application with the intent of only using 100 pages, but no reasonable person could endure the abuse that you have heaped on me for eight long, tough, years; without wanting to tell the World about it! Plus my dreams have continuously told me that I must use this application to make it extremely clear how despicable, manipulative, abusive, underhanded, corrupt, unjust and unfair you have been over the past eight years; while innocent Americans have died! You now have the blood of innocent American deaths on your hands! A five year old little girl just died in Nebraska! You have sold you soul trying to destroy me! Has all of this really been worth it for you! How sickening!

So I have invested $200.00 in another 50 pages so I can have my say! You have taught me that you will never treat me and/or my ideas with any respect and/or honesty! So I am writing all of this for the Scientific Community, with the hope that at least one of them and hopefully hundreds of them will speak up and stop you; and hold you accountable for what you have done here! They can easily read through the history of the three previous applications that I have filed on this issue over the past eight years; by simply Googling “patent application Ser. No. ______” website using application Ser. No. 11/401,566; 12/799,577 and 13/135,239! They can also lookup PARKER (U.S. Pat. No. 5,956,903), POLYAK (U.S. Pat. No. 4,122,675), ROSSEL (U.S. Pat. No. 3,707,812), RICHARDS (U.S. Pat. No. 7,358,623) and/or PAGE (U.S. Pat. No. 6,438,900); by Googling “U.S. Pat. No. ______” and see exactly how ridiculously you have used them to destroy eight years of my life! While innocent Americans have needlessly died! I have not been perfect; but I have been honest and I have tried to clear things up, every chance I had; while you have always done everything you could to confuse every single issue; dragging out this patent examination process!

So go ahead, keep trying to take the ideas that my LORD, JESUS CHRIST gave me! I for one, am very interested to see exactly what HE will do about it! HE told me exactly what to do with these ideas; and you have stopped all of that for over eight years! I am just naïve enough to believe that HE will not let you get away with all of this; without paying an enormous price! No reasonable person could put up with all of this injustice and not pray for justice and I say the best justice, is Devine Justice! I say that my LORD, JESUS CHRIST became the greatest teacher I could have ever hoped for. And that HE put me into all of these situations just so I could do all of this hard work and observe all of these incredible things! So I would be prepared to understand the dreams that HE then gave me; and know exactly what science and physics to utilize to build them; along with exactly what mathematics to employ, to prove it all!

HE just allowed me to become more prepared than the next guy! Is it really any surprise to anyone, that those who were not allowed to observe what I was allowed to observe; have been unable to use the correct assumptions, schemes, science, mathematics and/or “Laws of Physics”? It is no surprise to me, I know exactly who brought me to this party! I am willing to bet big that none of them has ever spent a single minute of hard, difficult and complex work; to actually learn a single thing about “wind driven structure pressures”; or any of these complex issues; especially how they all interrelate to each other! So they have nothing new to add to this subject, except confusion! Leaving them too continuously “guess”; and usually they have “guessed wrong”; revealing their ignorance! Yet you think you have the right to take away my dreams and destroy 23 years of hard work! WHY??

If you are reading this and you are in the Scientific Community, please do something! Please help me! What the USPTO has done to me; they could easily do to others; and this is not right! This current USPTO has wasted eight years of my life trying to take what is probably one of the greatest inventions that has been submitted to the USPTO, since America began! Something has gone horribly wrong at the USPTO! It seems that it is now much more important for an inventor and/or the greedy, corrupt politicians that back them, to know more people in power at the USPTO, than they know about actual and valid science, mathematics and physics! This new, sick, evil, ignorant and corrupt “USPTO good ole boys network” has progressed to the point that magic actually matters more that valid mathematics, science and physics! This should scare everyone in the Scientific Community! Along with everyone in America!

This is exactly why some politicians of a particular political party joke about global climate change; while our Planet teeters on the eve of destruction! My dreams tell me that these corrupt politicians do not believe in GOD! Instead, they think that they are gods; and that we should all serve them! They observe no Laws, especially the “Laws of Physics”, proving their hatred for GOD and the truth! They actually think that this World revolves around them and their endless stream of lies! They think that they can say anything and do anything; and never be held responsible! They actually believe that they are somehow untouchable! Well I promise you that GOD is watching us all and that HE is listening to all of us; and that HE is fed up with these evil fools; and their fool's paradise! He knows every hair on their evil heads and HE knows every evil thought that they have ever had and HE knows every evil word that they have ever spoken! GOD is always watching and HE is always listening! HE tells me that a reckoning is coming, HE tells me that HE has remove all of HIS protection from these evil fools and their entire families; leaving them vulnerable when hell comes to take these vicious, evil, soulless spawns of the devil, back home!

GOD knows that these greedy, corrupt politicians are not Christians; nor are any members of the “religious right” that support and vote for them; and that they never were true Christians! GOD knows that words are cheap, and that they will let any evil fool say them! Actions are what count and these evil men prove their hatred of GOD, every day of every year! They never listen to HIM, or heed HIS request! They turn their backs on the poor, the sick, the young, immigrants, the old and all other races than white; especially if they happen to be from some poor country! That does not have oil! My dreams tell me that my LORD JESUS CHRIST has recently sent all of these children to the United States from Central and South America; just to see exactly how these soulless, heartless, evil, hate filled, vile, despicable, “religious right” and corrupt politicians act! So HE will know exactly how to treat these spawns of the devil; when their time comes!

A reasonable person might wonder, “Why am I ranting and raving about corrupt politicians and the religious right at this time”? Well it is because my LORD JESUS CHRIST has given me at least ten clear dreams over the past five years; that make it perfectly clear that these are the exact people that have corrupted the USPTO and this patent examination process! Resulting in the eight years of abuse that I have had to endure; as disclosed herein! By professing to be Christians these corrupt politicians and the evil “religious right” that support them; are just proving that they are willing to lie about anything, and everything! Their belief in magic proves that they have been spawns of the devil since the day they were spawned, by other spawns of the devil! And like all good little spawns of the devil, they have continued to train and teach their own spawns of the devil, exactly how to viciously hate and lie about everything! They only trust other spawns of the devil; because they cannot stand to be around anyone that still has a soul!

I have an incredibly difficult time understanding exactly why they chose to sell their souls so cheaply and so obviously! I have been told to do nothing but watch and be amazed at the power of the LORD! They and their families will pay through all eternity for the true evil that they have become! Judgment and justice are coming; regardless of what you may believe! I am ready; are you? Mercy will be hard to come by! Maybe these politicians and “religious right” can just “talk, and talk, and talk” their way out of this judgment; just like they “talk and talk and talk” on the internet and their TV and radio talk shows! But GOD tells me that HE no longer listens to ANY of them! HE has grown sick and tired of their constant manipulation of the truth and HIS word and the sick, vicious, evil that they have become! If the good people of America just sit idly by and allow these evil, corrupt politicians along with an evil “religious right” to continue unchecked; then they will drag you off to hell with them! Good luck!

It is not supposed to be this way. Religion is supposed to be a good thing; but instead the “religious right” has turned religion into something sick and evil! While continuously twisting themselves into spawns of the devil! This sick, evil, perverted and corrupt “religious right” has now become the “religious wrong”! They have brought an irrational, unnecessary and un-needed hatred and anger into American culture; especially through their unending and ruthless TV and talk radio shows! They will discover that they have mistakenly lit a fire that will all too soon devour them all and burn them right off of this Planet once and for all; with a special place in hell waiting for each and every one of them and their spawns and their corrupt politicians or a certain persuasion!

Webster's defines “religion” as “the service and worship of GOD”. My LORD JESUS CHRIST has continuously told me in those ten dreams that “to HIS disappointment, man, over the past 2,000 years has slowly, almost imperceptivity, perverted religion into something in man's own image; that has almost nothing to do with GOD anymore; and that HE is sick of this evil, perverted, corrupt, “religious right” that thinks that they can say and do anything that they want, in HIS name”. HE says “that these people are not Christians; and that they never were and that they are just looking for ways to rule other people, and chose religion as just another way”.

They care nothing about the great balances of nature that GOD provided this Planet; especially if these balances interfere with their desire to profit from fossil fuels! The really sick joke here is that these fake Christians want to burn all of these fossil fuels, while they still insist that this Planet is only 5,500 years old! Yet coal, oil and natural gas, the three major forms of fossil fuels; were all formed hundreds of millions of years ago during the Carboniferous Period! If they cannot prove exactly how fossil fuels came into existence thought valid science and mathematics; then they should not be allowed to use any valid science and mathematics to find it, to use it, or mine it, or burn it, or drill for it, or refine it, or profit from it! Leaving them once again to define the origins of coal, oil and natural gas on magic!

My soul is large enough to accept CHRIST, The Bible, verifiable history, valid mathematics, science and physics! Their souls are so filled with evil, lies and hate that they have lost them; leaving them unable to even understand the very Planet they inhabit! They have become incapable of seeing, telling or even understanding the truth! Funny how they sure do use a lot of complex mathematics, science and physics when it comes to pulling, fracking and mining fossil fuels from deep within the Earth; but their love of these things ends there! Leaving them hating mathematics, science and physics in all other endeavors; and education in general; because they want everyone to be stupider than they are; so no one will question their authority! Given the low intelligence of most in the “religious wrong”; this means that they want all Americans to be dumber than dirt! So that these corrupt politicians and the “religious wrong” that supports them; can get away with anything! Once again their evil, sick, hateful nature has twisted them into exactly what they say they hate the most; “weapons of mass destruction”! If they want to leave this Planet free of weapons of mass destruction; they should just “self-annihilate” themselves! Like their own idea of “self-deportation”, for undocumented immigrants!

We would all be better off! The saying “for whom the bell tolls” does not apply to them! They stand in the way of every important improvement this nation needs; better infrastructure, better immigration laws, better affordable healthcare that cannot be denied to any American for any reason, better ways to feed the poor, childcare, maternity leave, better social security and much, much more! They would prefer that everyone just quietly die while working to serve them! Leaving them unfit to ever rule America again! While these same evil men wallow in abundant health care and fine food! They are false Christians that actually use GOD as their servant; as they use HIS name and word for their self-centered, self-serving, hidden agenda of ruling America without any restrictions, or checks and balances! Their unquenchable thirst for money and power knows no boundaries; as they evilly deny some Americans their Constitutional right to vote; or even have any say-so in how they see America's future!

Their evil knows no bounds! They will recklessly burn fossil fuels until we can no longer go outside in 120 F+ air; while we lose so much land to sea level rise; that even they will be forced to move! They will continue regardless of who gets hurt, or how many species are wiped from the Earth! Or even if their shortsightedness destroys us all; even themselves and their own little spawns of the devil! Now that is truly evil, proving once and for all that they are disciples of the devil! They hate GOD and the “Laws of Nature” that HE established, especially the “Immutable Laws of Physics” so much so, that they have once again twisted themselves into what they hate the most, “immutable”! They are so far gone now; that they have become “incapable of or unsusceptible to change”! They actually believe that this entire Universe should revolve around them; leaving them once again thinking that they are GOD! May GOD have mercy on them!

They know nothing about “pi-r-square”; all they care about is that “pie-are-round” and that some big, sick, evil, greedy and corrupt corporation buys them all that they can eat! So their lard asses can then just go and waddle around Washington doing nothing, but getting fatter, stupider, greedier, more corrupt and way more evil! For the past eight years, these corrupt politicians have been willing to go to any lengths to stop my ideas from being implemented! Why? Because my ideas threaten these corrupt politicians and their evil corporate masters; all infected with the sickness of greed! They will do anything to stop any idea that threatens their death grip on money and power here in America, and the World! Has America become the kingdom of hell where the greedy, rich and those in power; take what they want, when they want, from whomever they want; and manipulate their power to destroy all who stand in their way; and then are never held accountable for all of the misery, pain, anguish, death and destruction they purposefully cause!

This would literally make America one of the most evil countries in existence today! America will not stand long if this has become our legacy! Why has this evil been allowed to continue? GOD is watching and listening! All they care about is manipulating America's energy supply; to maintain a strangle hold on the throats of every American Citizen, along with every man, woman and child on this Planet. Even the sick, evil, corrupt “religious wrong” idiots that vote for them! By manipulating the oil, natural gas, gasoline, coal and nuclear power Industries; and by preventing any competition that might take a penny of their profits! I wonder how they, and their spawns, will spend all that money in hell! I need help from the Scientific Community! Please help me! It is in the best interest of your futures and the futures of your children and their children!

Thus, there is a need in the current art of wind energy for a method and apparatus to utilize wind energy within any structure what-so-ever; such as but not limited to commercial, military, governmental, industrial, amusement, vehicular and/or residential, etc., regardless of size, shape, and/or number of floors and/or decks involved; to efficiently utilize the push-pull power of an upwards flow of wind energy within a structure; for ventilation, moisture condensing and producing mechanical energy for useful work, which will include producing electricity. By capturing, channeling, concentrating wind energy within that structure to operate any form, type and size of wind powered device including any form, type and size of connected machine device. Including machine devices to propel vehicles. These are some of the objectives of this invention. Such method and apparatus must be easy to apply and produce sufficient wind energy, mechanical energy and/or electrical power.

### SUMMARY OF THE INVENTION

This invention involves an apparatus and method for capturing, concentrating, channeling and/or utilizing the power of an upwards flow of wind energy within a wind energy structure with one or more open tops to initiate a push-pull wind energy system, with one or more structural supports, with one or more external surfaces, separating one or more internal areas with one or more floors with one or more rooms with one or more internal surfaces, from an outside. I will not address the specific structural requirements of wind energy structures in great detail; because I am not trying to claim and/or patent any kind and/or type of new support structure. I have discussed the required weight loading requirements of filling a standard structure with wind powered devices with three separate structural engineers; and none of them saw any problems with what I am doing within my wind energy structures.

For example, if I do mount 90,000 wind powered devices each having a diameter of 10 feet; within a structure that has an inside diameter of 250 feet and stands 750 feet tall. Each 10 foot wind powered device would weigh approximately 80 pounds, plus another 30 pounds for an attached electrical generator; plus approximately 50 pounds each for a support structure. So each one will weigh 160 pounds×90,000=11,700,000 pounds; which will hold similarly true for lesser quantities, of larger wind powered devices. It must be remembered that most of my wind powered devices do not require any form of directional control such as tail fins or swivels; because all of the air only travels in an upwards flow. So almost all of my wind powered devices will be fixed in a downward facing position; requiring minimal structural support. Several will be on swivels with tail fins but only a few and not enough to add noticeable weight.

Typical floor loading capacities of standard steel framework high rise structures; is 50 pounds of live load per square foot, plus 20 pounds of partition load per square foot. This does not take into account air conditioning and other special heavy equipment and office supplies. A 250 foot round structure has a per floor area of 49,062 square feet (125×125=15,625×3.14=49062); a 750 foot tall structure will have 75 ten foot high floors. Providing a total square footage of 49,062×75=3,679,650×70 pounds per square foot; equals 257,575,500 pounds of total available load. My 11,700,000 pound load is 4.5% of this amount; leaving 95.5% of my structural weight loading available; for more machine devices and electrical items. All three structural engineers had no problems with standard steel framework construction; regardless of shape and/or height and/or width and/or length. They did recommend that I standardize on a 50 foot long beam length and a 10 foot high column height. Not as a design limitation but rather as a way of standardizing my structural elements to save money; during mass production.

I will not claim any structural supports, since I will rely on standard structural engineering guidelines. The internal areas of my wind energy structures will have minimal internal obstructions that could impede the flow of this wind energy. Intake and exhaust channels on square structures will take up most of the area of each wall; just like current glass wall structures, running between the steel frameworks. Round structures will have rotating outer wall sections with single inlet slots that take up around 33% of the circumference. By example, a 750 foot high by 250 foot diameter round structure would have 12 large outer steel framework columns that are 65 feet apart around the structures circumference that will run just inside of the rotating outer wall sections; for the full height of the structure. Then track and gear works for the rotating outer wall sections would be added to these 12 large columns; every 35 feet of height. Regardless of shape, there will be 50 foot long beams that are supported by 10 foot high columns, tying the frame together. These 50 foot beams will be supports for the grated and solid floors and the wind powered devices; within each 10 foot section.

These intake channels, exhaust channels and inlet slots in the external surface of these wind energy structures will connect the internal areas with the outside; allowing wind energy to enter the structure and/or leave as necessary. Their primary purpose is to allow wind energy to freely enter within these structures and only leave through the open tops. To operate any type, form, size or shape of wind powered device, even in winds down to 1.0 MPH, for many uses including a new and much more efficient way to generate electrical power and/or mechanical energy as needed and/or desired. The open tops will allow “Bernoulli's Principal” to establish the World's first push-pull wind energy structures; with some of the highest efficiencies ever realized.

“Wind energy structures”, “wind energy”, “capture”, “channel”, “concentrate” and “utilize” are clearly defined earlier in this specification. For this application at hand the term “open top” refers to the fact that “the tops of all of my wind energy structures must be open to optimize the utilization of Bernoulli's Principal within the wind energy structure to establish the first ever push-pull wind energy structure; some structures may have multiple open tops while some have only one; while it is preferred that they are fixed 100% open, 100% of the time and never close and remain 100% open, 100% of the time; there may be times when it is necessary that some of these open tops include any attempt, strategy, scheme, plan, assemblage of parts, occurrence, method and/or apparatus imaginable to allow them to modulate between 100% open and 90% closed; but they should never fully close”. By way of example, but not as a limitation, when major maintenance procedures on internal wind powered devices is underway, closing the top could prove extremely useful and provide added worker safety by stopping all of the wind powered devices within that wind energy structure. Also, during hurricanes, derechos, tornadoes and other high wind events, just operating the inlet channels and exhaust channels may not provide sufficient wind energy control; so the top may need to modulate towards closed until adequate control of internal wind speed is reestablished. When severe personal injury and/or catastrophic structure failure and/or wind powered device failure is detected, it may be advantageous to cease all operations, until the situation can be properly addressed.

During normal operating conditions, all open tops will be 100% open, 100% of the time and most probably involve a flared out open top to even further increase the low wind energy pressure available there to pull/suck/draw wind energy through my wind energy structures. Some will be fixed 100% opened, 100% of the time; while some will modulate between 100% opened and 90% closed; but no open top should ever fully close unless some future operational situation requires them too. Allowing wind powered devices to “run wild” in 100+MPH winds could prove disastrous; requiring some reduction in wind energy speeds within my wind energy structures.

My calculations teach me that the extreme high-velocity-low-pressure wind energy force generated by 125+MPH winds flowing over my open tops; could easily exceed the low pressure differential storm front that is driving these incident wind speeds over the bottom half of the tower; quickly increasing the wind energy pressure differential within my wind energy structures to a point where I could easily experience 130+MPH wind energy forces when ground force winds are only 110. Which could grow to 167+MPH within my wind energy structures in 150+MPH incident ground winds; and almost 225+MPH in 200+MPH incident winds flowing over the lower half of my wind energy structures. None of these calculations include wind gusts. What I am saying here is that my use of “Bernoulli's Principal” could prove so effective, that I actually increase the wind energy speed within my wind energy structures; way past the outside incident wind speed. So, I must account for this; or face certain eventual disaster.

And no I am not saying that my wind energy structures are somehow creating any extra energy from nothing. What I am saying here is that my ability to capture and then concentrate wind energy within my wind energy structures over height, just as I have said ever since Dec. 24, 2008. Could prove so effective, that I must throttle/modulate it down during hurricanes and/or tornadoes. As faster and faster high-velocity-low-pressure incident winds enter into my wind energy structures through openings on the wind impact wall over height during hurricanes and/or tornadoes; they immediately become higher and higher and higher high-pressure-low-velocity captured wind energy. This dramatic increase in wind energy pressure within my wind energy structures over their height, can become extremely high. Then as faster and faster and faster high-velocity-low-pressure incident winds flow over my open top, they will generate a lower and lower and lower and low-pressure-high-velocity force there. Resulting in large wind energy pressure differentials; between these ever higher internal wind energy pressures, as compared with the ever lower wind energy pressures over my open tops. Allowing me to generated wind energy speeds within my wind energy structures in a way and at speeds that have never been seen on this Planet before, within a structure.

Interestingly, several of my calculations revealed that this very same phenomenon can even occur on light and normal wind speed days. Allowing the wind speeds within the lower half of my wind energy structures to easily exceed the incident wind speeds outside of them. Which all speaks directly to my efficiencies! These are very complex calculations, and I have run them many, many times and I think I am correct; but it may take a super computer to prove me wrong, or right. It is all the same energy; but only by capturing wind energy within a container and then concentrating this wind energy over the height of my wind energy structures/containers, am I able to do things that no one has ever done before. Leaving me with no other wind energy system to compare with mathematically and/or even theoretically. Which is simply additional proof of how new, novel and non-obvious my ideas on this subject actually are!

My calculations teach me that when the outside incident winds reach about 125 MPH, I should begin to modulate my open tops away from 100% open. Whether expressed as high wind speeds, high wind energy and/or high wind pressure energy; I will still be transforming much more of it into mechanical energy, than any other wind energy system in existence on this Planet. Even if I do end up having to reduce the amount of wind energy that I am transforming into mechanical energy during extremely high winds; to protect my wind energy structures and the wind powered devices within it. This reduction allows me to keep operating throughout any high wind event, right up to 300+MPH. All of this speaks directly to how my wind energy structures can reduce storm force winds; by transforming them into vast amounts of mechanical energy. As better high speed wind powered devices are invented; then the need to modulate my open top will probably become a moot point. My initial calculations teach me that it will take about 1,000 of my wind energy structures; arranged in side-by-side, double offset rows. To begin to reduce storm force winds; and thereby storm surges, down to survivable levels. But even a single wind energy structure will reduce storm force winds, somewhat.

My calculations show that the best method of operating this open top between 100% open and 90% closed is with large, split, sliding doors. By way of example, but not as a limitation; a 250 foot inside diameter open top would have large, split, sliding doors that slide on rails that extend past the tops. These large, split, sliding doors would be split down the middle, with one half sliding on rails in one direction and the other half sliding in the other direction. These sliding doors would have a center hole that is equal to 10% of the entire open top; so that even when the doors slide fully close, these open tops would still in fact be 10% opened. Please see FIG. 15 for a detailed explanation of this. Additionally, when these sliding doors are fully opened, which is about 98% of every hour of every day, these extended flat surfaces around my open tops; would actually smooth out the flow of wind over these open tops. Reducing turbulence and directly increasing wind velocities; generating even lower wind energy pressures over these open tops. Which will in turn pull/draw/suck even more wind energy up though the wind energy structure; increasing their efficiencies.

Plus, these large, split, sliding doors will use electricity to modulate, either directly or through pneumatics; and will modulate even during hurricanes and tornadoes because as long as a few wind powered devices that are connected to electrical generator machine devices within the wind energy structure are still operating; electricity will be available. Unlike electrical power from the grid, and the real truth is that my wind energy structures will produce even more electricity during storms. So if there is somewhere for all of that electricity to go; I can probably operate at a very high output level throughout any storm. Manual hand crank devices could also be used that employ folding shutters that would partially or almost cover the open tops when necessary. I hate to say it but it might just prove too cumbersome and unsafe to modulate these open tops during high wind conditions; especially when they can be hundreds, or even thousands of feet in the air. So, fixed open tops that are 100% opened, 100% of the time may be inevitable; and my intake and exhaust channels will just have to do the job or controlling the amount of wind energy within a given wind energy structure. But I think about this problem every day and just maybe I will come up with a solution.

The input data that I would use to modulate my open tops between 100% opened and 90% closed will never be based on pressure sensor data. It will be based on wind speed within the structure, wind speed outside of the structure, wind powered device output and vibrational performance, maintenance schedules and safety issues; none of which required any pressure sensor data. So, I hereby declare that none of my attempts, strategies, schemes, plans, assemblages of parts, occurrences, apparatuses and/or methods; utilized on any wind energy structure to modulate my open tops between 100% open and 90% closed, will depend on pressure sensors as disclosed by PARKER.

It should be noted here, that I hereby declare that I personally have never seen any structure pressure control and/or structure pressure monitoring system that uses pressure sensors of any type; ever place a single pressure sensor on a single roof surface, in my life. And this was my profession for 23 years and I currently hold three granted U.S. Pat. Nos. 6,584,855; 6,968,745 and 7,127,850; that all involve structure pressure control. All three use pressure sensors of various types and I purposefully do not claim, disclose and/or show putting any pressure sensors whatsoever, on any roof surfaces whatsoever, please check me out. A reasonable person might ask, “Why would I say that a pressure sensor on a roof surface will fail”? It is because I took over 500 pressure readings on roof surfaces of various sizes and shapes; before I ever filed for the first of those three granted patents. I quickly discovered that all roofs are under a continuous high-velocity-low-pressure condition, as clearly disclosed earlier within this application. I knew that this constant low pressure sensor reading would have introduced an anomaly into my sensor calculations; eventually leading to the entire failure of my control system due to bad sensor input data. It would have done the same to PARKER's scheme. Please check me out, I never installed any pressure sensors on any roof surface whatsoever at Ciba, nor anywhere else.

I say that if PARKER had ever built a working model of his scheme, and survived the hurricane; he would have also noted this anomaly and never mounted another pressure sensor on another roof surface. PARKER never shows a single pressure sensor on a single roof in any of his drawings; he just refer to the option. Even ASHRAE did not recommend installing a pressure sensor on a roof surface, back in 1999 when PARKER filed his application. This is just one more reason why any high wind structure protection scheme that depends on pressure sensor input data will never work properly when needed and/or where it is needed the most, on the roof. And as I clearly point out herein, the roof is the absolute best place to relieve internal pressure buildups, during high wind events, such as hurricanes and tornadoes.

Plus, I plan to “modulate some of my open tops between 100% open and 90% closed, but they will never fully close”; while PARKER never mentions anything about any desire to “modulate” any of his “controlled openings”, and/or leave them 10% opened all of the time. His only stated goal is that they are either fully opened, or fully closed; which would never meet my definition and/or my desire “to modulate some of my open tops between 100% open and 90% closed”. A reasonable person might ask, “Why wouldn't PARKER modulate his openings”? Well, it is because PARKER always links a low pressure surface opening, with/to a high pressure surface openings, because he knows he must fully close the high pressure controlled opening as he is opening his low pressure controlled opening, or wind and rain will uncontrollably come in and damage or destroy the structure. If he chose to modulate his openings, he knows he would always have a high pressure controlled opening on the wind impact wall, partially opened. If it was opened for even a short period of time, it would still lead to tremendous damage to the structure; it could even allow it to be blown apart in just a few seconds. Even on TV they say all of this damage occurred in seconds; and as I disclose herein PARKER's static pressure system will take 10 minutes to change; and that is an eternity in 100+MPH winds. So no reasonable person would have ever modulated their openings to outside, during any hurricane and/or tornado.

These statements along with all of my arguments against PARKER herein, especially the ones above, all work together as a whole to prevent PARKER from every employing “Bernoulli's Principal” within any structure, as I am teaching. So no reasonable person would be motivated to ever take PARKER's scheme exactly as he discloses it; and add a single wind powered device within a structure for any sufficient reason and especially not in light of POLYAK, ROSSEL, RICHARDS and/or PAGE. Proving once again that as a whole my ideas are truly new, novel and non-obvious, in light of any existing patent.

Additionally, no one teaches leaving the entire roof off of a structure 98% of the time and allowing wind to howl through that structure. Not even PARKER. It is counter intuitive to do this. For thousands of years we built structures to keep the wind outside; while using roofs to keep the sun, snow and rain outside. No reasonable person would just take the roof off of their home; which is exactly why neither you, nor anyone else have ever seen/observed a wind energy structure as I am disclosing; on this Planet over the past 5,500 years of recorded history. There are a few reasons to build a structure with a top/roof that is opened 98% of the time; but none of them teach what I am teaching.

ONE is a chimney, which allows warm air to rise up through an open top; either as solar heat or process heat, like from a fire or other heat source. Chimneys must be sealed over their height to allow the heat to rise. This is based on based on “Charles's Law” which is also known as the “Law of Volumes”; which teaches us that “as air is warmed it expands, creating more volume, resulting in a lighter air mass that rises”. Which has often been referred to as “warm air rising”, or the “buoyancy factors of air” creating what ASHRAE calls a “stack effect”. Adding openings over the height of the chimney as I am teaching on my wind energy structures; would defeat the primary reason for building the chimney in the first place. During periods of low winds, cooler air entering the chimney over height would cool the air mass and allow it to become heavy and begin to fall within the chimney. Eventually pushing air out of the bottom of the chimney; defeating their primary goal. And when wind is present, the resulting concentrated and dramatic upwards flow of wind energy that I am teaching, would also defeat their primary goals. By either putting out the fire or uncontrollably over-heating it, or over-cooling the heat source, including solar heat; preventing any further heat from rising. So no reasonable person would add openings over height, to any chimney. My calculations teach me that it will feel “cool” within my wind energy structures, even on 109 F days; due to the shade provided, as the concentrated upwards wind energy flow reduces the perceived temperature by 12 F. Leaving my wind energy structures comfortable to inspect, maintain and repair; even on the hottest days of the summer; while further enhancing moisture to condense!

ANOTHER is to pour water down an open top, of say a tower, it in an attempt to generate a downward flow of air. Adding openings over the height of this tower as I am teaching on my wind energy structures; would defeat the primary reason for building the tower in the first place. It would encourage the dramatic upwards flow or air, which will stop all of their desired downward flow of air; and blow all of that water they expensively pumped up to the top, right back out of their open top. Additionally, adding more hot dry air at various heights of their tower; would require that much, much more water must now be expensively pumped up to the top of their tower, to evaporatively cool this added hot dry air. Further, using all of this water as fuel, in a time of drought; makes no sense.

Additionally, neither of these examples, nor anyone else on this Planet, is teaching using open tops to employ “Bernoulli's Principal” to dramatically increase the upwards flow of wind energy within any structure, but me. Verifying that my ideas are truly new, novel and non-obvious. Even I did not ever think that the absolute best way to utilized wind energy on this Planet, would involve a structure; until I had those dreams. I, like everyone else on this Planet, mistakenly thought that the best way to utilize wind energy is to immerse all wind powered devices; “directly into the atmospheric wind fluid flow”; and as far away from all structures as possible, to avoid wind turbulence. Just like those idiotic large propeller wind turbines in those idiotic wind farms; out in the middle of nowhere, yet close enough to one another to interfere with each other's performance and reduce the efficiencies of every wind turbine involved. You sure do not see any tall structures mixed in with all of those idiotic large propeller wind turbines! Nor do you see any of my wind energy structures; anywhere on this Planet! Nor have there ever been any; since time began! But you have wasted eight years, countless billions in property damages; along with countless American lives; lying about this simple and obvious fact!

It is more obvious to think that utilizing the inside of a structure would prevent the optimum utilization of wind energy by blocking most if not all wind speed; and just purely counter intuitive to think that utilizing the inside of a structure could somehow help! Incredibly, the opposite is true! The absolute best way to utilize wind energy on this Planet, is by capturing it and then channeling it within a structure; and then concentrating the amount of captured wind energy within that structure through more and more intake openings over the height of that structure. Then by adding an open top to that structure to employ “Bernoulli's Principal” to generate a low-pressure over that open top; to actually more than double the amount of available wind energy within that structure. It is all just so counter intuitive. It even still amazes me and I was the first to observe it.

For the invention at hand, “channel” is a primary word when used in describing and/or defining these wind energy structures, requiring that I expand on my definition of “channel/channeled/channeling”; that I provide on page 5, lines 24-27 herein. So when referring to “channel” concerning any wind energy structure it is understood to be “any channel, tube, pathway, track, louver, damper, device, machine, structure, opening and/or anything, etc. that is conformed to be useful in any attempt, strategy, scheme, plan, assemblage of parts, occurrence, method and/or apparatus to accomplish the capturing, channeling, concentrating and/or utilizing of wind energy within a structure”. Additionally, these wind energy structures utilize several unique channels that need to be defined. In order to save space and avoid duplicating the same words over and over again, it is understood that all of the following “channel” definitions also fully include my previous definitions of “channel” and “channel/channeled/channeling”.

One is “intake channels” and refers to “any channels mounted in any external surface of a wind energy structure that connects the internal areas of that wind energy structure with an outside and allows wind energy to pass from an outside and then into the internal areas of that wind energy structure”. Another is “exhaust channels” and refers to “any channels mounted in any external surface of a wind energy structure that connects the internal areas of that wind energy structure with an outside and allows wind energy to pass from the internal areas of that wind energy structure to an outside”. Whenever these “exhaust channels” involve any form of “control theory” as defined herein, they will immediately fall under the prior art established by PARKER, which has now fallen into the public domain. So, it is understood that “exhaust channels” can be applied in any way imaginable as needed and/or desired when building and operating wind energy structures, but are not to be considered as a new ideas that need claiming.

Further, “internal channels” refer to “any channels mounted within any internal area which includes within any room, on any floor, in any internal surface of any wind energy structure; connecting these various internal areas of that wind energy structure, allowing wind energy to pass between these various internal areas of that wind energy structure”. For this application the terms external channels, external ductwork, external pipes, external tunnels and the like” refers to the fact that “they are mounted completely external to the wind energy structure itself, but connect to the wind energy structure so that any and/or all of the force, motion and/or energy generated within a wind energy structure can be transmitted through these external channels, external ductwork, external pipes, external tunnels and the like; to any number of external special casement channels and/or separate but connected structures and/or any other structure and/or device in any way, for any reason as desired and/or imagined”.

For our purposes here “connect/connection/connected” is denied as “the act of joining two or more things together, regardless of the reason or outcome; by way of example but not as a limitation, any and/or all of the force, motion and/or energy generated within a wind energy structure can be transmitted through external channels, external ductwork, external pipes, external tunnels and the like; to any number of external special casement channels and/or separate but connected structures and/or any other structure and/or channel in any way, for any reason; additionally by way of example but not as a limitation, any and/or all of the force, motion and/or energy generated by a wind powered device within wind energy structures, external special casement channels and/or separate but connected structures can be transmitted by directly connecting a machine device to a wind powered device and/or by connecting it through shafts, belts, drive lines and the like, with remote machine devices that are mounted either inside and/or outside of wind energy structures, external special casement channels and/or separate but connected structures, thereby supplying them with mechanical energy”.

For this application the term “special casement channels” refers to “the transmission of any and/or all of the force, motion and/or energy generated by the upwards flow of wind energy within a wind energy structure; in any attempt, strategy, scheme, plan, assemblage of parts, occurrence, method and/or apparatus imaginable to a special channel that has a special containment casing which could be as simple as a length of ductwork pipe, tunnel, tube and the like that can be configured in either a horizontal airflow position or a vertical airflow position and/or any position in between; these special casement channels are the only ones that employ these special containment casings to purposefully prevent the introduction of additional wind energy once it contacts the first available wind powered devices; these special casement channels can hold any number of consecutive stages of wind powered devices desired and/or imagined; these special containment casings are purposefully designed with a single inlet and a single outlet so that the same body of air that moves through the first wind powered device, will also pass through each consecutive stage of wind powered devices; while the wind energy that this body of air possesses will constantly decrease as it propels each consecutive stage of wind powered device that is contained within these special casement channels; these wind powered devices can then be directly connected to a machine device and/or connected to remotely mounted machine devices that are mounted within these special casement channels and/or within a wind energy structure and/or outside of them through shafts, belts, drive lines and the like; as each contained stage of wind powered device transforms a certain amount of the available wind energy into mechanical energy leaving the remaining unchanged body of air volume with less and less available wind energy, the volume of the body of air remains the same; so to prevent wind stagnation, the diameter, wind-swept area and/or cross sectional areas of these special containment casings must enlarge approximately 17.5%, but it could enlarge by as much as 100%+ or as little as 5%, but it will always enlarge, after each consecutive contained stage of wind powered devices, to provide a sufficient low pressure area downstream of each stage of wind powered devices to keep this constant air body volume moving; plus in most but not all cases, each consecutive contained stage of wind powered devices within each special casement channel, will have fewer blades; some special casement channels will be fully mounted within the internal areas of the wind energy structure, while others will be fully mounted outside of the structure and connected to the wind energy structure through external channels, external ductwork, external pipes, external tunnels and the like”.

These “special casement channels” do not have to face the incoming wind; but they will contain multiple stages of wind powered devices. This would allow a single wind energy structures to perform much more work, providing a much larger return on investment. These special casement channels can be applied to my wind energy structures in any attempt, form, strategy, scheme, plan, assemblage of parts, occurrence, method and/or apparatus imaginable. Some can be mounted fully within the structure, while some could be mounted outside of the structure, and connected to a wind energy structure through external channels, external ductwork, external pipes, external tunnels and the like. It is understood, that since most if not all of the energy required to operate any special casement channel mounted outside of a wind energy structure, comes from within the structure; through these external channels, external ductwork, external pipes, external tunnels and the like; these special casement channels can also be considered as mounted within the structure. It is also understood that any number, type, form and/or style of multiple stages of wind powered devices; can be applied within these special casement channels. These special containment casings will contain 100% of the body of air volume; as a certain portion of the available wind energy is transformed into mechanical energy, through each consecutive stage of wind powered device. Leaving this unchanged body of air volume, with less and less wind energy to move it out of the structure.

It is further understood that any size, type, form and/or number of wind powered devices, can be direct connected and/or connected through shafts, belts, drive lines and the like with any number, form, type, shape and/or size of machine device remotely mounted either within these special casement channels and/or outside of them, to utilize the available mechanical energy. Since each stage of wind powered device will transform a certain amount of the available wind energy into mechanical energy leaving the “constant air body volume” with less and less available wind energy. The wind-swept area, diameter, and/or cross sectional area of these special containment casings must enlarge after each consecutive “contained stage” of wind powered devices by approximately 17.5% or as much as 100%+, or as little as 5% when only applied in winds above 70 MPH; but it must always enlarge. To provide a sufficient low pressure area downstream of each stage of wind powered devices; or stagnation will occur. Plus, in many cases, not all, each consecutive “contained stage” of wind powered devices within each special casement channel, will have fewer blades.

Now is a good time to totally separate “contained stages” of wind powered devices; from just “stages” of wind powered devices. Since new/additional wind energy is constantly being added over the height of wind energy structures through additional intake channels and/or inlet slots. This same enlargement of the diameter, wind-swept area and/or cross sectional area; is not required for each additional “stage” of wind powered device, within any wind energy structure itself “Contained stages” of wind powered devices are only used within my “special casement channels”; and their application does require the enlargement of the diameter, wind-swept area and/or cross sectional area; downstream of each consecutive “contained stage”.

Some “intake channels” and/or “inlet slots” will employ “inlet scoops” that will further improve their ability to channel wind energy into a wind energy structure and/or any connected but separate structures and/or any special casement channel. For the application at hand the term “inlet scoops” refers to “any attempt, strategy, scheme, plan, assemblage of parts, device, occurrence, method and/or apparatus imaginable; that will enhance the amount of wind energy being brought into a wind energy structure and/or any other connected structure and/or any channel in any way, for any reason; in order to maximize the upwards flow of wind energy within any wind energy structure; any size, type and/or number can be added as needed and/or desired to assure a smooth flow of wind energy into any and/or all wind powered devices, any and/or all separate but connected structure, and/or any channel, exhaust channels, intake channels, inlet slots, internal channels and/or special casement channels within and/or on a wind energy structure, to maximize the utilization of the wind energy available; further they can be used within any of the external channels, external ductwork, external pipes, external tunnels and the like; that are used to connect any number of external special casement channels and/or separate but connected structures, with a wind energy structure; while it is preferred that these inlet scoops are fixed 100% open, 100% of the time and never close and remain 100% open, 100% of the time; there may be times when it is necessary that some of these inlet scoops include any attempt, strategy, scheme, plan, assemblage of parts, occurrence, method and/or apparatus imaginable to allow them to modulate between 100% open and 100% closed”. So “inlet scoops” could be applied to the inlets of any “channel”, to increase, decrease and/or modulate the amount of wind energy that enters them and/or leaves them. Usually inlet scoops will be split, with one half of the opening/slot/channel's width covered by one inlet scoop; while the other half of the opening/slot/channel's width is covered by the other inlet scoop. Each side or these inlet scoops can be modulated individually and/or closed individually, while the other inlet scoop does not move at all and/or modulates differently.

As desired and/or required, some channels will constantly remain open and/or closed; while others will “modulate/modulated/modulating”; which Webster's defines as “to adjust to or keep in proper measure or proportion”. For our purposes here “modulate/modulated/modulating” refers to “any desire to modulate between 100% open and 90-100% closed and/or to proportionally move to open and/or proportionally move to close any opening, channel, inlet scoop, outlet bell, open top, etc. that is on, within and/or in any way connected to a wind energy structure; in order to keep in proper measure and/or proportion, the amount of wind energy that enters and/or leaves”. This modulation and/or proportionally move to open and/or proportionally move to close can be based on a set point. For the patent application at hand this “set point” is “based on any one and/or all of the relevant issues involved, such as but not limited to: internal structure pressure, outside pressure, electrical demand, internal wind speed, outside wind speed, wind direction, wind device rotor speed and/or internal pressure, forecasted weather and/or time of day, etc.; and it is understood that this set point will adjust as any chosen relevant issue changes”. These issues and more can be analyzed to determine when to open and/or when to close and/or when to modulate a specific channel, inlet scoop, outlet bell, open top, etc. The actual set point for any specific channel inlet scoop, outlet bell, open top, etc., may be different than for any other one, based on how all of the individual variables involved are weighted. Some installations will have variables not experienced at other installations.

Any and/or all channels, inlet scoops, outlet bells, open tops, etc., within and/or on and/or connected to any wind energy structure in any way; can be adjustable and move to open and/or move to close and/or modulate anywhere in between, at set points as desired and/or imagined. This operation can be in a “self-activating” way as defined earlier herein. Relying on wind energy and requiring no outside influence and/or assistance for their operation and/or they can be manually modulated and/or modulated by “control theory” as defined earlier herein. And as used in public domain prior art or existing patents (U.S. Pat. Nos. 6,584,855; 6,968,745; 7,127,850) held by this inventor; and/or any mix, version, attempt, strategy, scheme, plan, assemblage of parts, occurrence, method and/or apparatus involving self-activating, manual and/or control theory, imaginable and/or desired. Since none of the prior art addresses any “opening that allows wind to pass from an outside of the structure to an internal area of the structure”; involving any form of self-activating, manual and/or control theory”. I will include claims involving them.

Additionally, all of my research and calculations prove to me that wind naturally occurs in unpredictable “pulses”, that we often call “wind gusts”; some of which can be extremely dynamic and powerful one second; and then almost nonexistent the next second. Wind generated by falling and/or evaporating water; if this is even possible; will prove just as unpredictable and susceptible to fluxuating, due to rapid and unpredictable changes in temperature and humidity within their structures. These extreme pulses do not act like the steady/even flow of air that has been forced from a fan; whose operation is governed by the “Fan/Affinity Laws”. These “Fan/Affinity Laws” were only perfected to allow the practitioner to precisely, efficiently and effectively add energy to air, such as with a fan. These same “Fan/Affinity Laws” have nothing to add to any discussion and\or application involving the removal of energy from air; such as occurs with wind powered devices mounted within structures.

Instead all wind powered devices mounted within structures are governed by complex and evidently, difficult to comprehend “Laws of Pressure”. These high versus low wind energy pressure forces, are what I call “brutal” in winds above 70 MPH; but below 70 MPH these same wind energy pressure forces are what I call “delicate” and each one is almost impossible to use and/or manipulate, without the presence of the other wind energy pressure force. Even minimal resistance to wind flow within a structure in winds below 70 MPH, can cause these wind pulses to immediately stagnate within a structure; and immediately look for a new “pathway of least resistance”; and the pathway of the next pulse, may not even include the structure at all.

According to the “Laws of Pressure”, these pulses of wind energy must be encouraged to move as desired within a structure through properly designed pressure balances between all low wind energy pressure areas and all high wind energy pressure areas; by purposefully creating pathways of least resistance. These pulses of wind energy cannot be forced to do much of anything within a structure in winds below 70 MPH, or stagnation will immediately occur and air movement may never again be regained within that structure; without taking extreme measures; or until the wind approaches 70 MPH again. I hereby declare that back in 2004 I learned exactly how to generate low wind energy pressure areas downstream of each consecutive “stage” and/or “contained stage” of my wind powered devices mounted within structures.

Since I am forced to accept that multiple wind powered devices within a structure, now lies in the public domain; JOHN and PICKETT's unique schemes that have nothing to do with the “Laws of Pressure” actually proves beyond a shadow of a doubt that JOHN and PICKETT know nothing about how to “utilize the power of wind energy within a structure”. And neither JOHN nor PICKETT, nor anyone else teaches my new, novel and non-obvious ideas concerning the upwards air flow within a structure, nor my ability to capture, channel and concentrate wind energy within a structure over its height. Along with my extensive and unique use of “low pressure mathematics” and design throughout my scheme, including my unique application of an “open top” to employ “Bernoulli's Principal”; exactly like I have disclosed ever since Dec. 24, 2008; including within my current FIGS. 1-4! I respectfully request that I immediately be granted a patent on my new, novel and non-obvious ideas.

I hereby declare that I have always depended on “Bernoulli's Principal” and Bernoulli's velocity/dynamic pressure formula based on the teachings of Blaise Pascal; for the new, novel, non-obvious and proper utilization of wind energy within my wind energy structures. Beginning with my Dec. 24, 2008 filing on my application Ser. No. 11/401,566 and continuing through this application at hand. Which I actually thought I made extremely clear in 2008 by always saying “any lift generated by air passing over the top of the extended structure walls often called parapets, will actually make all of the wind powered devices involved more efficient, especially during high winds”. In my later applications I added “by actually pulling additional air up through these devices, producing the World's first push-pull wind energy system ever conceived, with some of the highest efficiencies ever realized”.

I hereby declare that I have always known since Apr. 11, 2006 that the only force in physics that will produce this described “lift” is “Bernoulli's Principal”; and the only way to accurately determine the amount of available “wind energy” is with Daniel Bernoulli's velocity/dynamic pressure formula described herein. Which I say I made extremely clear by mentioning “lift” and/or “lifting” over roofs and structures; along with the “upward” movement of air within my wind energy structures over two hundred times since Apr. 11, 2006. Including forty times in my all-important Dec. 24, 2008 filing on my application Ser. No. 11/406,566. I know of no other “Law in Physics” that will generate the type of “lift” described above; other than “Bernoulli's Principal”!

I hereby declare that at least 50% of the “driving force” within my wind energy structures is derived from the high-velocity-low-pressure wind flowing over the “open top” of my wind energy structures; that I have clearly shown on all of my applicable drawings since Dec. 24, 2008. And why I have always, also shown the parapet wall in all of these same drawings; extending above the highest point of any wind turbine mounted at or near the top of my wind energy structures. “Bernoulli's Principal” teaches us that this high-velocity wind simultaneously creates a reactionary low-pressure wind energy force over my entire “open top”. All of the “Laws of Pressure” clearly prove that air, wind and other incompressible flows will only flow/move from areas of high pressure into/towards areas of low pressure. Combine this with the fact that wind speeds always increase over height/altitude; allows this low-pressure wind energy force over the “open top” of my wind energy structures to quickly become the most powerful driving force; pulling vast amounts of wind energy in only an upwards direction. Neither PARKER nor FEX (U.S. Pat. No. 7,127,850) disclose any opening that is on the top of any structure; that never fully closes and is 100% opened, 98% of the time. Plus, this would defeat PARKER's primary goal of protecting the enclosed structure during high winds. This open top can have the ability to vary its open area to perfect the performance of the use of “wind energy” within a structure. Mostly it will expand as needed to increase the low wind energy pressure over this opening during light and normal winds; but during high wind episodes it could be advantageous to reduce the opening to prevent damage to the wind powered devices within my wind energy structures, especially during tornadoes and hurricanes. But this “open top” never closes unless some future operational need arises!

This is exactly the same low wind energy pressure that most people thought “lifted” roofs from structures. Which I assert through this application, is incorrect and that this low wind energy pressure is not sufficiently strong enough to lift a single roof, but it is definitely strong enough to allow my wind energy structures to operate very efficiently and effectively. The wind powered device shown near the top of my wind energy structure in FIG. 1; must always be within the structure. If it is ever exposed directly to wind, it will generate turbulence over my “open tops”, and deny the very lift that I strategically need for 50%+ of my driving force within my wind energy structures. The high-velocity-low-pressure wind entering my wind energy structures through channels on the wind impact wall. Will quickly become contained/trapped low-velocity-high-pressure wind energy that would easily stagnate; without the reactionary high-velocity-low-pressure over the “open tops” of my structures. Leaving “solar wind towers” inoperable monuments, to man's arrogance and ignorance!

Without an almost equal balance of low pressure forces and high pressure forces within my wind energy structures, stagnation is the only outcome. Just as with flight, there must be a high-velocity-low-pressure force on the top of the wing to suck/pull/lift the plane into the air; and there must also be a low-velocity-high-pressure force under the wing to support the lift. Without these two forces working in combination then planes would simply fall from the sky. Which did happen until the Wright Brothers built their own wind tunnel, after abandoning Otto Lilienthal's aeronautical data; because his mathematical errors failed to allow these two pressure forces to work in combination. Without these two pressure forces working in combination then sailboats could not tack; which was the case for centuries, as square rigged sailboats had to depend on the trade winds for directional control. Without these two pressure forces working in combination; then no “solar wind tower” or “wind energy structure” will ever efficiently or effectively, utilize any wind energy within a structure. Which is exactly why you have never seen a single one of my “wind energy structures” since recorded history began! Once again proving how new, novel and non-obvious my ideas actually are!

It must be remembered that every wind powered device within a structure is transforming kinetic wind energy into mechanical energy; leaving insufficient energy within the “constant air body volume” to remove itself from the structure, without help. This high-velocity-low-pressure force over the top of my wind energy structures provides this necessary help and energy to run multiple wind powered devices and still move the energy depleted “constant air body volume” from the structure, so more wind energy can enter the structure; avoiding stagnation. I am simply the first to recognize this all-important fact. I learned most of this from an in depth study of Daniel Bernoulli, one of my heroes. His work involving incompressible flows in 1738, taught me about the required balance of these two wind energy pressure forces. To accentuate one of these two wind energy pressure forces over the other and/or to ignore either one; assures failure.

As more and more wind powered devices are added to a single structure, the balance between these two wind energy pressure forces becomes even more delicate; and difficult to maintain. I spent years learning how to calculate, manipulate, use and create the delicate balance between these two wind energy pressure forces, before I filed my first application on these ideas, back in April of 2006. I learned all of this the hard way; through over 23 years of technically difficult, back breaking and expensive structure pressure control work. I had many failures to get to this point and I learned something from each and every one of them, while constantly studying Catholic Mathematicians, as a hobby. It always has been this way, and it always will be this way. Those failures that do not destroy us, teach us and make us wiser and stronger. It is my opinion that no one before me had encountered enough failures involving utilizing wind energy within a structure, to learn what I have learned. Almost everyone thinks that it is much easier to calculate, manipulate, use and create a delicate balance between these wind energy pressure forces, than it actually is, especially in winds below 70 MPH.

While all of the available wind energy is utilized within the structure, the force, motion and/or mechanical energy generated can be transmitted outside of the structure and utilized in any attempt, strategy, scheme, plan, assemblage of parts, occurrence, method and/or apparatus imaginable. Another way to gain the maximum amount of work from my wind energy structures is by connecting separate structures to them, and then pulling wind/air/pressure through these connected structures. For the application at hand, “connected but separate structures” involves “utilizing the upwards flow of wind energy within a wind energy structure by transmitting any and/or all of the force, motion and/or energy generated therein; outside of the structure in any attempt, strategy, scheme, plan, assemblage of parts, occurrence, method and/or apparatus imaginable, to pull/suck/draw any amount of air/wind/pressure through any number, shape, form, type and/or style of separate but connected structures imaginable; that are connected to the wind energy structure through external channels, external ductwork external pipes, external tunnels and the like; and then utilizing that transmitted force, motion and/or energy in any way imagined and/or desired within these connected structures, regardless of the output”. These connected structures do not have to face the incoming wind, nor do they need open tops; they could contain wind powered devices, special casement channels, moisture condensing devices and machine devices.

This method and apparatus involving separate but connected structures would allow a single wind energy structures to perform even more useful work, by ventilating these connected structures, along with supplying any needed machine device operation, while also supplying them with water and electricity and protecting them during major storms. This would allow a single wind energy structures to perform much more work, providing a much larger return on investment. Structures have used wind for ventilation, and fans have ventilated structures for over 150 years; but I am not talking about that. I am talking about inducing ventilation in separate structures; by transmitting any and/or all of the force, motion and/or energy generated by the upwards flow of wind energy that has been enhanced through “Bernoulli's Principal” within a wind energy structure, by connecting it to any surrounding structure. By way of example, but not as a limitation; these separate but connected structures could include meat processing complexes, hydroponic farm complexes, amusement park complexes, shopping centers, military complexes, industrial complexes, office complexes, government complexes, chicken processing complexes, colleges, universities, small cities, especially small rural communities, remote resorts, American Indian communities, islands, farms, ranches, military outpost, medical complexes and the like.

I hereby declare that this idea came to me with clarity on or around Sep. 1, 2013. I first began to think about it after reviewing JOHN (U.S. Pat. No. 8,517,662). As proof of my priority I offer what I said in a Jun. 5, 2013 filing on my application Ser. No. 13/135,239: “After running several mathematical models, it is my opinion that his entire scheme as drawn will automatically begin to operate in “reverse” in “incident winds” above 18 MPH; with “incident wind” then entering into the “outlet” of his “wind tunnel”; passing through his wind turbines in reverse; with the energy depleted air then being “pulled/sucked” out through his “open top”.” It took me about three months to mathematically calculate that I could use my own wind energy structures to pull/suck any amount of air/wind/pressure through any number, shape, form, type and/or style of separate structures imaginable; that are connected to these wind energy structure in any way imaginable. So I did not learn this from JOHN and PICKETT. Instead I learned all of this by being afraid that their scheme might fail; and begin operating in reverse.

I could not find any applicable prior art involving this and JOHN and PICKETT only teaches “pushing” air/wind/pressure through his wind tunnels and never expresses any desire whatsoever, to “pull” and air/wind/pressure through them. No reasonable person would reverse what JOHN and PICKETT are saying to arrive at what I am saying here. Plus, I hereby declare that back in June 2013 I did not disclose my desire to pull air through connected structures; I just expressed my fear that his ideas might fail and cause it. JOHN and PICKETT had not built their scheme; so they had not witnessed any associated failure. I hereby declare I have not told anyone about my idea of using my wind energy structures to pull/suck/draw; air/wind/pressure from/through any separate but connected structures, until now.

Any applicable number, form, type, size or shape of wind powered device currently existing or invented in the future can be used within my wind energy structures. For example and not so as to limit the invention, I envision economical smaller wind energy structures that could be installed on every home in America, resulting in a dramatic increase in energy savings and independence, capable of withstanding and operating throughout hurricanes and/or tornadoes, allowing people to more safely and comfortably shelter in place. Just for example and not by way of limitation, 10-16 homes with connecting backyards could have a 40 foot inside diameter by 150 foot tall wind energy structure, with individual rotating outer wall sections every fifteen feet. Housing around 50 wind powered devices; each with a 36 foot diameter and power all 10-16 homes; providing an incredible lookout that could include balconies 140 feet high, that could house cell phone antennas, security lights and cameras.

On a larger scale, these wind energy structures could be of any height, width and/or geometric shape imaginable. Just for example and not by way of limitation, they could be round and 750 feet tall, by 250 feet inside diameter; with 20 individual rotating outer wall sections that are each 32 feet high or so, by 250 feet in diameter. The bottom 40 feet and the top 50 feet of this 750 foot tall wind energy structure; will not rotate to stabilize the structure. The top of each rotating section could have an outlet bell; and/or any size, type, form and/or number outlet bells can be applied within a wind energy structure, in any way imaginable, to increase performance. Since my column spread is 50 feet on these round structures; the largest wind powered device possible would have a 48 foot diameter. This structure could house 4,320 individual 48 foot wind powered devices.

This same structure could also house a total of 90,000 individual 10 foot diameter wind powered devices mounted in stages over the entire height of the wind energy structure. As the wind powered devices are spaced as necessary; to accommodate structural columns and beams. Or 27,000 individual, 20 foot diameter, wind powered devices. Or 17,280 individual 24 foot diameter wind powered devices. Or 69,120 individual 12 foot diameter wind powered devices. All still allowing 60%+ free area for service and to insure the proper flow of wind energy within the wind energy structure. Entire stacks of wind powered devices could be disabled for service; with simple blank off panels on wheels that could easily be rolled under the bottom wind powered device, on grated and/or solid floors. Any one of these examples would be a very good application of this scheme and/or they can be applied in any mix of diameters of wind powered devices, imagined and/or desired to utilize the space and wind energy available. Some wind powered devices will counter-rotate as compared to the wind powered device above and/or below it, or both; to even out the flow of wind energy over the entire height of the wind energy structure. Also, stacks of wind powered devices may be arranged to create open spaces on one grated floor; so that the stack on the next floor will be directly above that open space to take advantage of the accelerated wind energy speeds.

Some of which can then be directly connected to machine devices and/or through single, common and/or multiple rotating shafts, that can then be connected to shafts, belts, drive lines and the like. With any number, form, type, shape and/or size of remote machine devices mounted within these wind energy structures and/or outside of them, to utilize the available mechanical energy. While all of the available wind energy is utilized within the structure, the force, motion and/or mechanical energy generated by the wind powered devices; can be transmitted outside of the structure and utilized in any attempt, strategy, scheme, plan, assemblage of parts, occurrence, method and/or apparatus imaginable, regardless of the output. Outlet bells can be used at the open tops to assure a smooth flow of air as it leaves, thereby increasing the effectiveness of the low wind energy pressure over the top of the wind energy structure. Proving that the way air leaves a wind energy structure is much more important that the way it enters that structure.

The individual blades on these wind powered devices can be much narrower than normal; and many more will be employed. As many as 50 individual blades on a 48 foot diameter wind powered device; each one could be supported every so often with “specialized blade support rings”. Using this 48 foot diameter wind powered devices as an example; one outwardly curved support ring with a diameter of 12 feet; then a straight blade support ring angled away from the hub with a diameter of 24 feet; then an inwardly curved blade support ring with a diameter of 36 feet; and a final outward curved ring with a diameter of 48 feet. My calculations show that this final ring should always be attached right at the end of each blade to provide support right where it is needed the most; while also maximizing the downstream low wind energy pressure. Each of the other rings can either be attached within the blade width, or directly to the top of the blades. In all cases the angled straight ring, or the curved portion of the rings; will always be on the leaving air side of all blades. To enhance the generation of downstream low wind energy pressure areas (on top) of each consecutive “stage” of wind powered device. Proving once again that the way air leaves a specific wind powered device, is much more important than the way it enters it; or these curved shapes would be mounted on the bottom of the blades.

These “specialized blade support rings” that are mounted within the blade width, can actually allow the implementation of shorter individual blade segments; that just run from support ring to support ring. This way blade maintenance would be exceeding easier and less expensive; allowing a single man to change blades out, while further reducing the possibility of catastrophic failure. All of the blades of each and every downward facing wind powered device; will actually be floating on this upwards flow of wind energy within every wind energy structure; while for the first time ever, gravity will be exerting the exact same force on each and every downward facing blade. Removing almost all Coriolis Effect and further reducing the blade-to-hub stress; in a way that has never been seen before. Some of these individual blades can be of special geometric shapes that will enhance the condensation of moisture from humid wind energy. Plus, these “specialized blade support rings” will maintain the proper blade separation, or distance apart from each other; over their entire length, to assure maximum performance with almost no vibration.

My calculations show that these multiple narrow blades that employ “specialized blade support rings”; will be far more efficient and longer lasting than the normal three blades currently used on large propeller wind powered devices. Then these “specialized blade support rings” could also have support arms that radiate out from the center of wind powered devices to form “radial blade support assemblies”. On the tops and/or the bottoms and/or both, of the “specialized blade support rings”; that run all the way out to the final “specialized blade support ring” installed on the tips of the blades. All working together to support the blades and “specialize blade support rings”, to and make them much more rigid and resistant to vibrational problems and blade warping; which would rob the wind powered device of desired performance and blade longevity. This same “specialized blade support ring” and “radial blade support assembly” system can be used on vertically mounted wind powered devices with multiple small blades.

Each blade used on these smaller wind powered devices, whether standard and/or moisture condensing, may have support rings every so often as desired and/or imagined; to decrease blade vibrations and further reduce blade-to-hub stress. Once again each ring will either be attached within the blade width, or directly to the top of the blades. In all cases the angled straight ring, or the curved portion of the rings; will always be on the leaving air side, or top, of all blades; to further enhance the generation of low wind energy pressure areas downstream, on top, of each consecutive stage of wind powered device. So even these 10 foot wind powered devices could have a 10 foot diameter specialized blade support ring attached to the outer tips to maximize the downstream low wind energy pressure. And for example, a 24 foot diameter wind powered devices could also have a 24 foot diameter support ring attached to the outer tips to maximize the downstream low wind energy pressure; plus an additional 12 foot diameter specialized blade support ring of any shape desired, for added blade strength and rigidity. And a 20 foot diameter device could have one 10 foot diameter ring and one 20 foot diameter ring.

So for this application at hand “specialized blade support rings” refer to “any attempt, strategy, scheme, plan, assemblage of parts, device, occurrence, method and/or apparatus imaginable, that is mounted on the top of any and all blades and/or within the blade width of any wind powered device in any way, shape, form, style and number imaginable and/or desired; the final ring regardless of shape should always be attached to the outermost blade tips to supply support right where it is needed the most; plus it will assist to maximize the downstream low pressure; in all cases the angled straight ring, or the curved portion of the rings; will always be on the leaving air side, or top, of all blades; to maximize the generation of low pressure over that particular wind powered device; thereby enhancing the upwards flow of wind energy within that wind energy structure; proving that the way the wind energy leaves a wind powered device is much more important than the way air enters a wind powered device; these specialized blade support rings can be spaced any distance from each other that is imagined and/or desired; to further increase blade rigidity and strength and/or decrease blade vibration and/or reduce blade-to-hub stress problems; this allows many more blades to be used on each individual wind powered device; plus each individual blade can be much narrower than normal; all working together to support the blades and make them much more rigid and resistant to vibrational problems and blade warping; which would rob the wind powered device of desired performance and blade longevity; also support rings mounted within the blade width can allow shorter individual blade segments that just run from specialized blade support ring to support ring; while it is preferred that these specialized blade support rings for wind powered device blades are fixed 100% open, 100% of the time and never close and remain 100% open, 100% of the time; there may be times when it is necessary that some of these blade support rings include any attempt, strategy, scheme, plan, assemblage of parts, occurrence, method and/or apparatus imaginable to allow them to modulate between 100% open and 100% closed”. Mounting “specialized blade support rings” on the bottoms (incoming wind energy side) of blades; will generate turbulence, robbing each blade involved of efficiency.

Then these “specialized blade support rings” can be further enhanced by adding “radial blade support assemblies” which refers to “any attempt, strategy, scheme, plan, assemblage of parts, device, occurrence, method and/or apparatus imaginable that would include support arms that radiate out from the center of the wind powered device, all the way out to the final specialized blade support ring installed on the tips of the blades; either in the middle of and/or on the tops, on the bottoms and/or on both the tops and bottoms of any and/or all blades in any way, shape, form and number imaginable; to keep blades at their optimum angle in relationship to the incoming wind energy to maximize blade efficiencies; all working together to support the blades and make them much more rigid and resistant to vibrational problems and blade warping; which would rob the wind powered device of desired performance and blade longevity”.

Before the blades of any wind powered device begins to float on this upwards movement of wind energy within a wind energy structure; they could slide/glide and be further enhanced and supported by employing “blade glide support assemblies”. That are mounted to these “specialized blade support rings” and/or “radial blade support assemblies”. “Blade glide support assemblies” are “any attempt, strategy, scheme, plan, assemblage of parts, device, occurrence, method and/or apparatus imaginable that is mounted on the top and/or bottom of any and/or all radial blade support assemblies; and/or mounted on the top and/or bottom and/or both; of any and/or all specialized blade support rings, in any way imagined and/or desired; that would provide a surface of least resistance for them to glide on and/or hang on; these could employ additional supports of any way, shape, form and number imaginable; to keep blades at their optimum angle in relationship to the incoming wind energy to maximize blade efficiencies; these blade glide support assemblies can be spaced any distance from each other that is imagined and/or desired; to further increase blade rigidity and strength and/or decrease blade vibration and/or reduce blade-to-hub stress problems; all working together to support the blades and make them much more rigid and resistant to vibrational problems and blade warping; which would rob the wind powered device of desired performance and blade longevity”. By way of example, but not as a limitation, these “blade glide support assemblies” could be simple wheels that will run in tracks. They could also involve special plastics, fabrics and metals that would provide a surface of least resistance for these “radial blade support assemblies” to glide on and/or hang from. These “blade glide support assemblies” would primarily be needed during light to moderate wind energy speeds; in wind energy speeds of around 18 MPH they will begin to lift the “radial blade support assemblies” from the “blade glide support assemblies”; allowing them to now float on wind energy within any wind energy structure.

In the interest of honesty, some of my calculations revealed that this high concentration of wind powered devices might just prove too aggressive, requiring a reduction to allow for better contact between the available wind energy and the wind powered devices. While some of my calculations revealed that many more wind powered devices may be employed. Also, my calculations show me that these wind powered devices should perform much better arranged in “staircase stacks”, which refers to “positioning the center of one wind powered device over the outer edge of the wind powered device just below it; thus providing a radius of offset, with another staircase stack beginning a diameter away; providing a diameter separation of the staircase stacks, as they pass over one another”. Additionally, “winding staircase stacks” refers to “staircase stacks that curve, and say for example but not as a limitation, follow the curved outer edge of a round wind energy structure. The options are endless, as larger wind energy structures can easily hold many more individual wind powered devices of any size imaginable. Along with a mix of various diameters, types and styles imagined.

Round wind energy structures could have multiple individual “rotating outer wall sections” that each have “inlet slots”, “intake channels”, and/or “special casement channels” on them; with or without “inlet scoops”. All but “rotating outer wall sections” and “inlet slots” have been defined earlier herein, and both of these are defined just below. These inlet slots would align with the incoming wind to channel wind energy into the structure as they swivel. It is understood that these inlet slots will vary in direction over the height of the structure, because the incoming wind direction will also vary in direction, over height. This allows for the capture of the maximum amount of wind energy within the structure; where it can then be efficiently and effectively channeled and/or concentrated and then utilized either within the structure and/or outside of it. For clarity, these individual rotating outer wall sections of the structure, are not wind powered devices by themselves. Their primary purpose is to focus wind energy into the structure, where it is captured. These sections stop rotating once their inlet slots align with the incoming wind, so that all of the wind energy will be captured, channeled and/or concentrated within the structure. For maintenance, high winds, safety, etc., these rotating outer wall sections can operate in reverse, and move their inlet slots, intake channels, etc. so that no wind energy can enter the wind energy structure.

For this application at hand, the term “rotating outer wall sections” refer to “any attempt, strategy, scheme, plan, assemblage of parts, device, occurrence, method and/or apparatus imaginable that will rotate an inlet slot, intake channel, etc. so as to maximize and/or minimize the amount of wind energy, entering a wind energy structure; any size, type and/or number can be added as needed and/or desired”. “Inlet slots” are a unique form of “intake channels” requiring their own definition for clarity; “inlet slots” involve “any attempt, strategy, scheme, plan, assemblage of parts, device, occurrence, method and/or apparatus imaginable, that are mounted in any external surface of a wind energy structure that connects the internal areas of that wind energy structure with an outside and allow wind energy to pass from an outside and then into the internal areas of that wind energy structure; during special conditions they could move and allow wind energy to pass from the internal areas of that wind energy structure to an outside; while it is preferred that these inlet slots are fixed 100% open, 100% of the time and never close; there may be times when it is necessary that some of these inlet slots include any attempt, strategy, scheme, plan, assemblage of parts, occurrence, method and/or apparatus imaginable to allow them to modulate between 100% open and 100% closed”.

These wind energy structures could have channels on all of the external surfaces that experience wind impact, or multiple rotating outer wall sections that will either operate in a self-activating manner as disclosed within this application at hand and/or through prior art manual and control theory, follow changing wind directions over height. Through further self-activating, manual and/or control theory operation, these channels on the wind impact external surface will move to open at a set point and allow wind pressure energy to enter the structure; while all of the other channels could move to close at a set point, capturing the wind energy where it can be concentrated into many other channels. It is understood that any type of channel, even motorized ones, could be used within these structures, since no other existing patent employs them in a similar way concerning wind energy. So even during light wind conditions, wind energy will become captured within the structure and then further channeled where it increases and continues to concentrate over height, through self-activating, manual and/or control theory operation of intake channels, internal channels, inlet scoops, open tops and outlet bells.

If the captured dynamic wind energy pressure becomes greater than the velocity wind energy pressure of the wind on the upper channels, then these channels could move to close at a set point and prevent the loss of any captured wind energy from within the structure. Additionally, wind energy could be diverted into any number, direction and/or type of channels and/or stages, by employing additional channels that open and/or close at set points, within the structure to maximize the energy of the available wind. My calculations show that only a few floors are needed to approach maximization. In a standard structure, rooms directly over other rooms for as few as five floors could be converted into wind energy structures with wind powered devices on the top/roof; as long as parapets are employed as disclosed herein. Or in stages over height, connected with nearby electrical, industrial and/or commercial machine devices; while adjacent rooms would continue to serve normal functions. It is understood that the word floor is used to describe any additional height of a wind energy structure and not just a standard floor.

Air straightening vanes can be added to these wind energy structures, as imagined and/or desired to assure a smooth entrance flow into structures and/or wind powered devices and/or moisture condensing devices and/or special casement channels and/or any other channel whatsoever, so as to maximize power generation. They would also assist in preventing debris from being drawn into a wind powered device during hurricanes and tornadoes; and/or simple bird screens may be employed. For the application at hand the term “air straightening vanes” refers to “any attempt, strategy, scheme, plan, assemblage of parts, device, occurrence, method and/or apparatus imaginable, that will reduce turbulence within a wind energy structure in order to maximize the flow of wind energy; any size, type and/or number can be added as needed and/or desired to assure a smooth flow of wind energy into and/or out of any and/or all wind powered devices, exhaust channels, intake channels, internal channels and/or special casement channels within a wind energy structure, to maximize the utilization of the wind energy available; further they can be used within any of the external channels, external ductwork, external pipes, external tunnels and the like; that are used to connect any number of external special casement channels and/or separate but connected structures, with a wind energy structure, and within any number of external special casement channels and/or separate but connected structures themselves”.

By example, large 250 foot diameter center up flow wind powered devices can be mounted on top of the structural support system of a wind energy structure. There is no other wind energy scheme in existence that can power a 250 foot diameter, vertical up flow, wind powered device like this one; other that my ideas expressed herein. Each one of these large wind powered devices can develop enough torque to power up to 50+, individual, large, electrical generator, machine devices, through multiple rotating shafts. With more coming on line, as wind powered device speed, increases. The top of the beam and column structural support system provides the only possible location to mount large heavy wind powered devices like this. Which are primarily used in high wind areas such as tornado alleys and hurricane coasts, so that any and all remaining available wind energy can be utilized before it leaves the structure, to weaken storm force winds. Even then, there are times that the open top above these parapet walls might need to modulate towards closing; but they will never fully close. Standard external surfaces of structures normally stop at the tops of their beam and column supports; and my research reveals that any wind powered devices mounted here, must have extended walls, often called parapets, that extend a little higher than all of the tops of any wind powered devices mounted there. To block winds from directly impacting any of the blades of a center up flow, wind powered device, like this one; and decreasing their performance and efficiencies. Below these parapet walls; columns and beams limit all wind powered devices mounted within any wind energy structure, to a maximum diameter of 48 feet.

Plus, parapets enable “Bernoulli's Principal” to push-pull wind energy through these wind powered devices and the structure. It is understood that since all of the wind energy utilized to operate any wind powered device mounted on top of these beam and column structural support system, comes from within the structure; these wind powered devices are to be considered as mounted within that wind energy structure. The extended walls, often called parapets, surrounding the top of said structure and extending higher than all tops of any wind powered device mounted there; prove that these wind powered devices are mounted within that structure. If no wind powered device is mounted on the top of the beam and column structural support system; then no parapets are required. Wind powered devices mounted anywhere within the structure could have channels leading up to the open top of any wind energy structure; that could open at a set point, so that any lift generated by air passing over the open top and/or these parapets. Making all of the wind powered devices involved more efficient, by actually pulling additional wind energy up through these devices. Producing the World's first push-pull wind power system ever conceived, with some of the highest efficiencies ever realized. Wind powered devices of any applicable number, form, type, size and/or shape could be mounted in multiple channels and/or stages over the height of the structure, or just, one.

Propeller driven wind powered devices could be mounted on swivels within the structure, and/or in any of these channels as desired, including any and/or all of the channels that allow wind to enter and/or leave the structure. It is understood that any wind powered devices mounted within any of these channels that allow wind energy to enter and/or leave a structure, are supplied by energy that then enters and/or leaves that structure; these wind powered devices are to be considered as mounted within the structure, even if they protrude from the structure and/or the channels that allow wind to enter and/or leave the structure. These wind energy structures offer the advantage of being built into and among other structures and within our big cities without becoming obtrusive and possibly could even go un-noticed, as they supply the surrounding structures with green energy in the form of electricity and/or the force, motion and/or energy to operate any form of machine device imaginable. While protecting all nearby structures during periods of high winds. Since the wind powered devices are contained within the structure; even a catastrophic failure will not be inherently unsafe; as opposed to a large propeller driven systems that could come apart and possibly destroy surrounding structures, while injuring or killing people.

With modifications, stairways, elevator shafts and/or other channels within existing structures could easily be converted into wind energy structures, while still remaining fire sealed from the primary structure they are attached to. Wind energy structures could be added onto and/or into existing structures and become a normal addition in new structures, to supply them with green energy. Architects, Engineers and Designers could work together on imaginative ways to implement wind energy structures into structures through artistic spires and/or pinnacles, or by simply disappearing them into the normal building structures. They could spiral around new and/or existing structures, and/or just be structures of any size, type, form and/or shape added onto and/or into other structures.

My calculations also show me that there are times and in special locations where surrounding formations such as other structures and/or topography like mountains, trees, etc., will focus wind into a fairly constant air flow pattern. Allowing for the addition of unique channels onto and into a wind energy structures that utilize this flow through additional wind powered devices. Some wind powered devices could be on swivels within this wind energy structure, to better utilize wind energy as wind directions shift. With further modifications, this focused wind energy can be concentrated and/or utilized through one or possibly several additional channels and/or stages of wind powered devices, keeping these devices smaller in size and weight. The power generated could be used by the surrounding structures that helped generate this focused green energy, or transmitted into the electrical power grid. Altogether, my ideas offers the new, novel, non-obvious, innovative and cost saving advantage of generating green electrical power right where it is needed the most, in downtown urban settings, and within the very structures using it. Eliminating the need for those large idiotic rural wind farms and the inefficient, extensive and expensive electrical distribution systems required to get the wind generated electrical power into urban settings, where it is needed most.

There are many advantages of this type of structure over all previous attempts. No other current wind energy system has all of these combined capabilities. Since the energy flow is within the structure, my ideas can easily maximize both the size of the structure and the size and number of the wind powered devices and/or machine devices without any loss of performance or efficiency. My calculations teach me that there are no limitations to the number of wind powered devices and/or machine devices employed; their size, or even their combined weight. With my design, the structure can simply be made larger and stronger to accept all possible variations, regardless of height, type, shape or size. Plus, my design is the most resistant to fatigue failure of any design I ever found throughout my research. I show basic round and square wind energy structures in my drawings for simplicity, but any shape, type, size, width and/or height is possible and it can flare at the top or bottom, or bend around other structures, for architectural appeal.

My open tops could incorporate a smooth shaped outlet bell, much like the inlet bell on most fans; to increase the low wind energy pressure over these open top. Why, because the outlets of my wind energy structures are far more important than the inlets. Once again proving that contained wind powered devices, operate in reverse to fans. Which is exactly what I said back on Aug. 26, 2011 in a filing in my application Ser. No. 13/135,239 on page 10, lines 1-2 “Without a well-engineered “way out”, no wind powered device within a structure will ever operate.” For this application the term “outlet bell” refers to “any attempt, strategy, scheme, plan, assemblage of parts, device, occurrence, method and/or apparatus imaginable, that is mounted on the open top of a wind energy structure in any way, shape, form and number imaginable to maximize the generation of low pressure over the open top and thereby the upwards flow of wind energy within that wind energy structure; outlet bells can also be used within a wind energy structure every so often over its entire height, or just one at the open top; some structures may have multiple open tops requiring multiple outlet bells, while some wind energy structures will have only one; any size, type and/or number can also be added as needed and/or desired to assure a smooth flow of wind energy out of any and/or all wind powered devices, exhaust channels, intake channels, internal channels and/or special casement channels within a wind energy structure, to maximize the utilization of the wind energy available; further they can be used within any of the external channels, external ductwork, external pipes, external tunnels and the like; that are used to connect any number of external special casement channels and/or separate but connected structures, with a wind energy structure; and within any number of external special casement channels and/or separate but connected structures themselves; while it is preferred that these outlet bells are fixed 100% open, 100% of the time and never close and remain 100% open, 100% of the time; there may be times when it is necessary that some of these outlet bells include any attempt, strategy, scheme, plan, assemblage of parts, occurrence, method and/or apparatus imaginable to allow them to modulate between 100% open and 90% closed; but they will never fully close”. For example, but not as a limitation, these outlet bells can also be applied every three to four floors, or every 30 to 40 feet or so; or at the top of each rotation section. To maximize the smooth upwards flow of wind energy within a wind energy structure; by maximizing the low wind energy pressure, at intervals.

I did not think that wind energy structures were possible either, until I risked my life and observed this possibility during the operation of my skylight on my own home during hurricane IVAN. If anyone had thought of the ideas taught within this patent, they would have surely employed them before now, and I see NONE! My mathematical models prove, that my wind energy structure scheme is at least one “order of magnitude” (10 times) improvement over any wind energy system currently employed on this Planet. With some calculations revealing as much as a 59 times (5,900%) improvement. Even a few calculation revealed that I could be as much as 360 times (36,000%) more efficient than anything ever previously thought of! This could mean that a single one of my wind energy structures, could replace up to 360 of those idiotic large propeller turbines!

Grated floors could be employed every so often, say every ten feet or so, to allow for easy maintenance. The grating will allow some wind energy to bypass the wind powered devices and promote a robust upwards flow of energy within the wind energy structure. Then my calculations teach me that solid floors with openings just below the next stack of wind powered devices; should be used every so often to maximize the use of the available wind energy; by avoiding bypass. These solid floors could also employ internal channels that will allow wind energy to bypass these solid floors during periods of excessive wind energy pressure. Whether grated or solid; these floors would also serve to limit any catastrophic wind powered device failure and promote increased efficiency; and could be mounted every ten feet or so, at each structural beam floor; based on ten foot high columns. A mix of grated and solid floors could be used on any structural beam floor, as desired and/or imagined.

All those skilled in the art of “wind energy” stopped looking before they got it right. Nothing about my scheme is obvious, especially when Webster's describes “obvious” as “easily discovered, seen, evident, and apparent”. How can anything be considered “obvious” when no one “discovered, saw, or found it to be evident and apparent” at any time before now, during the past 5,500 years? No one before me even thought that this was possible; because it is counter intuitive! I did not even think that the absolute best method and apparatus to utilizing wind energy on this Planet would involve employing a structure to capture, channel and/or concentrate wind energy over the height of the structure; until it was shown to me during the strongest winds of hurricane IVAN. The only thing that is obvious about what I am teaching through the patent application at hand; is that my ideas are truly new, novel and non-obvious.

The only true way to design a highly efficient method and apparatus to utilizing wind energy within a structure is by viewing wind energy primarily as a force that is governed by the “Laws of Pressure”. I knew that once wind energy is captured within a structure it will constantly strive to reach an equilibrium within that structure; and that the mathematics supporting “Pascal's Law” and “Boyle's Law” proves that all contained/captured pressures constantly seek to escape their captivity and reach equilibrium with the universe. This critical information combined with my intricate knowledge of structure pressures, allowed me to see what no one before me had ever seen; exactly how “wind energy pressure can be captured, channeled, concentrated and/or utilized within a structure”. This is the critical data that makes my wind energy structures, new, novel and non-obvious; in light of PARKER, PAGE, POLYAK, ROSSEL and/or RICHARDS.

All one needs to do is provide the captured wind energy pressure with a channel of least resistance to escape the structure through any number, type and/or size of properly designed internal channels and my always opened “open top”. “Pascal's Law” teaches us that a captured pressure exerts an equal force in all directions, allowing these channels to run in any direction imaginable, even in circles, within the structure. Also allowing wind energy structures themselves to run in any direction imaginable, even around the outside of other structures and/or topography. Additionally, there can multiple channels that can literally run in any direction imaginable and/or wind energy structures themselves that can also literally run in any direction imaginable.

Then one just needs to add any number and type of wind powered devices desired and/or imaginable to these channels and/or structures so that the escaping wind energy pressure can perform work and transform its wind energy pressure into mechanical energy and/or into electrical energy, as desired, on its way out of the structure. Therefore, it is actually the same principal that does all of the work within my scheme to protect a structure from high winds; that also does all of the work within my wind energy structure scheme. This energy is green, free, unlimited and uninterruptable by constantly renewing itself. My analysis of all current wind powered devices leaves me knowing that the best wind powered device for use within these wind energy structures, has yet to be invented. So I have taken the time within this application to define a method and apparatus that I think is an ideal wind powered device for use in these wind energy structures; that employs my “specialized blade support guides” and/or my “radial blade support assemblies” and/or my “blade glide support assemblies”. My design would be easy to repair and maintain; while possibly employing back up devices that could offer standby capabilities and/or even spare capacity as needed and/or desired. The primary device can be shut down for servicing; as a standby device is activated for uninterrupted service.

My preliminary energy and economic calculations reveal that once these wind energy structures are capitalized, in periods as short as three years, they could produce electrical power for around a penny per kilowatt; or less. My economic calculations show that this could in turn drive gasoline prices down to around $2.00 per gallon; while finally making electric vehicles truly non-polluting and extremely economical to operate. Wind energy structures could become common in all parking lots and elsewhere, ready to recharge totally electric vehicles, whenever and wherever possible.

The large propeller driven wind generators that everyone is familiar with, are far more prone to destruction by high winds than my systems, due to Coriolis Effect, cyclic stresses and gyroscopic precession. Which can literally vibrate them into destruction, while also dramatically robbing them of efficiency, every second, of every day. Plus their blades purposefully deform to prevent destruction in high winds, further reducing efficiencies. The efficiencies of my wind energy structures actually increase in high winds. The vibrations encountered by large propeller turbines, rapidly deteriorate their “blade-to-hub” connection; and the blades are the most costly parts of these turbines to build and/or replace. Their blades are abnormally large for the hub they are connected to; so they can produce the maximum amount of electricity, per installed unit. Smaller versions in the open atmosphere would fail to produce enough electricity; and thereby dramatically increase installation, maintenance and electrical production costs. Leaving no economic, or engineering reason to build smaller versions. Additionally, three of those heavy long blades are about all a single hub can handle; more blades would lead to increased “hub-to-blade” stress, resulting in even shorter blade life cycles.

The latest reports out of Britain show that the premature deterioration of blades may even further reduce their low 1% efficiencies, by half or more. While the premature failure of these huge blades will mean that the exorbitant cost of replacing them after only 12-15 years, will more than double the projected cost of the electricity produced. My wind energy structures will not suffer from any of these same destructive vibrations due to the mass of the structure; making them extremely safe for intercity applications. Since the wind travels upwards within my wind energy structures; each downward facing wind powered devices could have 50+ blades with very little “hub-to-blade” stress. As my “blade glide support assemblies” support these blades until they actually begin to float on wind energy as they rotate; eliminating nearly all of the “blade-to-hub” connection problems. The fact that the entire wind-swept area of each wind powered device could be covered with blades will dramatically increase performance; while my “specialized blade support guides” and/or my “radial blade support assemblies” reduce all “hub-to-blade” stress. Plus, individual blades could only be about ten inches in width and made from carbon fiber, aluminum and/or other light exotic materials, to dramatically reduce their weight and vibration, while dramatically increasing their strength and performance.

Additionally, these large propeller wind turbines cannot even begin to produce electricity until they encounter 8 MPH winds and then must cease all electricity production in winds above 33 MPH! In December 2011 one actually “exploded” in Ardrossan, U.K. in high winds. Again proving they can do very little to reduce storm force winds as currently designed and situated. And what do we do in our infinite wisdom? We spend billions, littering the countryside with thousands of these idiotic large propeller wind turbines; while most “new” ideas are just stupid attempts to “rearrange the deck chairs” on this “sinking Titanic version of wind energy”. No prior art wind energy scheme can handle strong winds, much less produce power in winds over 80, MPH, or right up to around 300+MPH, as I can.

From the beginning my dreams involved a truly green energy system/scheme that could supply 80% or more of America's entire electrical power needs; without any pollution; and/or any Governmental Grants and/or Subsidies. My wind energy structures can be mounted within or right next to large cities; eliminating the need for long, expensive and inefficient electrical transmission lines. Possibly generating 50% of the electrical power large cities require, within their very city limits. With some structures supplying 100% of their own electrical power needs from integrated wind energy structures. I would love to see a reputable University use a super computer to verify my performance. I say my wind energy structures can be built and produce electricity; 90%+ cheaper than a JOHN and PICKETT solar wind tower; 60% cheaper than a nuclear electrical power plant; 15% cheaper that a coal and/or oil electrical power plant and 9% cheaper than a natural gas electrical power plant; provided that all subsidies and grants are removed from all electrical power plants involved; including mine. I also say my electrical power plants of comparable kW output can be built at a fraction of the costs of these others. In other words, I am saying that my wind energy structures need no Governmental Subsidies and/or Grants to compete with any and/or all other type of Electrical Power Generation Plant, on a level playing field.

Please remember that currently, all coal, oil, natural gas and nuclear electrical power plants are heavily subsidized; though barge, pipeline, rail and all other forms of fuel transportation subsidies; along with mining/drilling, pollution, health care and many other hidden subsidies. It is my opinion that if grants and subsidies are needed to level the playing field; then something is wrong and the correct science, mathematics and/or physics has not been employed yet; and researchers need to keep studying the issues involved. Please don't forget that I am the only one of these electrical power plants that does not have to pay a single penny for fuel, or a single penny to transport any fuel to my power plants, or a single penny to pump water 2,250 feet into the air. Or a single penny for any form and/or type of pollution abatement; and absolutely the only one that is actually more efficient during storms; especially hurricanes and tornadoes. Therefore, only my wind energy structures represent the correct science, mathematics and physics!

GOD owns the wind and HE generously gives it to everyone, everywhere. No person owns the wind, no matter how much money and influence they may have; and therein lays the primary problem for the evil and the greedy. Oil, coal, natural gas and nuclear fuels are just much, much easier for the evil and greedy to control and manipulate and thereby dominate every man, woman and child on this Planet! While the pollution from their fossil and nuclear fuels; slowly kills us all! I say this is exactly why so many have sold their souls trying to destroy me and take these ideas from me over the past eight years! They are incredibly afraid of losing their death grip, on money and power!

Additionally, a purposefully cynical effort to discredit wind energy could make it look undesirable and force America and the World; back into the manipulative hands of these evil, greedy men. I would love to see the FBI investigate just who within the oil, gas, coal and nuclear Industries have been promoting the deployment of all of these large propeller wind turbine farms. They represent just about the least elegant way imaginable, to employ “wind energy”. They are less than 1% efficient based on their use of the wind power density available to them. I call them “baby mathematics” because they exhibit such immature engineering. Japan was almost destroyed by the curse of nuclear power and still no one knows exactly how to deal with nuclear waste. The Worldwide pollution associated with mining and burning coal makes it a poor energy alternative. I would love to be part of any idea that breaks the death grip OPEC has on the throats of all Western economies, so that all of the economies of the World will be based equally on the “value they add”; while economies based on the “gift of oil” become a footnote in history.

The “Law of Conservation of Energy” teaches us that “energy can neither be created nor destroyed; it can only be transformed from one state to another”. When large numbers of wind energy structures as disclosed herein are appropriately deployed in and/or around cities. For the first time in recorded history, humans could actually reduce the destructive force of hurricanes and tornadoes by transforming approximately 30% of the available wind energy into mechanical energy and therefore electrical power if desired. A destructive 140 MPH wind could be reduced to a survivable 98 MPH wind or less, while producing vast quantities of electrical power as a byproduct. Please show me another single theory in existence today that has this ability. Plus, if many of the homes had my self-activating, high wind, structure protection schemes built into them as I disclose herein, the families involved could have safely sheltered in place.

Those idiotic large propeller driven systems must be sighted/installed five rotor diameters apart, in all directions, to prevent loss of performance and turbulence damage. The average large propeller driven wind generator has a rotor diameter of approximately 230 feet, so they have to be sighted/installed at least 1,150 feet from each other, in all directions. How could such spacing ever hope to reduce storm force winds; especially with their low efficiencies? I recently read about a great article by Mark Jacobsen with Stanford University co-authored by Cristina L. Archer and Willet Kempton of the University of Delaware, concerning the very issue of using wind turbines to reduce storm force winds. I did not have access to the article itself. They say it would take nearly 78,000 of these large propeller wind turbines to significantly reduce storm force winds, which must mean that just their enormous “static” presences will reduce storm force winds; because my research says, they will self-destruct if rotating. I think it will only take about 1,000 of my wind energy structures or less, to provide similar storm force wind reduction. I do not suffer from any of the problems that plague these large idiotic propeller wind turbines. Additionally, in high winds I do not go into a “static display” mode like these idiotic large propeller turbines. Allowing me to keep transforming vast amounts of wind energy into mechanical energy and therefore electrical power; thereby reducing even more storm force winds into much more survivable winds. Thereby reducing the damage they cause; especially within large cities just as predicted by Jacobsen, Archer and Kempton; but with far fewer wind energy structures.

Single, staggered, rows of my dynamic wind energy structures could be built about 20 miles off shore; around all large seaboard cities. A good height maybe around 750 feet, but any height could be used. The bottom 40 feet and the top 50 feet will not rotate; so research labs, living areas, off shore gambling, etc., could be added and sold and/or rented with recreational areas constructed around their bases. Including large marinas for motor boats, sail boats, wind surfing, kite sailing, etc.; including racing, from platforms about 20 miles out to sea. Their underwater support structures would eventually resemble reefs and draw large amounts of fish. Providing unlimited recreational and adventure activities; while producing vast amounts of green energy and protecting the cities they encircle. My structures could be 2,300 feet tall, or taller but my research proves that the added construction and maintenance cost limits the feasible height at this time, especially when I could build around 18-20 prefabricated versions of my 750 foot tall wind energy structures for the same cost as a single 2,250 foot structure. And 18-20 offset, side-by-side, structures; will do far more to reduce storm force winds.

My wind energy structures can be of any geometric shape, size or height imaginable and mounted right next to each other, and/or in a staggered row scheme employing sophisticated mathematical modeling concerning row offset, placement and separation. Funneling and directing the available wind energy smoothly into the second row of my wind energy structures; actually allowing them to produce even better performance efficiencies than the first row, due to reduced turbulence. Assuring the maximum amount of Wind Power decrease/transformation with very little wind bypass, while still allowing for almost 360 degree exposure to varying wind directions.

Current mathematical results show that only two rows are required, with each row containing as many individual wind energy structures as desired; which means they could run for miles and miles in any direction required and/or desired. Then another two rows could be deployed every few miles or so, based on the Wind Power Density encountered. Or possibly encircle large cities to power them and protect them from hurricanes and/or tornadoes. Industrial Plants could wait to perform certain high electrical demand functions until weather fronts approached every 3-8 days; and during high wind events they could go into 24 hour operation. Plus, homeowners could turn down their thermostat during the same high wind periods, wash and dry all their laundry, charge batteries for off grid use; while Atlantic City and Vegas could go light crazy, with the cheaper electricity.

Another unique vision I have for these wind energy structures is of a structure of unlimited size and shape with a simple, strong, and repairable steel, plastic, composite, wood, etc. skeletal structure; that has an inexpensive and easy to install porous membrane covering. This porous membrane will allow wind energy to enter these wind energy structures through molecular and/or micro pore “channels” etc. Then this membrane would have the unique ability to seal its inside surface and prevent the loss of any captured wind energy. So once again, wind energy coming from any direction, is first captured by the membrane, then channeled into any number and/or size of “channels” running in any imaginable direction, then concentrated over height and then utilized to generate mechanical energy, all within the structure.

This is part of my reasoning behind using the word “channel” in my claims concerning wind energy structures. I am currently in the process of contacting several manufacturers of wind membranes concerning this unique one-way air movement. I hereby declare that I have never seen a membrane, or structure with these abilities. I envision many Military, Emergency and Disaster Area uses for this inexpensive and easy to erect wind energy structure that can be compactly stored and ready for immediate deployment. It could become the most widely deployed Third World wind energy system. The membrane could have a tear away ability that allows it to disintegrate in high winds, so as to protect the underlying structure. Maintenance would be simple as the membrane could have the ability to be easily field repaired, and/or discarded after several uses when damaged, or when it is tattered and then replaced with a new one. Several of these unique dynamic wind energy pressure structures could be deployed together to satisfy any possible mechanical energy/electrical emergency demand load.

Besides the obvious supply of electrical power and drinking water in humid climates; these wind energy structures have other strategic abilities on the battlefield. Radar, infrared cameras, motion detectors, etc. could be mounted at their tops; that are sighted past the secured area. Then Phoenix Guns, Bofors 20 and/or 40 MM Guns, Gatling guns, missile launchers, remote operated sniper rifles, etc.; could be mounted at the top of these wind energy structures, and use this data to become fully automatic; with no lives at risk on the tower. Providing the maximum amount of protection from sneak attacks, missile and rocket attacks, even RPG's. Additionally, soldiers could be stationed there too. The added height would improve communications and even allow sophisticated cell phone systems in the battlefield; for optimum and immediate use of intelligence data. All powered by green wind energy, while supplying purified water whenever possible.

The force, motion and/or energy generated by wind energy within these wind energy structures can be utilized in any number of other ways imaginable; which includes by way of example, but not so as to set limits; in vehicles, the condensing of moisture from humid air masses and/or for entertainment. Wind energy structures could be used as primary and/or supplemental water sources for meat processing complexes, hydroponic farm complexes, amusement park complexes, casino complexes, shopping centers, military complexes, industrial complexes, office complexes, government complexes, chicken processing complexes, colleges, universities, small cities, especially small rural communities, remote resorts, American Indian communities, especially islands, farms, ranches, military outpost, medical complexes; while still providing electrical power, other needed machine device operations, ventilation, along with any needed machine device operation, and protecting them during major storms. Amusement Parks applications could involve machine devices and rides both inside and outside of wind energy structures; providing commercial, entertainment and educational opportunities.

Additionally, my wind energy structures can be painted and/or formed to blend in with surrounding structures and topography, basically disappearing them into their surroundings. They will not be scars on the land, like drilling rigs and mines. In a strange trip back through history, my wind energy structures on Polynesian Islands could be painted and formed to resemble Tiki Gods; in an interesting and useful resemblance of the statues of Easter Island. Once standard, uniform design criteria have been established; my structures can be mass produced by many factories, in many areas of America and the World. In sections, that can be transported by ships, railcars and barges; assuring high quality control and uniform construction with fully interchangeable parts. Well trained and educated travelling teams can quickly prepare many sites at once and be followed by more teams that then field assemble and erect the parts. My Wind Electrical Power Plants are far simpler than all of these other Plants; requiring far fewer maintenance workers, resulting in far less total maintenance cost and cheaper electricity for everyone.

Imagine farms in humid climates with my wind energy structures sighted about 3,000 feet apart, in all directions. They could have stadium lights on all sides that allow farmers to work in the cool of the night with wind powered electrical generators and sleep away the heat of the day, in inexpensive air conditioning. The self-generated rain would water their crops, livestock and personal needs and they could sell green electrical power to the grid. Hydroponic vegetable farms, dairy farms, chicken farms, beef and pork fattening farms, etc. could now be located in high wind humid areas; with air conditioned work areas to better control worker comfort, animal health and insect infestations.

These wind energy structures could help save the Third World and prevent future wars over water supplies. Even in this country during the drought of the past several summers, there were many days with high humidity, but it would just not rain. I think I can make it rain. Mother Nature just needs some help. We have beat her up a little and heated her up a little and changed what is normal. When there is normal rain; these wind energy structures would become extremely efficient rain capture systems. They would already have cisterns to catch the rain generated within the structure; and during normal rains much, much more rain will be captured that with a normal cistern. This is a direct result of the fact that large amounts of wind energy that will be drawn, pushed and/or channeled into these wind energy structures as previously described. Now this wind energy will contain large amounts of entrained rain from outside that will be driven from the wind energy within these structures by the motion and force of the wind powered devices. Wind energy structures built over salt water to protect seaboard cities from hurricanes and storm surges could have uniquely designed bases that break the surface tension of the ocean and increase evaporation. Unique rain gutters situated 30 feet or so above the ocean; will collect purified drinking water that could pumped to shore.

I could not find where anyone has ever condensed moisture within an “open top structure” using only momentum generated by wind energy. Vapor compression, reverse osmosis, condensing stills and other ideas have been extensively used; but almost all of them use electricity to operate and usually a lot of it. But I am using no electricity and in fact I will normally be producing vast amounts of electricity while I am producing condensed/distilled drinking water as a waste byproduct. For this application the phrase “moisture condensing” or any version thereof, involves “any attempt, strategy, scheme, plan, assemblage of parts, device, occurrence, method and/or apparatus imaginable, to utilize the upwards flow of wind energy within a wind energy structure to drive humid air masses into saturation thereby allowing any moisture present to condense, including any attempt, strategy, scheme, plan, assemblage of parts, occurrence, method and/or apparatus imaginable to transmitted the force, motion and/or energy generated within a wind energy structure in any way imaginable in any attempt, strategy, scheme, plan, assemblage of parts, occurrence, method and/or apparatus imaginable, to condense any moisture present in any humid air drawn/pulled/sucked through any imaginable number, shape, form, type and/or style of separate but connected structures and/or connected special casement channels; that are connected to a wind energy structure through external channels, external ductwork external pipes, external tunnels and the like”.

Moisture will only condense when it reaches its dew point temperature. Which is exactly what happens on a cooling coil with vapor compression; and yes moisture will condense on either the highest horizontal internal surface and/or the coolest internal surface of just about any “closed container”. This holds true for solar stills which by necessity must be a “closed systems” that employ “closed containers”; so that the moisture present, is not allowed to escape. But I am not talking about that; I am talking about generating condensation using momentum within my “open top”, wind energy structures to generate the coincidence of the dew point and dry bulb temperatures.

This means I am generating this coincidence within an “open top system” and within an “open top container”. This is extremely difficult given the physics of this Planet and I was unable to find another similar coincidence within any patent, idea, scheme or any open system in existence; and I was on ASHRAE's Dehumidification Committee for several years. We often discussed this coincidence, but we never ever discussed anything remotely similar to what I am disclosing herein. Moisture within “open top containers” seldom if ever condenses without incurring a dramatic temperature swing, such as the cold surface of a cold glass or liquid, a cold window surface, or a vapor compression cooled coil surface; or any cold surface. The moisture/humidity will keep moving “upwards” because as proven earlier “Avogadro's Law” teaches us that humid air, is lighter and thus less dense than dryer air.

This lighter air will simply keep moving upwards until it naturally reaches coincidence within the cooler air aloft; which is why the bottom of clouds represents where the dew point and dry bulb temperature coincide. If air with water vapor in it was not lighter than dry air, there would be no evaporation what-so-ever on this Planet, and there would be no clouds what-so-ever, in our skies. This is a huge problem for anyone evaporating warm water into dry warm air and attempting to create a downward flow of air; because fighting physics is neither fun, nor profitable. Plus, attempting to evaporate cool moisture into cool air, during nights and winters will prove just as difficult, if not impossible. Very little water will actually evaporate because the process begins with very little difference between the dew point and the dry bulb. Cool air with moisture vapor in it, is still lighter than dry cool air; which is why we still have clouds in the winter.

This is why the absolute moisture content of a body of air is always defined either by its dew point temperature and/or by the grains of moisture it holds, per pound of dry air. Two of the primary sides of every psychrometric chart; with dry bulb temperature as the bottom line of the chart. This allows practitioners to use fairly simple mathematics to calculate total moisture content. My calculations teach me that whenever the dew point is within 8 F of the dry bulb temperature, I should be able to use the momentum of wind energy; either within “geometric moisture condensing devices” and/or within any wind powered device. Within my wind energy structures and/or within any connected channels and/or structures; to close this 8 F gap and reach the coincidence of the dry bulb and the dew point in approximately 33% of the humid air mass present.

Subsequently, I will generate moisture condensation that will rain within these wind energy structures at the hand of man in way that is unique in human history; but is almost exactly how GOD set nature up to create rain. I am well aware of “high mass air wells”, “radiative air wells”, “active air wells”, “air drop systems” and “atmospheric water generators”. I am not employing any of their ideas, instead I envision my wind energy structures with the unique ability to become “open atmospheric, high mass, momentum, water generators”. That do not directly employ any of the critical characteristics of any previous moisture condensing system; but instead employs techniques that no man has ever employed on this Planet before now. And no they are not like the ones on Tatooine in Star Wars, the ones disclosed herein, are real.

For our discussion here; a “centrifugal force” is “a force that pulls air out and away from the center of a rotation mass”; and a “centripetal force” is “a force that pushes air towards the center of a rotating mass”. Then I will be using a “centripetal force” generated by the force of wind energy spinning my wind powered devices and pushing this force towards their rotating center shaft; over the height of the structure. This will in turn push the heavier dryer air masses towards this rotating center mass. Leaving the lighter humid air mass at or near the outer walls of my wind energy structures; where I can coalesce them into saturation. Several calculation showed the reverse; with the lighter humid air masses moving towards the center, where they still coalesced into saturation. Either way the results were the same; rain within my structures.

Then, if needed, I will employ catalysis such as silver iodide and/or carbon dioxide (dry ice) or even infrared lasers to ionize the air; that will in turn cause water droplets to immediately condense, while also cooling the air around the condensed water droplets; generating a “chain reaction” of condensation/rain. Which will in turn further cool the surrounding air, driving even more of the available moisture into saturation. I will need to conduct extensive tests to determine how to maximize the generation of mechanical energy within my wind energy structures through sophisticated design; along with extensive tests to determine how to maximize the condensation of moisture within them; and then create a chart that would allow a user to pick and choose the best wind energy structure system for their particular needs; from hopefully at least 100 choices.

Herein “geometric moisture condensing device” is “any attempt, strategy, scheme, plan, assemblage of parts, device, occurrence, method and/or apparatus imaginable of geometric shapes and/or forms, in any size, type and/or number that are configured in any way, so as to assist in any way; to use only wind energy momentum to drive air with any available moisture content into saturation and/or condensation; these geometric moisture condensing devices can be configured in either a vertical air flow position and/or a horizontal configuration; or they can be tilted in any direction imaginable between vertical and horizontal; regardless of which configuration is employed; these geometric moisture condensing devices do not have to face the incoming wind; nor do they need open tops; some will rotate and some will remain in fixed positions; thereby maximizing the generation of water within a wind energy structure, they can be applied to the any and/or all of the blades of individual wind powered devices; also within any and/or all exhaust channels, intake channels, internal channels and/or special casement channels and within a wind energy structure itself, to maximize the capture of any water available; further they can be used within any of the external channels, external ductwork, external pipes, external tunnels and the like; that are used to connect any number of external special casement channels and/or separate but connected structures, with a wind energy structure, and/or within any number of external special casement channels and/or separate but connected structures themselves”.

These “geometric moisture condensing devices” fully comply with the above “moisture condensation” definition. As stated above, some will be formed into any and/or all of the blades of individual wind powered devices; converting them into “geometric moisture condensing blades”. I will connect some to wind powered devices so that they can rotate and produce my desired coincidence through “centrifugal force”; and some will be positioned in fixed positions within my wind energy structures, connected but separate structures and/or my special casement channels. All available water will be collected and stored, or distributed.

Wikipedia defines “vehicle” as “a mobile machine that transports passengers and/or cargo; most often, vehicles are manufactured, such as bicycles, cars, trucks, buses, motorcycles, trains, ships, boats and aircraft”. All of which fully complies and conforms to my definition of a “machine device” herein. When wind energy structures are merged into a ship/boat's structure; it will form what could be called “dynamic wind energy ships”. On dynamic wind energy ships, just as on any other vehicle and/or vehicle structure; channels could easily be merged into the ships structure and be installed around, over, beside, through and under rooms that serve other purposes such as living quarters, cargo holds, administrative areas, galleys, etc. Thereby allowing wind energy to be captured, channeled, concentrated and/or utilized within the vehicle's structure; by one or many wind powered devices. On some dynamic wind energy ships some of the wind energy structures will run high above the decks of the ship and some structures could be raised to capture more wind energy and then lowered during extreme wind conditions, or when docked. These ideas could easily be merged into the structures of other vehicles creating “dynamic wind energy vehicles” of any type and/or form imaginable.

So, even though structures are emphasized in this patent, it is understood that the same principles of a method and apparatus to utilize wind energy within any structure could be applied to constructing any structure such as but not limited to commercial, military, governmental, industrial, amusement, vehicular and/or residential, etc. structures, regardless of size, shape, and/or number of floors and/or decks involved; to efficiently utilize the push-pull power of an upwards flow of wind energy within a structure; for ventilation, moisture condensing and producing mechanical energy for useful work, which will include producing electricity, etc. By capturing, channeling, concentrating wind energy within that structure to operate any form, type and size of wind powered device including any form, type and size of connected machine device. Including mobile machine devices within vehicles. Other aspects of the invention are more fully disclosed hereafter.

While preferred embodiments have been described, it will be appreciated that other modifications, adaptations and changes to the invention will be readily apparent to those skilled in the art. I hereby declare that I had all of these included ideas back in 2006 and chose to keep some of them private until now. I have just realized that I am now unable to patent my core ideas as originally planned. This would have protected all of the above therein and prevented others from taking them from me; while I continued to study them. Since I am forced to dramatically limit my claims; I must clearly state now, how I intended to employ my ideas, all along.

### DESCRIPTION OF THE DRAWINGS

FIG. 1-16 Are views of an apparatus and method for utilizing the power of an upwards flow of wind energy within “wind energy structures” with one or more open tops to initiate a push-pull wind energy system, one or more structural supports, one or more external surfaces, separating one or more internal areas with one or more floors with one or more rooms with one or more internal surfaces, from an outside.

FIG. 1 Is a three dimensional view or a square wind energy structure; illustrating wind powered devices, machine devices, geometric moisture condensing devices, special casement channels, intake channels, exhaust channels, internal channels and external channels, along with grated and solid service floors.

FIG. 2 Is a three dimensional view of a round wind energy structure; illustrating large, split, sliding doors over an open top that also has an outlet bell with a large wind powered device just below it, rotating outer wall sections, inlet slots and inlet scoops.

FIG. 3 Is a cross sectional view of a round wind energy structure; illustrating opened large, split, sliding doors over an open top that has an outlet bell with a large wind powered device just below it, machine devices, air straightening vanes, rotating outer wall sections, multiple stacks of wind powered devices, some having geometric moisture condensing blades, individual geometric moisture condensing devices and a cistern.

FIG. 4 Is illustration of another embodiment of this invention; revealing another way of obtaining the maximum amount of work from a single wind energy structure by transmitting any and/or all of the force, motion and/or energy generated by the upwards flow of wind energy within that structure to any number, shape, form, type and/or style of separate but connected structures imaginable and/or desired, through external channels, external ductwork, external pipes, external tunnels and the like.

FIG. 5 Is a plan view example of a square wind energy structure; showing how wind energy structures can fit between the beam and column structural layout.

FIG. 6 Is a plan view example of a round wind energy structure; showing how wind energy structures can fit between the beam and column structural layout.

FIG. 7-9 Are cross sectional views of wind energy structures showing how multiple stacks of wind powered devices can be arranged within floors and within rooms and between structural columns and beams.

FIG. 10-11 Are plan views of a wind energy structure showing how multiple stacks of wind powered devices can be arranged within rooms and between structural beams.

FIG. 12 Is a cross sectional view of a special casement channel, with a special containment casing with a single inlet and a single outlet. Further illustrating specialized blade support guides, radial blade support assemblies and blade glide support assemblies.

FIG. 13-14 Are three dimensional drawing of one possible way to control and/or modulate the operation of any intake, exhaust and or internal channel.

FIG. 15 Is a three dimensional drawing of the top large, split, sliding doors as one of the best methods of operating this open top between 100% open and 90% closed.

FIG. 16 Provides the “design temperatures” for Yuma, Ariz.

### DETAILED DESCRIPTION OF THE INVENTION

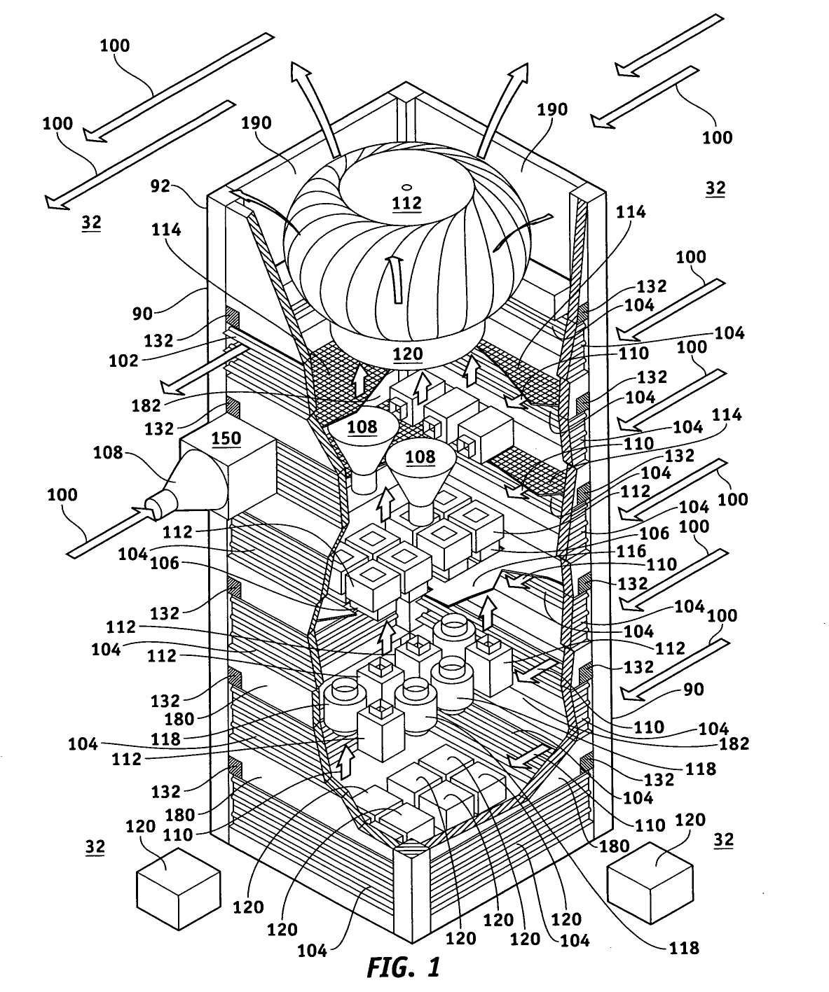

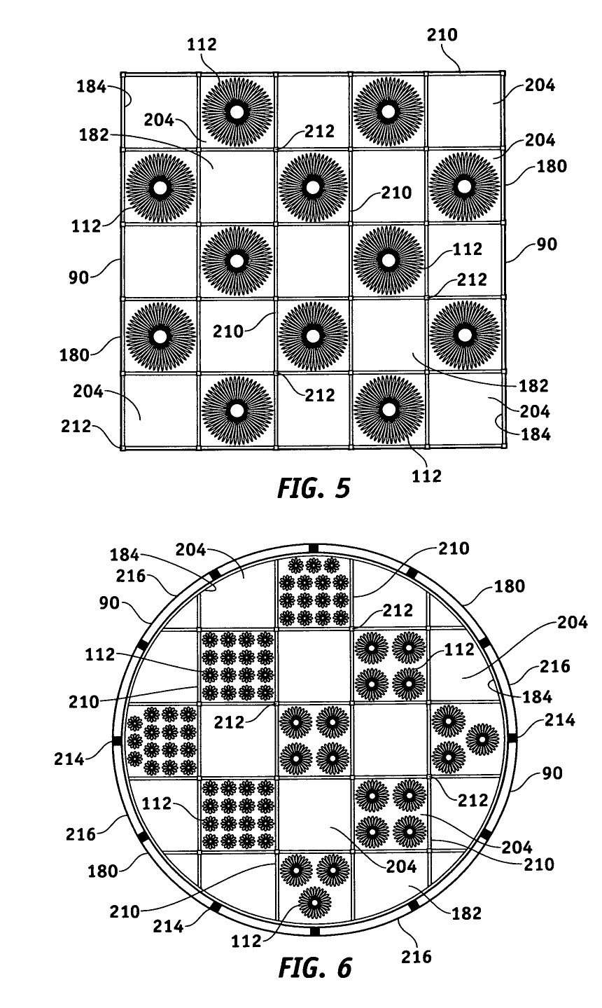

FIGS. 5-7 Illustrates how to utilize “Bernoulli's Principal” to create the World's first push-pull wind energy structure 90. Involving an apparatus and method for utilizing the power of an upwards flow of wind energy 110 within wind energy structure 90, with one or more open tops 190, one or more structural supports 210 and 212, and one or more external surfaces 180, separating one or more internal areas 182 with one or more floors 202 with one or more rooms 204 with one or more internal surfaces 184, from an outside 32. It is understood that structure 90 could be of any type, shape, height, depth, width and/or length imaginable, which are all included by reference and inference; and will employ standard structural engineering design guidelines and requirements.
FIG. 1 This particular three dimensional illustration is of an equal sided, square structure 90. The preferred embodiment is a structure 90 that has minimal internal obstructions that could impede the upward flow of wind energy 110. Further, illustrated is the installation of intake channels 104 on all sides that could possibly receive wind 100. Internal channels 106 can be employed within structure 90 as shown; to channel, concentrate and/or utilize this wind energy 110 through any size, type, shape or number of wind powered devices 112. It is understood that any number, type, form and/or style of multiple stages of wind powered devices 112 and/or geometric moisture condensing device 118 imagined and/or desired can be mounted within and/or attached to a single wind energy structure 90. The only limitation here is the size, type, shape and/or height of the wind energy structure itself 90 and it can be designed to any size, type, height and/or shape desired or imagined.

With further modifications, the force, motion and/or energy produced by any wind powered device 112 within structure 90 can be further utilized by directly connecting them machine devices 120 mounted within structure 90 and/or by connecting them with one or more machine devices 120 remotely mounted within structure 90 and/or outside 32 of structure 90, through the addition of shafts 124 (not shown), belts 126 (not shown), drive lines 128 (not shown) and the like (not shown or numbered). It is understood that any applicable form, type, size and/or number of machine devices 120 can be employed, both within structure 90 and outside 32 of it. So while all of the wind energy 110 is captured, channeled and concentrated within structure 90, the force, motion and/or mechanical energy generated by any wind powered device 112 located within the structure 90 can be either utilized within structure 90 and/or transmitted to the outside 32 of structure 90 and utilized in any scheme, plan, assemblage of parts, occurrence, method and/or apparatus 120, imaginable and/or desired.

For this particular illustration I purposefully used simple boxes and shapes for wind powered devices 112 with internal machine devices 120, because I wanted to make a point that specialized devices 112 and 120 can be used to meet any sophisticated industrial and/or commercial need. Showing boxes allows ones imagination to envision possibilities that would be limited if I always showed the normal propeller type of wind powered device 112. I do show propeller type device 112 in most of my other drawings, because they are the norm. Please note that the wind 100 is coming from the right hand side, therefore all of the intake channels 104 on that side have moved to open at a set point, while the intake channels 104 on all of the other sides have moved to close at a set point. This will serve to capture wind energy 110 within structure 90 and prevent it from leaving until it reaches the open top and/or an exhaust channel 102. An exhaust channel 102 is shown on the left hand side, at the top of structure 90, and has moved to open at a set point, to release wind energy 110 and thereby relieve any undesired excess of wind energy 110. Any exhaust channels 102, intake channels 104, internal channels 106, external channels 150, special casement channels 108, inlet scoops 144, outlet bells 130, open tops 190, etc.; involved with any wind energy structure 90, will move to open and/or move to close and/or modulate anywhere in between, at set points as desired and/or imagined.

Other existing internal channels 106 (not shown) such as stairways 106 (not shown) and/or abandoned elevator shafts 106 (not shown), within any structure (not shown and not numbered) can also be used to capture, channel, concentrate and/or utilize wind energy 110 as long as landings (not shown) still allow an open internal channel 106 to exist from the bottom to the open top of that structure. Sufficient intake channels 104 (not shown) must be installed so that these existing internal channels 106 (not shown) are allowed to capture, channel and/or concentrate as much wind energy 110 as possible.

This drawing includes the placement of a large center flow wind powered device 112 that has a large machine device 120 directly connected to it; sitting on the top of the structural support system 210 and 212 for structure 90. By example, this allows this 112 to be the full size of a two-hundred-fifty foot open top 190; and provides the only possible location to mount large wind powered device 112 like this, on any wind energy structure 90. Because below this open top 190; fifty foot beams 210 limit all wind powered devices 112 mounted within structure 90, to a maximum diameter of forty-eight feet. Large wind powered devices like this are used primarily in high wind 100 areas such as tornado alleys and hurricane coasts, so that any and all remaining available wind energy 110 can be utilized before it leaves structure 90, to weaken storm force winds 100.

Since external surfaces 180 of standard structures 90, normally stop at the tops of their beam 210 and column 212 supports; my research reveals that any wind powered devices 112 mounted on top of these beam 210 and column 212 supports of wind energy structure 90, must have extended walls 92 often called parapets 92 which describe the same surface, that extend a little higher than all tops of wind powered devices 112 mounted there, leaving them totally within structure 90. These will prevent high winds 100 from directly impacting the blades 170 and/or 172 of the wind powered devices 112 mounted at this location. Which will actually reduce the efficiency of a center flow wind powered device 112, like this one. Plus, the open top above parapets 92 enables “Bernoulli's Principal” to push-pull wind energy 110 through these wind powered devices 112 and entire structure 90. It is understood that since all of the energy 110 utilized to operate any wind powered device 112 mounted on top of these beam 210 and column 212 supports of structure 90, comes from within structure 90; these wind powered devices 112 are to be considered as mounted within structure 90. Additionally, with extended walls 92 often called parapets 92 surrounding the top of said structure 90 and extending higher than all tops of said wind powered devices 112 mounted there; proves that these wind powered devices 112 are mounted within structure 90.

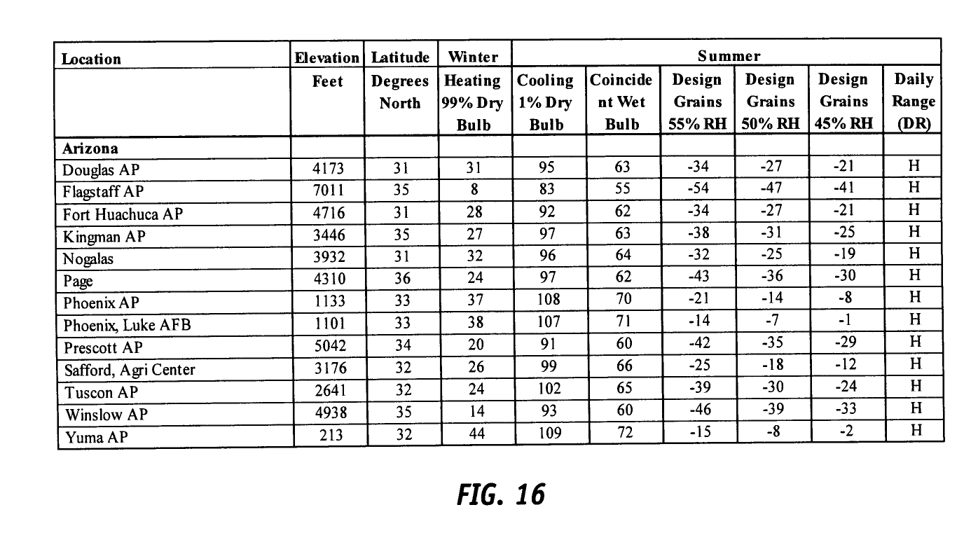

Three more wind powered devices 112 with internal machine devices 120 are mounted in one of the intake channels 104 on the right side, that allow wind 100 to enter structure 90, with internal channels 106 used to direct wind energy 110 into and out of them. Just below these are eight more wind powered devices 112 with internal 120 machine device; mounted on top of solid floor 116. Each uses internal channels 106 to direct wind energy 110 into them. Just above these and on the left are two rotating geometric moisture condensing devices 118, which are connected to two of these eight wind powered devices 112 with shaft drive 124 (not shown). So, each of these two single device 112 are providing mechanical energy to two devices; one internal 120 and one external 118. Just to the left of these moisture condensing devices 118 is a special casement channel 108; in outside 32; connected to wind energy structure 90 through external channel 150. External ductwork 152 (not shown), external pipes 154 (not shown), external tunnels 156 (not shown) and the like (not shown) could have been used to connect channel 108 to structure 90. This allows the upwards flow of wind energy 110 within structure 90 to pull/draw/suck wind 100 through this special casement channel 108; and into structure 90. The internal configuration of this special casement channel 108 is addressed in detail in FIG. 16. Grated 114 and solid 116 service floors are shown to allow for better maintenance and limit catastrophic wind powered device failure, while affording additional control of wind energy 110 flow. And could be mounted every ten feet or so, at each structural beam 210 floor; based on ten foot high columns 212. A mix of grated 114 and solid floors 116 could be used on any structural beam 210 floor, as desired and/or imagined.

Four more stages of wind powered device 112 are shown just below solid floor 116; intermixed with four individual moisture condensing devises 118. These four 112 devices are connected to the six remotely mounted 120 machine devices within the bottom of structure 90; and the two 120 machine devices remotely mounted in outside 32, one on the left and another on the right, of structure 90. A series of belt drives 126 (not shown) are configured to connect these twelve devices, four 112's with eight individual and separate 120 machine devices. It is understood that more intake channels 104 and/or more exhaust channels 102 can be employed over the height of structure 90 as wind 100 velocities increase over height. Sometimes more intake channels 104 may be used on the lower floors 202 than the upper floors 202; or more exhaust channels 102 may be used on the upper floors 202 than the lower floors 202. The term floor 202 is used to describe any increase in structure 90 height and is not limited to the normal description of a floor 202.

Since “Pascal's Law” teaches us that this captured wind energy 110 pressure exerts an equal force in all directions, these internal channels 106 can run in any direction imaginable (not shown), even in circles (not shown), within structure 90. This same “Law” allows these wind energy structures 90 themselves to run in any direction imaginable (not shown); even around other structures (not shown) and/or topography (not shown); as long as they have an open top 190 to enable “Bernoulli's Principal”. There can be multiple internal channels 106 that can literally run in any direction imaginable (not shown) and/or wind energy structures 90 themselves that can also literally run in any direction imaginable (not shown); as long as they also have open tops. Wind powered devices 112 can be mounted in any channel in any way imaginable, including internal channels 106, special casement channels 108, intake channels 104, exhaust channels 102 and/or external channels 150. Any wind powered devices 112 mounted within any of these channels, are to be considered as mounted within the structure 90; even if they protrude from structure 90 because all of the wind energy 110 utilized to operate them either then enters structure 90, or came from within wind energy structure 90.

Wind powered devices 112 mounted anywhere within structure 90 could have internal channels 106 leading to the top of structure 90 that will move to open at a set point; so that any lift generated by wind 100 passing over the open top 190 of structure 90 and/or extended walls 92 often called parapets 92, will make all of the wind powered devices 112 involved, more efficient, especially during high winds 100, by pulling more energy 110 up through these wind powered devices 112, producing the World's first push-pull wind energy 110 system, with some of the highest efficiencies ever realized.

Wind energy structures 90 can withstand 150 MPH+ winds 100, while producing substantial mechanical energy; because their efficiencies dramatically increase in winds 100 above seventy MPH. No sealed surfaces are needed for this type of structure 90 to withstand hurricanes and/or tornadoes and is strong enough to withstand even stronger winds 100 and continue to produce mechanical energy and therefore electrical power throughout any high wind 100 event, including tornadoes and/or hurricanes, through the implementation of properly designed wind energy structures 90, properly designed high speed wind powered devices 112, along with properly sized and located exhaust channels 102, in sufficient numbers. Some exhaust channels 102 can be configured to also act as intake channels 104 when needed; and vice-versa.

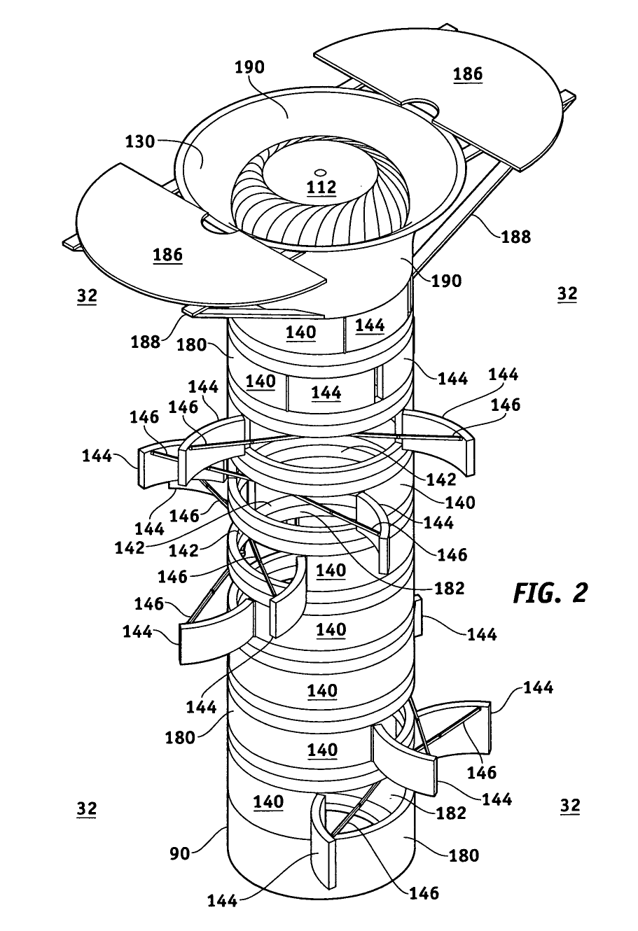

FIG. 2 By way of example and not as a limitation, this three dimensional view of a round wind energy structure 90 illustrates how the inlet slots 142 of these rotating outer wall sections 140 will move to face in different directions to accommodate differing incoming wind 100 directions over height. By example and not limitation, structures 90 could have a twenty-two foot inside diameter and be about one-hundred-twenty feet tall, with individual rotating outer wall sections 140 every ten feet. With twenty-five wind powered devices 112, each with a twenty foot diameter. On a larger scale, these wind energy structures 90 could be of any height, width and/or geometric shape imaginable. Or by example they could be round, seven-hundred-fifty feet tall with a two-hundred-fifty foot inside diameter; with twenty individual rotating outer wall sections 140 that are each thirty-two feet high, by two-hundred-fifty feet inside diameter. The internal structural beams 210 and columns 212; along with the bottom forty feet and the top fifty feet of this seven-hundred-fifty foot tall structure 90; will not rotate; to provide structural rigidity.

Continuing with this example, each of these rotating outer wall sections 140 will have vertical inlet slots 142 that are about two-hundred-sixty feet wide, by thirty-two feet tall; or about one-third of the circumference of structure 90. With or without, modulating inlet scoops 144 that are approximately one-hundred-thirty feet wide by thirty-two feet tall, each. These inlet scoops are operated and stabilized by control arms 146. Usually inlet scoops 144 will be split, with one half of the opening/slot/channel's 142, 102, 104, 106 and/or 108 width covered by one inlet scoop 144; while the other half of the opening/slot/channel's 142, 102, 104, 106 and 108 width is covered by the other inlet scoop 144. Each side or these inlet scoops 144 can be modulated individually and/or closed individually, while the other inlet scoop 144 is not moved at all. These vertical inlet slots 142 align with the incoming wind 100, to channel wind energy 110 into structure 90 as they swivel. These inlet slots 142 are illustrated in direction over the height of the structure as shown, because the incoming wind 100 direction will also vary in direction over height; thereby capturing the maximum amount of wind energy 110 within structure 90. These inlet scoops 144 assist in channeling more wind 100 into structure 90 where it becomes captured wind energy 110. Inlet scoops 144 on the top two rotating sections 140 have modulated closed, to prevent the loss of wind energy 110. Sometimes it will prove advantageous to just close a single inlet scoop 144; leaving the other inlet scoop 114 beside it, fully opened. With these inlet slots aiming in so many different directions; wind 100, wind energy 110 and devices 112, 118 and 120 have been purposefully removed for clarity. Rotating outer wall sections 140 of any wind energy structure 90; are not wind powered devices 112 by themselves. Their sole purpose is to focus wind 100 into structure 90 where it is captured. Sections 140 stop rotating once their inlet slots 142 are aligned with incoming wind 100, so wind energy 110 will be captured, channeled and/or concentrated within structure 90.

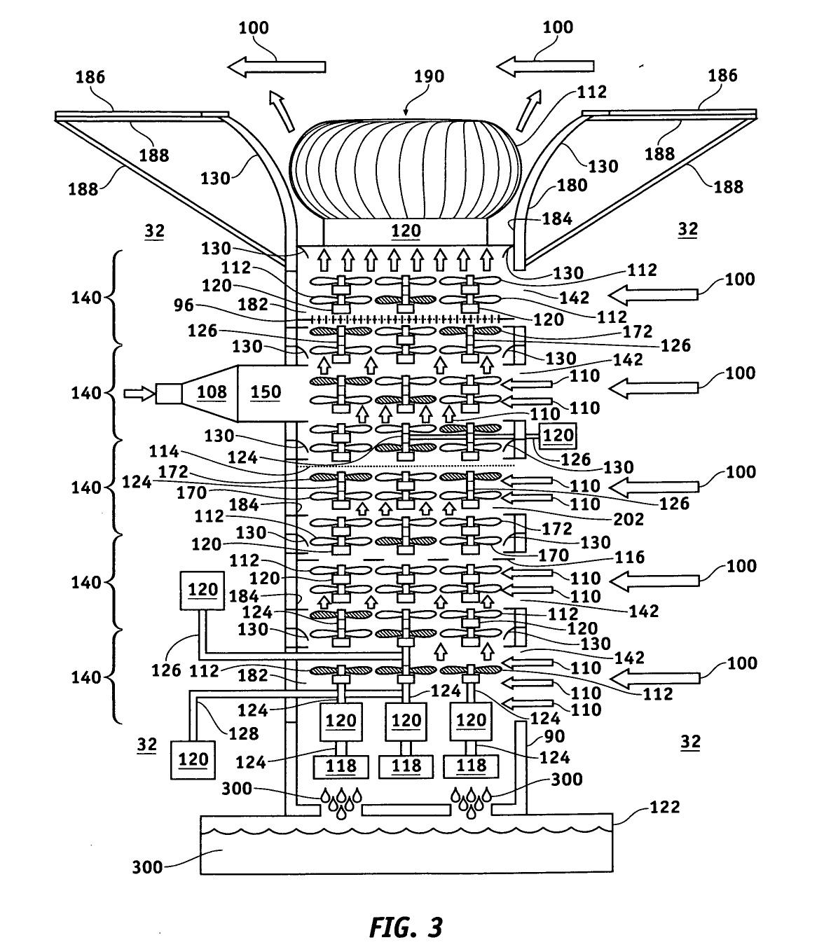

FIG. 3 According to another embodiment of the invention, this is a cross sectional view of an apparatus and method for utilizing the power of an upwards flow of wind energy 110 within a round wind energy structure 90. Illustrated is an outlet bell 130 at the open top 190 of structure 90, to assure a smooth flow from the structure, increasing the effectiveness of the low wind energy pressure over the top outlet 190. Improving the push-pull effect of “Bernoulli's Principal” throughout structure 90; along with anything connected to it. Outlet bells 130 have been added to the top of each rotating outer wall section 140; additional outlet bells 130 can be added at various heights, and used in any way imaginable, within structure 90; for increased low wind energy 110 pressure generation, and increased performance. This drawing illustrates one of the best methods of operating this open top 190 between 100% open and 90% closed, with large, split, sliding doors 186. By way of example, but not as a limitation; a two-hundred-fifty foot inside diameter open top 190 would have large, split, sliding doors 186 that slide on rails 188 that extend past the top 190. These large, split, sliding doors 186 would be split down the middle, with one half going one direction and the other half going the other direction. When these large, split, sliding doors 186 are fully opened for about 98%+ of every hour of every day, the extended flat surfaces of these large, split, sliding doors 186 around my open tops 190; would actually smooth out the flow of wind 100 over this open top 190 which will directly increase wind 100 velocity and generate an even higher-velocity-lower-pressure force over this open top 190. Which will in turn pull/draw/suck even more wind energy 110 up though structure 90 in accordance with “Bernoulli's Principal”.

Air straightening vanes 96 of any size, type and/or number can be added as desired, to assure a smooth entrance flow into any and/or all wind powered devices 112, geometric moisture condensing devices 118 and/or channels 102, 104, 106 and 108 as needed and/or desired, to maximize the utilization of the wind energy 110 available. They could also prevent debris from being drawn into a wind powered device 112 and/or geometric moisture condensing devices 118 and/or channels 102, 104, 106 and 108, during hurricanes and tornadoes. Or simple bird screens can solve this problem.

It is understood that any number, type, form and/or style of multiple stages 134, 136 and/or 138 of wind powered devices 112 and/or geometric moisture condensing device 118 imagined and/or desired can be mounted within, wind energy structure 90. Wind powered devices 112 can be directly connected to machine devices 120 within structure 90 and/or they can be connected to single and/or multiple rotating shafts 124, all driving a single and/or multiple machine devices 120, over height to efficiently utilize wind energy 110. Some 112 can then be connected through shafts 124, belts 126, drive lines 128 and the like; with any number, form, type, shape and/or size of machine devices 120 mounted within these wind energy structures 90 and/or outside 32 of them.

This particular structure 90 has multiple standard stacks 134 of wind powered devices 112 over height; many more stacks will be located in front of and behind these stacks 134. Pairs of devices 112 are connected together with common shafts 124 to power high torque machine devices 120; along with many individual wind powered devices 112 connected with individual machine devices 120. As you can see this figure became quite congested with numbers; so I was unable to number every device 112 and 120. Just to the right of structure 90 is a remote machine device 120 mounted in outside 32 and connected to several of these common shafts 124 with belt drive 126. About half of all these wind powered devices 112 have “shaded” moisture condensing blades 172. A set of air straightening vanes 96 is shown near the top. The open top 190 has large, split sliding doors that are opened, including slide rails 188 and a large wind powered device 112 mounted on top of the structural beams 210 and columns 212 directly connected with machine device 120. Grated 114 and solid 116 service floors are shown to allow for better maintenance and limit catastrophic wind powered device failure, while affording additional control of wind energy 110 flow. And could be mounted every ten feet or so, at each structural beam 210 floor; based on ten foot high columns 212. A mix of grated 114 and solid floors 116 could be used on any structural beam 210 floor, as desired and/or imagined. Also illustrated is special casement channel 108 that is mounted on the left side of structure 90 in outside 32 that is connected to one of the rotating outer wall sections 140 of structure 90 through external channel 150. External ductwork 152 (not shown), external pipes 154 (not shown), external tunnels 156 (not shown) and the like (not shown) could have been used here.

Three rotating geometric moisture condensing devices 118 are connected to three common shafts 124 near the bottom of wind energy structure 90; just below three remote mounted machine devices 120 that are connected to these same common shafts 124. Several wind powered devices 112 are also connected to these same common shafts 124; to provide the necessary mechanical energy to power any and/or all devices 120 and 118 that are also connected to these common shafts 124. Two more remote machine devices 120 are mounted just to the left of structure 90 in outside 32 and connected to several of these same common shafts 124. One 120 with drive line 128 while the other 120 employs belt drive 126. Condensed moisture in the form of water 300 is shown flowing from the bottom of structure 90 and into cistern 122 or the like, where it is stored or distributed.

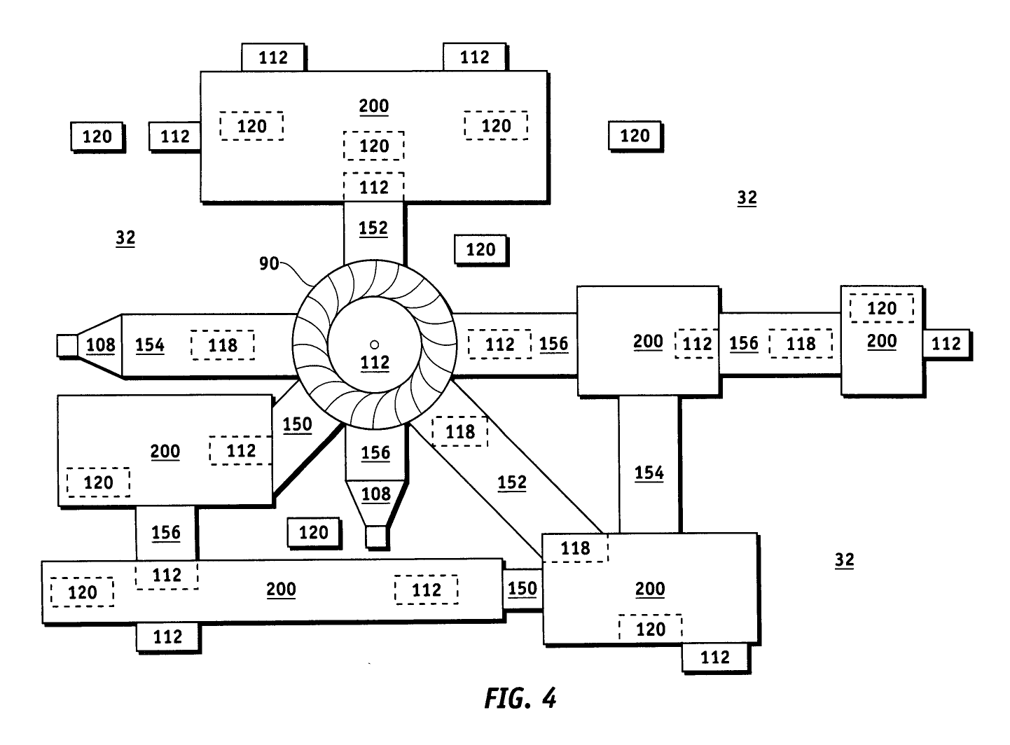

FIG. 4 Is a three dimensional plan view illustration of another embodiment of this invention; revealing another way of obtaining the maximum amount of work from a single wind energy structure 90 by transmitting any and/or all of the force, motion and/or energy generated by the upwards flow of wind energy 110 within that structure 90 to any number, shape, form, type and/or style of separate but connected structures 200 imaginable and/or desired, through external channels 150, external ductwork 152, external pipes 154, external tunnels 156 and the like. This would allow a single wind energy structure 90 to perform even more useful work, by ventilating these connected structures 200; providing more locations for wind powered devices 112, geometric moisture condensing devices 118, and machine devices 120. Along with furnishing any unique machine device 120 operations that these separate structures 200 need. While also supplying them with water and electricity and protecting them during major storms. Thereby providing an even larger return on investment.

By way of example, but not as a limitation; these separate but connected structures 200 could represent internet centers, cloud centers, meat processing complexes, hydroponic farm complexes, amusement complexes, military complexes, industrial complexes, office complexes, government complexes, chicken processing complexes, colleges, universities, small cities, especially small rural communities, remote fishing villages, American Indian communities, island community, farms, ranches, military outpost, medical complexes and the like. None of these are specifically and individually shown on my drawings, nor are they specifically numbered as the above groups. I just wanted to give people something to think about. For clarity and simplicity, I will just number every separate but connected structure 200; with the clear understanding that any and all of the above groups and more, are including by reference and inference.

Wind energy 110 will be drawn/sucked/pulled through these separate but connected structures 200 and then into wind energy structures 90. These separate structures 200 do not have to be part of structure 90, nor do they need to be structurally connected to structure 90. Only the external channels 150, external ductwork 152, external pipes 154, external tunnels 156 and the like; are needed to connect separate structures 200 to one another, and to wind energy structure 90. Also illustrated is a special casement channel 108 that is mounted on the bottom side of structure 90 in outside 32, and connected to wind energy structure 90 through external tunnel 156. Another special casement channel 108 is mounted on the left side of structure 90, in outside 32, and connected to wind energy structure 90 through external pipe 154. External pipe 154 also contains a moisture condensing device 118. It is understood that external channel 150 (not shown), external ductwork 152 (not shown), and the like (not shown) could have been used at either of these locations.

Again referring to this drawing, several separate structures 200 may be connected to each other in any way imaginable through external channels 150, external ductwork 152, external pipes 154, external tunnels 156 and the like; and then connected to wind energy structure 90 with more of the same 150, 152, 154, 156 and the like. It is understood that any number, type, form and/or style of multiple stages of wind powered devices 112 and/or geometric moisture condensing device 118 imagined and/or desired can be mounted within and/or attached to any separate structure 200 and/or within any of the external channels 150, external ductwork 152, external pipes 154, external tunnels 156 and the like; that connect separate structures 200 and/or structure 90. Then any wind powered device 112 can be directly connected to a machine device and/or connected to remotely mounted machine devices 120 that are mounted within these separate but connected structures 200 and/or within structure 90 and/or outside 32 of them; through shafts 124, belts 126, drive lines 128 and the like. All powered by wind energy 110 that is pulled/drawn/sucked through them 200 and then into wind energy structure 90; that can then be utilized to produce mechanical energy and/or electricity that can then be used in any way imaginable. Wind powered devices 112, geometric moisture condensing devices 118 and/or machine devices 120 shown with dotted lines; illustrates that they are in fact within these structures 200 and/or their connections; such as external channels 150, external ductwork 152, external pipes 154, external tunnels 156 and the like.

FIGS. 5-6 Illustrates single structural floors 202 of individual wind energy structures 90. The large wind powered device 112 shown on the top of structure 90 in FIGS. 1-4; will be mounted on the top of the highest structural floor 202 of structure 90. Which is the only place a large device 112 like these can be mounted on structure 90.
FIG. 5 Is a plan view example of say a two-hundred-fifty foot by two-hundred-fifty foot square wind energy structure 90; showing the layout of the fifty foot maximum beam 210 lengths used. I will round all dimensions for simplicity and clarity. So, this structure 90 will have twenty-five; fifty foot by fifty foot structural rooms 204, per floor 202. Every crossing of these beams 210 is supported by a ten foot high column 212; producing a ten foot high structural floor 202. A seven-hundred-fifty foot high structure 90 would have seventy-five such ten foot high structural floors 202 over height. So this structure 90 will have a total of 1,875 structural rooms 204. With a maximum structural beam 210 spread of fifty feet; the largest wind powered device 112 possible, would have a forty-eight foot diameter. Structure 90 could hold 4,320 individual forty-eight foot diameter wind powered devices 112 within these 1,875 structural rooms. These forty-eight foot diameter wind powered devices 112, could have fifty individual blades 170 and/or 172 or more; instead of the normal three on wind farm devices 112. Which allows the individual blades 170 and/or 172 to be much narrower, much more efficiently shaped and much lighter than normal; possibly as thin as helicopter blades, constructed of high strength laminates. This increased number of blades 170 and/or 172 will dramatically improve the efficiencies of every wind powered device 112.

Or this same structure 90 could also hold; a total of 90,000 individual ten foot diameter wind powered devices 112. Or 27,000 individual, twenty foot diameter wind powered devices 112. Mounted in stages 134, 136 and 138 over the height of structure 90; allowing 60%+ free area for service, and insuring proper wind energy 110 flow within structure 90. These are all good applications of this scheme and/or they can be applied in any mix of diameters of wind powered devices 112, imagined and/or desired to utilize the structural spaces 202, 204 and wind energy 110 available. The open rooms 204 on this floor 202 will be full of similar wind powered devices 112 on the next floor 202; leaving open rooms 204 above devices 112 on this floor 202 for optimum performance.

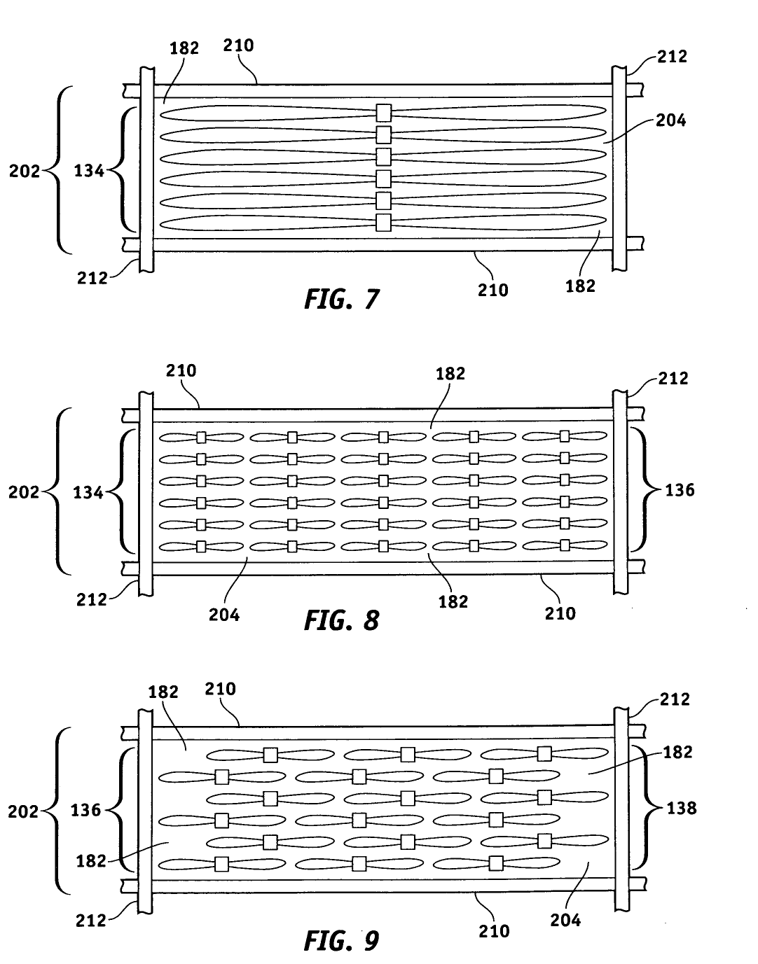

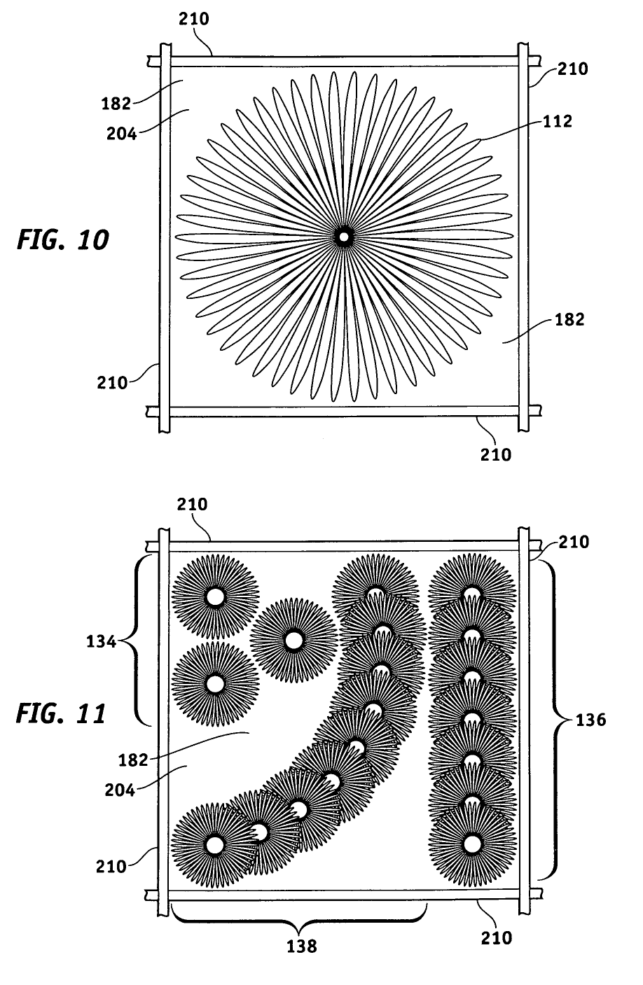

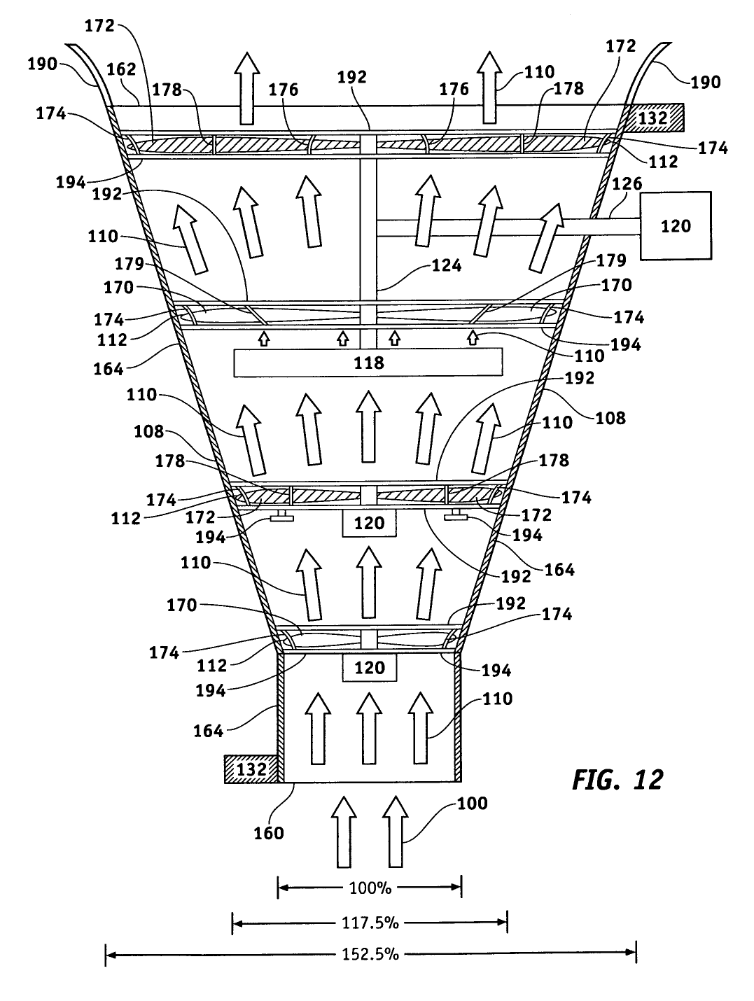

FIG. 6 Is a plan view example of say a two-hundred-fifty foot diameter round wind energy structure 90; showing the same layout of the fifty foot maximum beam 210 lengths used. So, this structure 90 will round out to approximately twenty; fifty foot by fifty foot structural rooms 204 per floor 202; and will hold a similar number of wind powered devices as the square structure with less free area. So, this round wind energy structure 90 could hold 17,280 individual twenty-four foot diameter wind powered devices 112; or 69,120 individual twelve foot diameter wind powered devices 112 as shown. The open rooms 204 on this floor 202, will be full of similar wind powered devices 112 on the next floor 202; leaving open rooms 204 above devices 112 on this floor 202, to maximize efficiency. This round structure 90 has twelve large outer steel frame work columns 214 that are spaced evenly apart around structure 90 circumference that will run just inside of the rotating outer wall sections 140; for the full height of structure 90. Then track and gear works 216 for these rotating outer wall sections 140 would be added to these twelve large columns 214; every thirty-five feet of height.
FIGS. 7-11 I purposefully did not number the individual wind powered devices 112 or individual machine device 120 on these figures because the primary goal for these figures is to show how standard stacks 134, and staircase stacks 136 and winding staircase stacks 138 will fit within structural rooms 204, of structural floors 202.
FIG. 7 Is a cross sectional view of one structural room 204, of a structural floor 202, of a square wind energy structure 90; illustrating the possible arrangements of a single large stack 134 of six wind powered devices 112 that completely fill this structural room 204. Beams 210 are above and below; with columns 212 shown on both the right and the left. For example and not limitation, this arrangement of wind powered devices 112 within rooms 204 could be repeated within twelve of the twenty-five rooms 204 of each of the seventy-five floors 202, of a square wind energy structure 90 that was say two-hundred-fifty feet by two-hundred-fifty feet; and seven-hundred-fifty feet tall.
FIG. 8 Is a cross sectional view of one structural room 204, of a structural floor 202, of a square wind energy structure 90, illustrating the possible arrangements of sets of staircase stacks 136 of wind powered devices on the right hand side, with sets of standard stacks 134 of wind powered devices 112 on the left hand side. Beams 210 are above and below these stacks 136 and 134; with columns 212 shown on both the right and the left. By way of example and not as a limitation, this arrangement of wind powered devices 112 within rooms 204 could be repeated within twelve of the twenty-five rooms 204 of each of the seventy-five floors 202, of a square wind energy structure 90 that was say two-hundred-fifty feet by two-hundred-fifty feet; and seven-hundred-fifty feet tall.
FIG. 9 Is a cross sectional view of one structural room 204, of a structural floor 202, of a round wind energy structure 90, illustrating the possible arrangements of sets of winding staircase stacks 138 of wind powered devices 112 on the right hand side, with sets of staircase stacks 136 of wind powered devices 112 on the left hand side. Beams 210 are above and below these stacks 138 and 136; with columns 212 shown on both the right and the left. By way of example and not as a limitation, this arrangement of wind powered devices 112 within rooms 204 could be repeated within nine of the roughly twenty rooms 204 of each of the seventy-five floors 202 of a round wind energy structure 90, that say had a two-hundred-fifty foot diameter; and was seven-hundred-fifty feet tall. My calculations show me that these wind powered devices 112 should perform better arranged in staircase stack 136 as shown; where the center of one wind powered device 112 is positioned over the outer edge of the wind powered device 112, just below it. Additionally, they could be arranged in winding staircase stacks 138 that follows the curved outer edge on this round structure 90, by example, but not as a limitation. Providing a radius of offset and then another staircase stack 136 and/or 138 will begin a radius away; allowing a radius separation of the staircase stacks 136 and/or 138 as they pass over one another. Additionally, the staircase stacks 136 and/or 138 themselves may be offset by a radius and not pass directly over a lower staircase stack 136 and/or 138. The options are endless as structures 90 with larger diameters, and increased height, can easily hold many, many more individual wind powered devices 112.
FIG. 10 Is a plan view of one structural room 204, of a wind energy structure 90, illustrating the possible arrangements of a single set of large stacks of wind powered devices 112 that completely fill this structural room 204. Beams 210 are show all the way around this room 204; as a different view of a similar room shown in FIG. 7.
FIG. 11 Is a plan view of one structural room 204, of a wind energy structure 90, illustrating the possible arrangements of multiple smaller standard stacks 134, staircase stacks 136 and winding staircase stack 138 of wind powered devices 112 that fill this structural room 204. Beams 210 are show all the way around this room 204; and is a different view of a similar rooms shown in FIGS. 8-9.
FIG. 12 Is a cross sectional view of a special casement channel 108, with special containment casing 164, illustrating a number of consecutive wind powered devices 112. These special containment casings 164 could be as simple as a length of ductwork, pipe, tunnel, tube and the like that are purposefully designed with a single inlet 160 and a single outlet 162 to prevent the introduction of additional wind energy 110 once it contacts the first available wind powered device 112. So that the same body of air that moves through the first wind powered device 112 will also pass through each consecutive stage of wind powered devices 112. While the wind energy 110 that this body of air possesses will constant decrease as it propels each consecutive stage of wind powered device 112 that are fully contained within these special casement channels 108. These wind powered devices 112 can then be directly connected to a machine device 120 and/or connected to remotely mounted machine devices 120 that are mounted within these special casement channels 108 and/or within a wind energy structure 90 and/or outside 32 of them through shafts 124, belts 126, drive lines 128 and the like. As each contained stage of wind powered device 112 transforms a certain amount of the available wind energy 110 into mechanical energy; the remaining unchanged body of air volume has less and less available wind energy 110, while the volume of the body of air involved remains the same. So to prevent wind stagnation, the diameter, wind-swept area and/or cross sectional areas of these special containment casings 164 must enlarge approximately 17.5%, but it could enlarge by as much as 100%+ or as little as 5%, but it will always enlarge, after each consecutive contained stage of wind powered device 112. Plus in most but not all cases, each consecutive contained stage of wind powered devices 112 within each special casement channel 108, will have fewer blades 170 and/or 172.

Any and/or all of the force, motion and/or energy generated by the upwards flow of wind energy 110 within a wind energy structure 90 is transmitted to any number, shape, form, type and/or style of special casement channels 108 imaginable. This would allow a single wind energy structure 90 to perform much more work, providing a much larger return on investment. Some 108 channels can be mounted totally within structure 90 and some could be mounted totally outside of structure 90 in outside 32, connected to wind energy structure 90 through external channels 150, external ductwork 152, external pipes 154, external tunnels 156 and the like. It is understood that any number, type, form and/or style of multiple stages of geometric moisture condensing device 118, whether fixed or rotational, as imagined and/or desired can be fully contained within special casement channel 108, including “shaded” geometric moisture condensing blades 172. Special casement channels 108 can be configured either in a vertical airflow and/or a horizontal airflow as shown in FIGS. 5-6 and 8. Or tilted in any direction imaginable between vertical and horizontal. Regardless of which configuration is employed; these special casement channels 108 do not have to face the incoming wind 110.

This particular special casement channel 108 has a vertical up airflow. The top outlet 162 of this particular special casement channel 108 includes outlet bell 130. Just below this are two wind powered devices 112 connected together through the implementation of shaft 124. This same common shaft 124 is also directly connected to rotatory geometric moisture condensing device 118 that is just below these two wind powered devices 112. Once again this common shaft 124 is connected with machine device 120 that is mounted in outside 32, on the right hand side through belt drive 126. Below geometric moisture condensing device 118 are two individual wind powered devices 112; with each having its own machine device 112, directly connected to it.

The blades 170 and/or 172 on any wind powered device 112, within any wind energy structure 90 and/or any special casement channel 108 and/or any separate but connected structure 200; could be supported every so often as shown in this drawing. By employing specialized blade support rings: 174 outwardly curved, 176 inwardly curved, 178 straight up and/or 179 straight outward; as needed, desired and/or imagined. For this current example one outwardly curved specialized blade support ring 174 has been placed at the ends of each blade 170 and 172 of each wind powered device 112 involved. You can also that several of these wind powered devices; have moisture condensing blades 172. Then moving out from the center of the top device 112 there is an inwardly curved blade support ring 176, followed by a straight specialized blade support ring 178. Radial blade support assemblies 192 are attached to the tops of every specialized blade support ring on each of these wind powered devices 112; plus blade glide support assemblies 194 mounted to the bottoms of every specialized blade support ring 174, 176, 178 and/or 179. The second wind powered device from the bottom employs track type blade glide support assemblies 194 that involve wheels for blades 170 and/or 172 to glide on before floating.

If a wind powered device 112 has a forty-eight foot diameter; it could have a straight specialized blade support ring 178 with a twenty-four foot diameter; then an inwardly curved blade support ring 176 with a diameter of thirty-six feet. And a final specialized blade support ring 174, 176, 178 and/or 179 with a diameter of forty-eight feet, mounted right on the end tips of blades 170 and/or 172, to provide strength and support right where it is needed the most; at the end of each blade 170 and/or 172. My calculations show that this final specialized blade support ring 174, 176, 178 and/or 179 should be mounted right on the end tips of blades 170 and/or 172, regardless of blade 170 and/or 172 length; to provide support right where it is needed the most, and to maximize the downstream low wind energy pressure. Each ring 174, 176, 178 and/or 179 will either be attached within the width of blade 170 and/or 172, or directly to the top of blades 170 and/or 172. In all cases the angled straight ring 179, or the curved portion of rings 174 and/or 176; will always be on the leaving air side, or top, or top side, of all blades 170 and/or 172; to enhance the generation of low pressure areas downstream, or top, of each consecutive stage of wind powered device 112. Proving once again that the way wind energy 110 leaves a wind powered device 112; is much more important than the way wind energy 110 enters a wind powered device 112; or these curved shapes would have been mounted on the bottom of blades 170 and/or 172. Blades 172 are “shaded”.

Additionally, these specialized blade support rings 174, 176, 178 and/or 179 will maintain the proper, desired blade 170 and/or 172 separation, or distance apart, from each other; over their entire length, further reducing vibration and assuring maximum efficiencies. Then these specialized blade support rings 174, 176, 178 and/or 179 themselves could also have support arms that radiate out from the center of the wind powered device 112 and all the way out to the 174, 176, 178 and/or 179 support ring installed on the tips of blades 170 and/or 172; on the tops and/or bottoms and/or both, of blades 170 and/or 172. All working together to form radial blade support assemblies 192, that support blades 170 and/or 172 of any length, shape, form and/or number imaginable. These radial blade support assemblies 192 will keep blades 170 and/or 172 at their optimum angle in relationship to the incoming wind energy 110 to maximize blade efficiencies. While also making them much more rigid and resistant to vibrational problems and blade warping; which would rob the wind powered device 112 involved, of desired performance and blade 170 and/or 172 longevity.

All of these blades 170 and/or 172 of each and every downward facing wind powered device 112; will actually be floating on this upwards flow of wind energy 110 within every wind energy structure 90; while for the first time ever, gravity will be exerting the exact same force on each and every downward facing blade 170 and/or 172. Removing almost all of the blade-to-hub stress; in a way that has never been seen before. Before they begin to float, these blade could employ blade glide support assemblies 194; mounted on the top and/or bottom and/or both; of any and/or all radial blade support assemblies 192 to provide them with a surface of least resistance as they rotate. To avoid sagging; while keeping blades 170 and/or 172 at their optimum angle, in relationship to the incoming wind energy 110 to maximize blade 170 and/or 172 efficiencies and further reduce any vibration. Also, these blade glide support assemblies 194 could be mounted on the top and/or bottom and/or both; of any and/or all specialized blade support rings 174, 176, 178 and/or 179; as imagined and/or desired.

Some of the individual blades 170 can be of special “shaded” geometric moisture condensing shapes 172 that will condense moisture from humid wind energy 110. These specialized blade support rings 174, 176, 178 and/or 179 that are mounted within blade 170 and/or 172 width, can actually allow the implementation of shorter individual blade 170 and/or 172 segments; that just run from one specialized blade support ring 174, 176, 178 and/or 179 to the next specialized blade support ring 174, 176, 178 and/or 179. This way blade 170 and/or 172 manufacturing, installation and maintenance will be exceeding easier and less expensive; while further reducing the possibility of a catastrophic failure. My calculations show that these multiple narrow blades 170 and/or 172 that employ my specialized blade support rings 174, 176, 178 and/or 179; will be far more efficient and longer lasting than the normal three blades (not shown) currently used. Lasting possibly six times as long and/or forever with the correct composites. These same specialized blade support rings 174, 176, 178 and/or 179 and radial blade support assemblies 192 can be used on vertically mounted wind powered devices 112.

Each blade 170 and/or 172 on smaller wind powered devices 112, may have specialized blade support rings 174, 176, 178 and/or 179 every so often as desired and/or imagined; to decrease blade 170 and/or 172 vibrations, reducing blade-to-hub stresses. Once again, each ring 174, 176, 178 and/or 179 will either be attached within the blade width, or directly to the top of the blades. In all cases the angled straight ring 179, or the curved portion of rings 174 and/or 176; will always be on the leaving air side, or top, of all blades 170 and/or 172; to further enhance the generation of low wind energy pressure areas downstream, on top or after, of each consecutive stage of wind powered device 112. So even ten foot diameter wind powered devices 112 could have a ten foot diameter blade support ring 174, 176, 178 and/or 179 attached to the outer tips to maximize the downstream low wind energy pressure; providing support where it is needed the most.

Twenty-four foot diameter wind powered devices 112 could have a twenty-four foot diameter specialized blade support ring 174, 176, 178 and/or 179 attached to the outer tips; along with another twelve foot diameter specialized blade support ring 174, 176, 178 and/or 179 of any shape desired, for added blade strength and rigidity, if desired. And for example, a twenty foot diameter wind powered devices should also have a twenty foot diameter support ring 174, 176, 178 and/or 179 attached to the outer tips to maximize the downstream low wind energy pressure; plus an additional ten foot diameter specialized blade support ring 174, 176, 178 and/or 179 of any shape desired, for added blade strength and rigidity. Support rings 174, 176, 178 and/or 179 used on these smaller blades 170 and/or 172 could also have support arms that radiate out from the center of the wind powered device 112 and all the way out to the final 174, 176, 178 and/or 179 support ring installed on the tips of blades 170 and/or 172; on both the tops and bottoms of blades 170 and/or 172; to form radial blade support assemblies 192. Then blades 170 and/or 172 could employ blade glide support assemblies 194; mounted on the top and/or bottom and/or both; and/or on any and/or all radial blade support assemblies 192 to provide them with a surface of least resistance as they rotate.

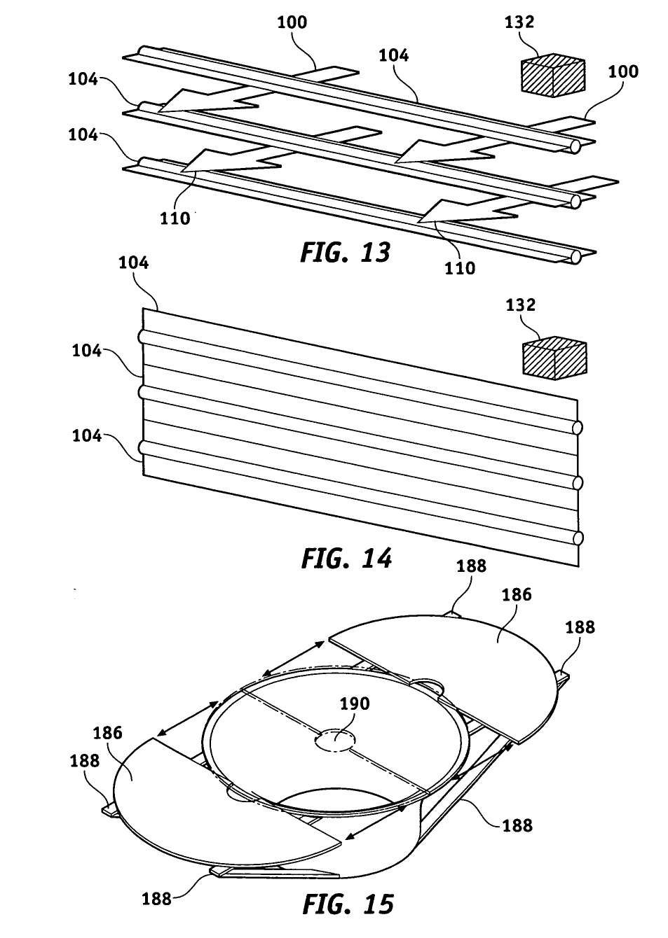

FIG. 13-14 Are both three dimensional drawings of one possible way to control the operation and modulation of any intake channel 104, exhaust channel 102, internal channel 106, special containment channels 108 and/or external channels 150. Illustrating both the closed and modulating configurations and how wind 100 becomes wind energy 110 once it enters structure 90. These may be operated through manual control, “control theory” and/or “self-activating” operation that requires no external influence and/or assistance; and/or any mix, version, attempt, strategy, scheme, plan, method assemblage of parts, occurrence, and/or apparatus thereof, imaginable and/or desired. To attempt to clearly show each of these and their movement; would prove too cumbersome and complex for these drawings. And each has been disclosed in detail herein. Each and every channel shown in FIGS. 5-8 will be operated by at least some form of these; so for clarity each operation will be shown by the same number 132 on the drawings. Allowing the designer to choose which is best, for that specific location.
FIG. 15 Is a three dimensional illustration of large, split, sliding doors 186 as one of the best methods of modulating open tops 190 between 100% open and 90% closed. These large, split, sliding doors 186 would be split down the middle, with one half of 186 sliding on rails 188 in one direction and the other half of 186 sliding in the other direction. Sliding doors 186 could have a center hole that is equal to 10% of the entire open top 190; so that even when doors 186 slide fully close, these open tops 190 would still be in fact 10% opened.
FIG. 16 Provides the “design temperatures” for Yuma, Ariz. That I used in my arguments against JOHN and PICKETT U.S. Pat. Nos. 8,120,191; 8,517,662, 8,643,204 and/or 8,727,698; presented herein.

The description of the present embodiments of the invention has been presented for the purposes of illustration, but is not intended to be exhaustive or to limit the invention to the form disclosed. Many modifications, adaptations and variations will be apparent to those of ordinary skill in the art. As such, the present invention has been disclosed in connection with the preferred embodiments which fall within the spirit and scope of the invention as defined by the following claims.

1) A method for utilizing the push-pull power of an upwards flow of wind energy to ventilate a wind energy structure and/or to condense moisture and/or to ventilate separate but connected structures including:
a) a structure with one or more open tops, one or more structural supports, one or more external surfaces, separating one or more internal areas with one or more floors with one or more rooms with one or more internal surfaces, from an outside;
b) including one or more adjustable intake channels;
c) further including providing at least one of said one or more adjustable intake channels in at least one of said one or more external surfaces of said wind energy structure;
d) wherein said at least one of said one or more adjustable intake channels is configured to open at desired set points and allow said wind energy to pass from said outside, and enter into at least one of said one or more internal areas within at least one of said one or more floors within at least one of said one or more rooms, within said wind energy structure;
e) wherein said at least one of said one or more adjustable intake channels is further configured to close at desired set points to prevent the loss of said wind energy that has entered into said at least one of said one or more internal areas within said at least one of said one or more floors within said at least one of said one or more rooms, within said wind energy structure;
f) wherein said wind energy structure is configured so that said wind energy that has entered into said at least one of said one or more internal areas within said at least one of said one or more floors within said at least one of said one or more rooms, is allowed to leave said wind energy structure thought at least one of said one or more open tops, into said outside; and
g) further including setting at least one of said set points for said at least one of said one or more adjustable intake channels.

2) The method of claim 1 further including:
a. providing one or more adjustable internal channels within said wind energy structure;
b. wherein at least one of said one or more adjustable internal channels is configured to open at desired set points and allow said wind energy that has entered within at least one of said one or more internal areas within at least one of said one or more floors within at least one of said one or more rooms within said wind energy structure to pass through said at least one of said one or more adjustable internal channels, within said wind energy structure;
c. wherein said at least one of said one or more adjustable internal channels is further configured to close at desired set points to prevent any said wind energy that has entered within said at least one of said one or more internal areas within said at least one of said one or more floors within said at least one of said one or more rooms, within said wind energy structure to pass through said at least one of said one or more adjustable internal channels, within said wind energy structure; and
d. further including setting at least one of said set points for said at least one of said one or more adjustable internal channels.

3) The method of claim 1 wherein at least one of said one or more adjustable channels, is self-activating.

4) The method of claim 1 further including:
a. providing one or more adjustable rotating outer wall sections with one or more inlet slots;
b. wherein at least one of said one or more adjustable rotating outer wall sections is configured to position at least one of said one or more inlet slots so as to allow wind energy to pass from said outside and into at least one of said one or more internal areas within at least one of said one or more floors within at least one of said one or more rooms, within said wind energy structure at desired set points; and
c. further including setting at least one of said set points for said at least one of said one or more adjustable rotating outer wall sections.

5) The method of claim 1 further including:
a. providing one or more inlet scoops;
b. wherein at least one of said one or more inlet scoops is adjustable and configured to modulate based on set points; and
c. further including setting at least one of said set points for said at least one of said one or more adjustable inlet scoops.

6) The method of claim 1 wherein at least one of said one or more adjustable channels is configured to modulate based on set points; including setting at least one of said set points for said at least one of said one or more adjustable channels.

7) The method of claim 1 further including:
a. providing one or more adjustable open tops;
b. wherein at least one of said one or more adjustable open tops is configured to modulate between 100% open and 90% closed based on set points; and
c. further including setting at least one of said set points for said at least one of said one or more adjustable open tops.

8) The method of claim 1 further including providing one or more geometric moisture condensing device, wherein at least one of said one or more geometric moisture condensing devices is configured to condense moisture from said wind energy within said wind energy structure.

9) The method of claim 1 further including:
a. providing one or more outlet bells;
b. wherein at least one of said one or more outlet bells is adjustable and configured to modulate between 100% open and 90% closed based on set points; and
c. further including setting at least one of said set points for said at least one of said one or more adjustable outlet bells.

10) The method of claim 1 further including one or more air straightening vanes.

11) The method of claim 1 further including connecting one or more separate structures to said wind energy structure;
a. including a connection between said wind energy structure and at least one of said one or more separate structures; and
b. wherein said connection is configured so that said upwards flow of wind energy within said wind energy structure, pulls said wind energy through said at least one of said one or more separate structure and into said wind energy structure.

12) A method for utilizing the push-pull power of an upwards flow of a wind energy within a wind energy structure to produce mechanical energy and/or useful work and/or electricity and/or to condense moisture including:
a) a structure with one or more open tops, one or more structural supports, one or more external surfaces, separating one or more internal areas with one or more floors with one or more rooms with one or more internal surfaces, from an outside;
b) further including one or more wind powered devices with one or more blades within said wind energy structure configured to convert said upwards flow of wind energy into said mechanical energy;
c) further including one or more machine devices;
d) further including a connection between at least one of said one or more wind powered device and at least one of said one or more machine devices, so that together they convert said mechanical energy into said useful work;
e) further including a connection between at least one of said one or more machine devices and at least one of said one or more wind powered devices, so that together they convert said mechanical energy into said electricity;
f) including a wall surrounding the top of said structure wherein said wall extends approximately as high as all tops of at least one of said one or more wind powered devices mounted on top of the highest of at least one of said one or more structural supports.

13) The method of claim 12 further including one or more specialized blade supports rings and/or one or more radial blade supports and/or one or more blade glide supports on at least one of said one or more blades on at least one of said one or more wind powered devices, within said wind energy structure.

14) The method of claim 12 further including one or more grated floors and/or one or more solid floors, mounted on at least one of said one or more structural supports, within said wind energy structure.

15) The method of claim 12 further including:
a. providing one or more geometric moisture condensing devices, wherein at least one of said one or more geometric moisture condensing devices is configured to condense said moisture from said wind energy;
b. and/or providing one or more geometric moisture condensing blades, wherein at least one of said one or more blades on at least one of said one or more wind powered devices is at least one of said one or more geometric moisture condensing blades; and
c. wherein said at least one of said one or more geometric moisture condensing blades is configured to condense said moisture from said wind energy.

16) The method of claim 12 further including one or more special casement channels, configured so that the said upwards flow of wind energy within said wind energy structure moves a volume of air containing said wind energy through said one or more special casement channels:
a. including a special containment casing with a single inlet and a single outlet;
b. including two or more wind powered devices within at least one of said one or more special casement channels;
c. including one or more machine devices within said at least one of said one or more special casement channels;
d. further including a connection between at least one of said two or more wind powered devices and at least one of said one or more machine devices within said at least one of said one or more special casement channels; and
e. wherein said special containment casing is configured to enlarge after each of said two or more wind powered devices within said at least one of said one or more special casement channels.

17) The method of claim 12 further including one or more separate structures that are connected with said wind energy structure;
a. including one or more wind powered devices within at least one of said one or more separate structures;
b. further including one or more machine devices within said at least one of said one or more separate structures; and
c. further including a connection between at least one of said one or more wind powered devices and at least one of said one or more machine devices within said at least one of said one or more separate structures.

18) An apparatus for utilizing the push-pull power of an upwards flow of wind energy to ventilate a wind energy structure and/or to condense moisture and/or to ventilate separate but connected structures including:
a) a structure with one or more open tops, one or more structural supports, one or more external surfaces, separating one or more internal areas with one or more floors with one or more rooms with one or more internal surfaces, from an outside;
b) including one or more adjustable intake channels;
c) further including providing at least one of said one or more adjustable intake channels in at least one of said one or more external surfaces of said wind energy structure;
d) wherein said at least one of said one or more adjustable intake channels is configured to open at desired set points and allow said wind energy to pass from said outside, and enter into at least one of said one or more internal areas within at least one of said one or more floors within at least one of said one or more rooms, within said wind energy structure;
e) wherein said at least one of said one or more adjustable intake channels is further configured to close at desired set points to prevent the loss of said wind energy that has entered into said at least one of said one or more internal areas within said at least one of said one or more floors within said at least one of said one or more rooms, within said wind energy structure;
f) wherein said wind energy structure is configured so that said wind energy that has entered into said at least one of said one or more internal areas within said at least one of said one or more floors within said at least one of said one or more rooms, is allowed to leave said wind energy structure thought at least one of said one or more open tops, into said outside; and
g) further including setting at least one of said set points for said at least one of said one or more adjustable intake channels.

19) The apparatus of claim 18 further including:
a. providing one or more adjustable internal channels within said wind energy structure;
b. wherein at least one of said one or more adjustable internal channels is configured to open at desired set points and allow said wind energy that has entered within at least one of said one or more internal areas within at least one of said one or more floors within at least one of said one or more rooms within said wind energy structure to pass through said at least one of said one or more adjustable internal channels, within said wind energy structure;
c. wherein said at least one of said one or more adjustable internal channels is further configured to close at desired set points to prevent any said wind energy that has entered within said at least one of said one or more internal areas within said at least one of said one or more floors within said at least one of said one or more rooms, within said wind energy structure to pass through said at least one of said one or more adjustable internal channels, within said wind energy structure; and
d. further including setting at least one of said set points for said at least one of said one or more adjustable internal channels.

20) The apparatus of claim 18 wherein at least one of said one or more adjustable channels, is self-activating.

21) The apparatus of claim 18 further including:
a. providing one or more adjustable rotating outer wall sections with one or more inlet slots;
b. wherein at least one of said one or more adjustable rotating outer wall sections is configured to position at least one of said one or more inlet slots so as to allow wind energy to pass from said outside and into at least one of said one or more internal areas within at least one of said one or more floors within at least one or said one or more rooms, within said wind energy structure at desired set points; and
c. further including setting at least one of said set points for said at least one of said one or more adjustable rotating outer wall sections.

22) The apparatus of claim 18 further including:
a. providing one or more inlet scoops;
b. wherein at least one of said one or more inlet scoops is adjustable and configured to modulate based on set points; and
c. further including setting at least one of said set points for said at least one of said one or more adjustable inlet scoops.

23) The apparatus of claim 18 wherein at least one of said one or more adjustable channels is configured to modulate based on set points; including setting at least one of said set points for said at least one of said one or more adjustable channels.

24) The apparatus of claim 18 further including:
a. providing one or more adjustable open tops;
b. wherein at least one of said one or more adjustable open tops is configured to modulate between 100% open and 90% closed based on set points; and
c. further including setting at least one of said set points for said at least one of said one or more adjustable open tops.

25) The apparatus of claim 18 further including providing one or more geometric moisture condensing device, wherein at least one of said one or more geometric moisture condensing devices is configured to condense moisture from said wind energy within said wind energy structure.

26) The apparatus of claim 18 further including:
a. providing one or more outlet bells;
b. wherein at least one of said one or more outlet bells is adjustable and configured to modulate between 100% open and 90% closed based on set points; and
c. further including setting at least one of said set points for said at least one of said one or more adjustable outlet bells.

27) The apparatus of claim 18 further including one or more air straightening vanes.

28) The apparatus of claim 18 further including connecting one or more separate structures to said wind energy structure;
a. including a connection between said wind energy structure and at least one of said one or more separate structures; and
b. wherein said connection is configured so that said upwards flow of wind energy within said wind energy structure, pulls said wind energy through said at least one of said one or more separate structure and into said wind energy structure.

29) An apparatus for utilizing the push-pull power of an upwards flow of a wind energy within a wind energy structure to produce mechanical energy and/or useful work and/or electricity and/or to condense moisture including:
a) a structure with one or more open tops, one or more structural supports, one or more external surfaces, separating one or more internal areas with one or more floors with one or more rooms with one or more internal surfaces, from an outside;
b) further including one or more wind powered devices with one or more blades within said wind energy structure configured to convert said upwards flow of wind energy into said mechanical energy;
c) further including one or more machine devices;
d) further including a connection between at least one of said one or more wind powered device and at least one of said one or more machine devices, so that together they convert said mechanical energy into said useful work;
e) further including a connection between at least one of said one or more machine devices and at least one of said one or more wind powered devices, so that together they convert said mechanical energy into said electricity;
f) including a wall surrounding the top of said structure wherein said wall extends approximately as high as all tops of at least one of said one or more wind powered devices mounted on top of the highest of at least one of said one or more structural supports.

30) The apparatus of claim 29 further including one or more specialized blade supports rings and/or one or more radial blade supports and/or one or more blade glide supports on at least one of said one or more blades on at least one of said one or more wind powered devices, within said wind energy structure.

31) The apparatus of claim 29 further including one or more grated floors and/or one or more solid floors, mounted on at least one of said one or more structural supports, within said wind energy structure.

32) The apparatus of claim 29 further including:
a. providing one or more geometric moisture condensing devices, wherein at least one of said one or more geometric moisture condensing devices is configured to condense said moisture from said wind energy;
b. and/or providing one or more geometric moisture condensing blades, wherein at least one of said one or more blades on at least one of said one or more wind powered devices is at least one of said one or more geometric moisture condensing blades; and
c. wherein said at least one of said one or more geometric moisture condensing blades is configured to condense said moisture from said wind energy.

33) The apparatus of claim 29 further including one or more special casement channels, configured so that the said upwards flow of wind energy within said wind energy structure moves a volume of air containing said wind energy through said one or more special casement channels:
a. including a special containment casing with a single inlet and a single outlet;
b. including two or more wind powered devices within at least one of said one or more special casement channels;
c. including one or more machine devices within said at least one of said one or more special casement channels;
d. further including a connection between at least one of said two or more wind powered devices and at least one of said one or more machine devices within said at least one of said one or more special casement channels; and
e. wherein said special containment casing is configured to enlarge after each of said two or more wind powered devices within said at least one of said one or more special casement channels.

34) The apparatus of claim 29 further including one or more separate structures that are connected with said wind energy structure;
a. including one or more wind powered devices within at least one of said one or more separate structures;
b. further including one or more machine devices within said at least one of said one or more separate structures; and
c. further including a connection between at least one of said one or more wind powered devices and at least one of said one or more machine devices within said at least one of said one or more separate structures.
